(19) United States
(12) Patent Application Publication
(10) Pub. No.: US 2021/0276077 A1
(43) Pub. Date: Sep. 9, 2021

(54) ARTICLES AND METHODS OF MANUFACTURE

(71) Applicant: Poly6 Technologies, Inc., Boston, MA (US)

(72) Inventors: Keith Hearon, Boston, MA (US); Steven Lee, Brighton, MA (US); Ioana Knopf, Melrose, MA (US)

(21) Appl. No.: 17/260,769

(22) PCT Filed: Jul. 18, 2019
(86) PCT No.: PCT/US19/42439

§ 371 Date: Jan. 15, 2021

Related U.S. Application Data
(60) Provisional application No. 62/699,797, filed on Jul. 18, 2018.
(60) Provisional application No. 62/712,116, filed on Jul. 30, 2018.
(60) Provisional application No. 62/713,923, filed on Aug. 2, 2018.
(60) Provisional application No. 62/719,288, filed on Aug. 17, 2018.
(60) Provisional application No. 62/719,209, filed on Aug. 17, 2018.
(60) Provisional application No. 62/829,756, filed on Apr. 5, 2019.

(51) Int. Cl. B22C 9/10; B33Y 80/00; B22D 25/02; F01D 5/28; F01D 5/18

(52) U.S. Cl. CPC B22C 9/10; B33Y 80/00; B22D 25/02; F05D 2230/21; F01D 5/18; F05D 2220/32; F05D 2240/30; F01D 5/284

(57) ABSTRACT

Articles of manufacture such as ceramic cores and cast metal turbomachinery components are disclosed herein, as well as methods of preparing such articles of manufacture. The articles and methods of manufacture are directed to improving the production and performance of internal combustion engines.

### CROSS REFERENCE TO RELATED APPLICATIONS

This application claims the benefit of U.S. Provisional Patent Application 62/699,797, filed Jul. 18, 2018, U.S. Provisional Patent Application 62/712,116, filed Jul. 30, 2018, U.S. Provisional Patent Application 62/713,923, filed Aug. 2, 2018, U.S. Provisional Patent Application 62/719,209, filed Aug. 17, 2018, U.S. Provisional Patent Application 62/719,288, filed Aug. 17, 2018, and U.S. Provisional Patent Application 62/829,756, filed Apr. 25, 2019, the contents of which are herein incorporated by reference in their entirety.

### FIELD OF THE INVENTION

Disclosed herein are both articles of manufacture and methods of manufacture directed to improving the production and performance of internal combustion engines such as gas turbine engines. In particular, injection molding assemblies and methods are disclosed for the efficient production of ceramic cores having complex internal geometries for use in the production of cast metal turbomachinery components such as turbine blades having improved performance characteristics.

### BACKGROUND OF THE INVENTION

Internal combustion engines play an important role in the energy and aerospace industries. The performance of internal combustion engines has improved significantly over the last several decades. The development of novel materials and cooling designs for turbomachinery components has been critical to this improved performance, permitting combustion engines to operate at increasing temperatures. Operating temperatures of modern gas turbine engines, for example, temperatures may reach between 1500 and 2000° C.

There remains a need to improve both the production and performance of internal combustion engines such as gas turbine engines, as well as to reduce associated greenhouse gas emissions.

In particular, there remains a need to improve the production, performance and design complexity of turbomachinery components such as gas turbine blades.

### SUMMARY OF THE INVENTION

Disclosed herein are articles of manufacture, features within articles of manufacture and methods of manufacture directed to improving the production and performance of internal combustion engines, and in particular, gas turbine engines for use in the aerospace and energy sectors.

In one aspect, an injection mold assembly is disclosed comprising a (i) dissolvable, additively manufactured monolithic polymer mold; (ii) optionally an intermediate layer encasing the inner mold; and (iii) optionally, an outer shell surrounding the intermediate layer. When the injection mold assembly comprises an intermediate layer, an outer layer or both, the dissolvable, additively manufactured monolithic polymer mold may be referred to as an “inner mold.”

In a particular embodiment, the dissolvable, additively manufactured monolithic polymer mold dissolves in water or an organic solvent. In one embodiment, the dissolvable, additively manufactured monolithic polymer mold exhibits minimal swelling behavior when dissolved, and more particularly, an increase in polymer volume is less than about 200%, less than about 150%, less than about 100%, less than about 50%, less than about 25% or less than about 20%.

In one embodiment, the dissolvable, additively manufactured monolithic polymer mold comprises one or more features suitable for forming features in an intermediate article (e.g., a ceramic core) produced therefrom and in particular, features on the order of about 400 microns or less.

In one embodiment, the intermediate layer, the outer shell or both are conventionally manufactured. In an alternative embodiment, the intermediate layer and the outer shell are additively manufactured.

In another particular embodiment, the intermediate layer, the outer shell or both are dissolvable.

In a second aspect, a ceramic core is disclosed wherein the ceramic core is produced from utilizing the injection molding assembly disclosed herein and more particularly, an injection molding assembly comprising (i) a dissolvable, additively manufactured monolithic polymer mold; (ii) optionally an intermediate layer encasing the polymer mold; and (iii) optionally, an outer shell surrounding the intermediate layer.

In a particular embodiment, the ceramic core is suitable for casting a metal article, such as a turbomachinery component. In one embodiment, the turbomachinery component is a turbine blade or turbine vane.

In a particular embodiment, the ceramic core comprises alumina, fumed silica, fused silica, zirconium silicate or combinations thereof.

In one embodiment, the ceramic core is a multi-wall ceramic core.

In one embodiment, the ceramic core comprise one or more features suitable for forming one or more cooling features in a final article of manufacture (e.g., a turbine blade, a turbine vane) cast from the ceramic core.

In one embodiment, the one or more features are on the order of about 150 to about 500 micron in size. In certain embodiments, the ceramic core comprises one or more features on the order of about 150 microns, about 200 microns, about 250 microns, about 350 microns, about 400 microns, about 450 microns, or about 500 microns or more in size. In a particular embodiment, the ceramic core comprises one or more features on the order of about 400 microns or less in size.

In a third aspect, a turbine blade is disclosed wherein the turbine blade is produced from a ceramic core disclosed herein and more particularly, a ceramic core produced utilizing the injection molding assembly disclosed herein.

In one embodiment, the turbine blade comprise a single crystal superalloy.

In one embodiment, the turbine blade comprises one or more features selected from structural features, cooling features or combinations thereof. In a particular embodiment, the one or more features are on the order of about 5 micrometers to about 500 micrometers, ore more specifically about 10 micrometers to about 400 micrometers in size.

In one embodiment, turbine blade comprises one or more cooling features selected from the group consisting of passages, channels, cavities, complex internal features, flow channels, reservoirs, inlets, outlets or hierarchical meshes.

In another particular embodiment, the turbine blade comprises one or more internal cooling features selected from cooling passages, channels or cavities. Optionally, the internal cooling feature may comprise one or more turbulating components selected from the group consisting of dimples, ribs or pins.

In certain embodiments, the one or more turbulating components are pins and more particularly, a plurality of pins in the form of one or more pin arrays. In a particular embodiment, the turbine blade comprises an angled pin array, an intersecting pin array or both.

In a particular embodiment, the pins span the trailing edge cavity present within the turbine blade from the suction side wall to the pressure side wall at an angle or angles not perpendicular a midplane of the cavity or a wall.

In another particular embodiment, the turbine blade comprises one or more impingement holes and more particularly, a plurality of impingement holes. In one embodiment, the number of impingement holes per square centimeter is greater than about 100. In certain embodiments, the number of impingement holes per square centimeter is between about 150 to about 500,000, more specifically about 150 to about 100,000.

In one embodiment, the plurality of impingement holes are arranged in multiple angles. In certain embodiments, the centerlines of the individual holes constituting the plurality of impingement holes is at an angle to the surface of the inner wall wherein the angle is selected from about 1 degree to about 90 degrees, about 10 degrees to about 90 degrees, about 30 degrees to about 90 degrees, or about 60 degrees to about 90 degrees.

In one embodiment, the turbine blade comprises a plurality of impingement holes, wherein all or a portion of the impingement holes comprise a positive feature.

In one embodiment, turbine blade comprising one or more crossover holes, one or more impingement holes or both, in each case at differing angles relative to adjacent cavities.

In another embodiment, the turbine blade comprises cooling holes that connect internal cooling cavities and passages to the exterior of the airfoil. These film cooling holes may have curved passages.

In a particular embodiment, the turbine blade exhibits improved one or more properties compared to existing turbine blades, wherein the improved properties are selected from the group comprising improved durability, improved average blade cooling effectiveness, reduced airfoil temperature, reduced maintenance frequency or improved heat transfer cooling effectiveness.

In one embodiment, the turbine blade disclosed herein permits an increased turbine inlet temperature compared to existing turbine blades. In a particular embodiment, the increase in turbine inlet temperature is greater than about 1%, greater than about 2% greater than about 3%, greater than about 4% or greater than about 5% higher. In one embodiment, the turbine blade permits a turbine inlet temperature is between about 1700 and about 2000, or about 1700, about 1800, about 1900, about 2000, about 2100 or about 2200° C.

In a fourth aspect, a gas turbine engine is disclosed comprising a gas turbine engine assembly, wherein the gas turbine engine comprises a plurality of turbine blades disclosed herein.

In a particular embodiment, the gas turbine engine is characterized by improved thermal efficiency and/or fuel efficiency compared to existing gas turbine engines.

In a particular embodiment, the gas turbine engine is characterized by an improvement in fuel efficiency of between about 0.1 to about 1%.

In a particular embodiment, the gas turbine engine is characterized by reduced greenhouse gas emissions compared to existing gas turbine gas engines. In a particular embodiment, the greenhouse gas emissions are reduced by between about 0.1 and about 1.0%.

In a fourth aspect, a method is disclosed for preparing a ceramic green body, comprising (i) providing a ceramic slurry; (ii) injecting a flowable ceramic slurry into a dissolvable, additively manufactured monolithic polymer mold disclosed herein, wherein the polymer mold is optionally housed within an injection molding assembly disclosed herein; (iii) allowing the ceramic slurry to solidify to provide a ceramic green body; and (iv) dissolving the polymer mold by means of a dissolving liquid to provide an isolated ceramic green body.

In a particular embodiment, the method further comprises additively manufacturing the polymer mold in (ii). In such embodiments, the method combines additively manufacturing and conventional manufacturing, i.e., injection molding.

In a particular embodiment, the dissolving liquid is water or an organic solvent.

In another particular embodiment, the polymer mold exhibits minimal swelling when dissolved, and more particularly, an increase in polymer volume is less than about 200%, less than about 150%, less than about 100%, less than about 50%, less than about 25% or less than about 20%.

In a particular embodiment, the flowable ceramic slurry comprises solid particulate components and carrier phase components. Optionally the ceramic slurry comprises a pore former and one or more additives.

In a particular embodiment, the method further comprises (v) debinding the isolated ceramic green body to provide a ceramic brown body and (vi) sintering the ceramic brown body to provide a ceramic core.

In one embodiment, the debinding in (v) comprises solvent debinding and thermal debinding.

In a fifth aspect, a method is disclosed for preparing a ceramic core, comprising (i) providing a ceramic slurry; (ii) injecting the ceramic slurry into a dissolvable, additively manufactured monolithic polymer mold as disclosed herein, wherein the polymer mold is optionally housed within an injection molding assembly disclosed herein; (iii) allowing the ceramic slurry to solidify to provide a ceramic green body; (iv) dissolving the polymer mold by means of a dissolving liquid to provide an isolated ceramic green body; and (v) further processing the isolated ceramic green body to provide the ceramic core.

In a particular embodiment, the further processing in (v) comprises debinding the ceramic green body to an provide isolated and sintering the ceramic brown body to provide a ceramic core. In one embodiment, the debinding comprising solvent debinding, thermal debinding or a combination thereof.

In a particular embodiment, the dissolving liquid is water or an organic solvent.

In another particular embodiment, the polymer mold exhibits minimal swelling when dissolved, and more particularly, an increase in polymer volume is less than about 200%, less than about 150%, less than about 100%, less than about 50%, less than about 25% or less than about 20%.

In a particular embodiment, the method further comprises additively manufacturing the polymer mold in (ii). In such embodiments, the method combines additively manufacturing and conventional manufacturing, i.e., injection molding.

In one embodiment, the method disclosed herein permits one or more steps of traditional investment casting processes to eliminated, including core/die assembly, wax over-molding and ceramic shelling.

In a particular embodiment, the method is repeated multiple more times. In one embodiment, the yield of the repeated method is greater than about 70%, greater than about 75%, greater than about 80%, greater than about 85% or greater than about 90%.

In a fifth aspect, a method is disclosed for preparing the turbine airfoil, comprising (i) providing a ceramic core as disclosed herein; (ii) introducing molten metal into and around the ceramic core; (iii) permitting the molten metal to cool; and (iv) removing the ceramic core.

### BRIEF DESCRIPTION OF THE FIGURES

FIG. 1 depicts an embodiment of the injection molding assembly disclosed herein comprising a two-part additively manufactured inner mold, an intermediate layer and an outer shell.

FIG. 2 shows an embodiment of the injection molding assembly disclosed herein comprising a monolithic additively manufactured mold inner mold, an intermediate layer and an outer layer.

FIG. 3 depicts an embodiment of the turbine blade disclosed herein.

FIG. 4 depicts an embodiment of a turbine blade disclosed herein.

FIG. 5 shows an embodiment of the ceramic core disclosed herein.

FIG. 6 depicts an embodiment of the additively manufactured core/shell mold disclosed herein.

FIG. 7 depicts an embodiment of a fired ceramic core disclosed herein, characterized by three dimensional features.

FIG. 8 depicts an embodiment of the turbine blade disclosed herein, including an angled pin array and an intersecting pin array

FIG. 9 depicts an embodiment of the turbine blade disclosed herein including a lead edge having an impingement hole with positive feature.

FIG. 10 depicts shows an embodiment of the turbine blade disclosed herein, wherein the turbine blade comprises angled impingement holes

FIG. 11 depicts an embodiment of the turbine blade disclosed herein, wherein the turbine blade comprises curved film cooling holes

FIG. 12 depicts an embodiment of the turbine blade disclosed herein, wherein the turbine blade comprises impingement cooling mesh.

FIG. 13 depicts an embodiment of the ceramic core disclosed herein.

### DETAILED DESCRIPTION

### I. Definitions

The term “about” or “approximately” as used herein generally means within 20%, preferably within 10%, and more preferably within 5% of a given value or range. The term “about x” further includes x.

As used herein, the term “additive manufacturing” or “3-D printing” generally refers to a group of processes characterized by manufacturing three-dimensional components by building up one or more materials to make a net or near net shape object, Additive manufacturing is in contrast with subtractive manufacturing, in which material is removed from an initial form in a manufacturing process. This definition of additive manufacture is also in contrast with other conventional manufacturing processes that include injection molding, extrusion, blow molding, vacuum molding and compression molding. Any suitable additive manufacturing technique can be used to prepare the molds disclosed herein, including but not limited to material extrusion (ME), binder jetting (BJ), material jetting (MJ), vat polymerization (VP), powder bed fusion (PBF), stereolithography (SLA), digital light processing (DLP), sheet lamination (SL) or direct energy deposition (DED).

The term “alkyl”, as used herein, radical of saturated or unsaturated aliphatic groups, including straight-chain alkyl, alkenyl, or alkynyl groups, -chain alkyl, alkenyl, or alkynyl groups, cycloalkyl, cycloalkenyl, or cycloalkynyl (alicyclic) groups, alkyl substituted cycloalkyl, cycloalkenyl, or cycloalkynyl groups, and cycloalkyl substituted alkyl, alkenyl, or alkynyl groups. Unless otherwise indicated, a straight chain or branched chain alkyl has 30 or fewer carbon atoms in its backbone (e.g., C1-C30 for straight chain, C3-C30 for branched chain), and more preferably 20 or fewer. Likewise, preferred cycloalkyls have from 3-10 carbon atoms in their ring structure, and more preferably have 5, 6 or 7 carbons ring structure.

The term “alkylaryl”, as used herein, refers to an alkyl group substituted with an aryl group (e.g., an aromatic or heteroaromatic group).

As used herein, the term “analog” refers to a chemical compound with a structure similar to that of another (reference compound) but differing from it in respect to a particular component, functional group, atom, etc. As used herein, the term “derivative” refers to compounds which are formed from a parent compound by chemical reaction(s). These differences in suitable analogues and derivatives include, but are not limited to, replacement of one or more functional groups on the ring with one or more different functional groups or reacting one or more functional groups on the ring to introduce one or more substituents.

The terms “alkenyl” and “alkynyl”, as used herein, refer to unsaturated aliphatic groups analogous in length and possible substitution to the alkyls described above, but that contain at least one double or triple bond respectively.

The term “aryl”, as used herein, refers to 5-, 6- and 7-membered aromatic, heterocyclic, fused aromatic, fused heterocyclic, biaromatic, or biheterocyclic ring system, optionally substituted by halogens, alkyl-, alkenyl-, and alkynyl-groups. Broadly defined, “Ar”, as used herein, includes 5-, 6- and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with such substituents as, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF3, —CN, or the like. The term “Ar” also includes polycyclic ring systems having two or more cyclic rings in which two or more carbons are common to two adjoining rings (the rings are “fused rings”) where at least one of the rings is aromatic, e.g., the other cyclic rings can be cycloalkyls, cycloalkenyls, cycloalkynyls, aryls and/or heterocycles. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl.

As used herein, the term “aspect ratio” describes the proportional relationship between the width and height of an object. For example, an aspect ratio of 3:1 indicates that the width is three times the height of the object.

As used herein, “biodegradable” polymers are polymers that degrade to macromolecular, oligomeric and/or monomeric species under physiological or endosomal conditions. In various preferred embodiments, the polymers and polymer biodegradation byproducts are biocompatible. Biodegradable polymers are not necessarily hydrolytically degradable and may require enzymatic action to fully degrade. In one embodiment, the polymer composition disclosed herein for use in making the mold is biodegradable. In another embodiment, the polymer composition disclosed herein for use in making the mold is not biodegradable.

As used herein, the term “casting” refers to process of producing an object by pouring molten or flowable material into a mold, which contains a hollow cavity of the desired shape, and then allowed to solidify. The solidified part is known as a “casting” and separated from the mold.

The term “catalysts” or “catalytic centers,” as used herein, refer to a molecular species or component thereof which lowers the activation energy of chemical reactions and is generally not destroyed or consumed by the chemical reaction and is or can be regenerated. Catalysts are often used to increase rates or yields of chemical reactions and may offer significant economic, efficiency and energy advantages to individuals or businesses that carry out these reactions.

The term “ceramic,” as used herein, generally refers to an inorganic compound, non-metallic, solid material comprising metal, non-metal or metalloid atoms primarily held in ionic and covalent bonds. Exemplary ceramics may include oxide, nitride or carbide materials.

As used herein, the term “ceramic core” refers to a ceramic structure primarily used for forming cavities in the component being cast that are too small or complex to be machined following casting procedures. Ceramic cores may be made from a variety of ceramic materials, including materials containing fused silica, zircon, and/or alumina—generally in the form of a ceramic powder-binder mix. In certain embodiments, the ceramic core is coated. In certain embodiments, the ceramic core is a sacrificial ceramic core.

The term “chain transfer,” as used herein, generally refers to chain transfer reactions which may occur during a polymerization reaction in which a chemical reaction occurs during a chain polymerization in which an active center is transferred from a growing macromolecule or oligomer molecule to another molecule or to another site on the same molecule, such as to limit the molecular weight of the growing macromolecule or oligomer molecule.

The term “chain transfer agent” (also known as control agents, modifiers or regulators), as used herein, refers to compounds which react with the free-radical site of a growing polymer chain (a chain carrier) and interrupt chain growth and which may result in the original chain becoming deactivated and a new growing chain being generated. Chain transfer agents may influence molecular weight distribution for polymers formed during polymerization processes and may influence polymer physical, mechanical and thermomechanical behavior. Chain transfer agents may include at least one chemical bond of sufficiently low bond energy to undergo chain transfer reactions, and chain transfer activity is reported in the form of chain transfer constants, which may vary from 0.001 up to >220,000. Representative chain transfer agents include, but are not limited to, halogen-containing compounds, aromatic hydrocarbons, and thiols (mercaptans).

As used herein, the use of the singular “compound” in reference to an oligomeric or polymeric compound includes such mixtures. As used herein, reference to any oligomeric or polymeric material without further modifiers includes oligomeric or polymeric material having any average molecular weight.

The term “cooling channel,” as used herein, generally refers to a channel or passage wherein one or more cooling agents (gases or liquids) may flow to facilitate heat transfer.

As used herein, the term “crosslink” refers to a connection between two strands. A crosslink may be a covalent chemical bond, a physical chemical interaction such as a chain entanglement, interchain hydrogen bonding, chain alignment such as that seen in crystallization, a supramolecular interaction such as the self-complementary hydrogen bonding exhibited by ureidopyrimidinone (UPy) molecular moieties, ionic or ionomeric crosslinking, slide-ring crosslinking (freely movable crosslinks), semi-interpenetrating networks formed by dispersion and/or dissolution of one substituent in a second crosslinked phase, interpenetrating networks formed by crosslinking of multiple substituents in and throughout networks for separately by each substituents, liquid crystalline interactions, or other crosslinking interactions. The crosslink may be formed by reaction of a pendant group in one strand with the backbone of a different strand, or by reaction of one pendant group with another pendant group. Crosslinks may exist between separate strand molecules and may also exist between different points of the same strand.

The term “curable,” as used herein, refers to monomeric, oligomeric or polymeric materials or compositions thereof capable of being toughened or hardened-typically by crosslinking or linear polymerization of polymer and/or oligomer chains therein.

The term “curing,” as used herein refers to the process of applying an external stimulus, such as, but not limited to, light, radiation, electron beam irradiation, heat, chemical additives, including ionic additives, and combinations thereof which induce linear polymerization and/or crosslinking to produce toughening or hardening of the materials. UV curing is a process that uses light to alter the properties of a photopolymer.

The term “creep”, as used herein, refers to time-dependent deformation of a material under constant stress and (typically) at elevated temperatures. Creep is a function of the material's properties, exposure time, exposure temperature and applied stress (load). Under some circumstances, the deformation may be so significant that the material may fail. The rate of deformation is called the creep rate, reflecting creep strain vs. time and can be determined by measuring dimensional changes accurately at a constant temperature and stress. Creep limit is a term used to refer to the stress to which material can be subjected without the creep exceeding a specified amount after (e.g., hours) at a given temperature (e.g., operating temperature). In a particular embodiment, the creep characteristic of the ceramic mold disclosed herein is reduced by about 0.1 to about 10% over existing ceramic molds and in particularly, about 0.1, about 0.5, about 1.0, about 3.0, about 5.0 or about 8.0% or more.

As used herein, the term “cure” refers to refers to the process by which a material hardens or stabilizes, including processes by which thermoplastic or thermosetting polymers undergo polymerization reactions to form linear polymers branched polymers or crosslinked polymer networks in the presence of heat, moisture, catalysts, ionizing radiation, acids or bases, oxidizing agents are photo-redox agents, UV light or other stimuli.

As used herein, the term “dissolvable” refers to a material (e.g., a mold) that is capable of dissolving, wherein the term “dissolving” refers to the passing of a solute into a solution. For clarity, “dissolving” may also refer to the diffusion or dispersion of a particle, ionic species, polymer, oligomer, molecule, macromolecule, or other molecular constituent into a heterogeneous surrounding medium, including a liquid environment such that a colloidal dispersion, emulsion, or other mixture is formed.

As used herein, the term “engine efficiency” refers to the relationship between the total energy contained in the fuel, and the amount of energy used to perform useful work. Combustion temperature is a driver in the efficiency of a gas turbine engine.

As used herein, the term “exhaust gas temperature” refers to the temperature of exhaust gases exiting the turbine. The exhaust gas temperature is measured by thermocouples mounted in the exhaust stream and is presented on a flight deck gauge in either degrees Fahrenheit or degrees Celsius.

As used herein, the term “film cooling” refers to a cooling strategy for turbine blades which uses bleed air from the compressor, ducted to the internal chambers of the turbine blade and then discharged through one or more small holes in the blade wall, to form a film of cool air over the external blade surface thereby protecting it from the hot gasses exiting the combustor.

The term “fillers,” as used herein, generally refers to materials (typically particulates) which can be added to a polymer formulation to lower cost and/or to improve resulting properties. Such materials can be in the form of a solid, liquid or gas and can be extender fillers which primarily occupy space and are mainly used to lower the formulation cost or functional fillers, such as, but not limited to, reinforcing fillers, rubbery fillers, and fibrous fillers.

The term “flow channel,” as used herein, generally refers to a microscale channel wherein one or more liquids or gases may flow through.

The term “free radical initiator,” as used herein, generally refers to organic and inorganic compounds capable of generating radicals that initiate polymerization. Exemplary initiators include, but are not limited to, peroxide and azo containing compounds.

The term “free radical inhibitor,” as used herein, generally refers to a compound which may be added during a free-radical polymerization which react with and can trap radicals present. Such trapping events act to inhibit the radical polymerization process.

As used herein, the term “gas turbine engine” refers to a continuous combustion or internal combustion engine. The four types of gas turbine engines that are typically used to propel and power aircraft are known as turbofan, turboprop, turboshaft, turbojet, and un-ducted fan.

As used herein, the term “gate” refers to the location where the material enters into the cavity of the mold. Types of gates include, for example, sub, edge, fan, and cashew.

The term “halogen”, as used herein, refers to fluorine, chlorine, bromine, or iodine.

The term “heat transfer”, as used herein, refers to the flow of heat (thermal energy) due to temperature differences and the subsequent temperature distribution and changes.

The term “heat transfer coefficient”, as used herein, refers the quantitative characteristic of convective heat transfer between a fluid medium and the surface flowed over by the fluid. Heat transfer can be measured locally.

The “heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) where Y is absent or is H, O, (C1-4)alkyl, phenyl or benzyl, and optionally containing 1-3 double bonds and optionally substituted with one or more substituents.

Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl.

The term “heteroaryl”, as used herein, refers to a monocyclic aromatic ring containing five or six ring atoms consisting of carbon and 1, 2, 3, or 4 heteroatoms each selected from the group consisting of non-peroxide oxygen, sulfur, and N(Y) where Y is absent or is H, O, (C1-C8)alkyl, phenyl or benzyl. Non-limiting examples of heteroaryl groups include furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide), thienyl, pyrimidinyl (or its N-oxide), indolyl, isoquinolyl (or its N-oxide), quinolyl (or its N-oxide) and the like. The term “heteroaryl” can include radicals of an ortho-fused bicyclic heterocycle of about eight to ten ring atoms derived therefrom, particularly a benz-derivative or one derived by fusing a propylene, trimethylene, or tetramethylene diradical thereto. Examples of heteroaryl can be furyl, imidazolyl, triazolyl, triazinyl, oxazoyl, isoxazoyl, thiazolyl, isothiazoyl, pyraxolyl, pyrrolyl, pyrazinyl, tetrazolyl, pyridyl (or its N-oxide), thientyl, pyrimidinyl (or its N-oxide), indolyl, isoquinolyl (or its N-oxide), quinolyl (or its N-oxide), and the like.

As used herein, the term “impingement cooling” refers to cooling wherein the temperature of the impinging fluid is different than that of the impingement surface. In some embodiments described herein, one or more impingement cooling strategies are used in the leading edge of the turbine blade, the mid-chord section of the turbine blade or any location within the turbine blade.

As used herein, the term “impingement distance” refers to the distance from an exit of an impingement hole to the impingement jet contact location.

As used herein, the term “impingement jet” refers to columnar cooling airflow which flows out of an impingement hole contacts an airfoil wall opposite of the impingement hole exit.

As used herein, the term “injection molding” refers to a manufacturing process for producing parts by injecting flowable material optionally under pressure into a cavity, where it generally solidifies, cools or hardens before it is removed. The process can be used to produce articles of manufacture from various materials including plastics, fibers, ceramics, and powdered metals, with polymers as binders and additional additives as pore formers, plasticizers, carriers, crystallization kinetics modulators and demolding facilitation agents. An injection molding assembly may have one or more parts, including but not limited to a mold consisting of a rigid outer shell and a hollow internal cavity

As used herein, the term “inner mold” refers to a mold surrounded or encompassed by one or more components of an injection molding assembly, including, but not limited to, an intermediate layer and an outer layer or shell.

As used herein, the term “internal cooling” refers to a cooling strategy for turbine blades that relies (primarily) on structures internal to the blade.

As used herein, the term “internal cooling channel” refers to a cooling channel embedded inside the turbine blades in a root to tip or lead edge to trail edge direction. Cooling channels may form as a single pass or multi-pass channels depending on the design considerations. These inner cooling channels may be in the airfoil or platform section of the turbine blade.

As used herein, the term “internal combustion engine” refers to heat engine where the combustion of a fuel occurs with an oxidizer (usually air) in a combustion chamber that is an integral part of the working fluid flow circuit. Internal combustion engines are used in a variety of sectors, including aerospace, automotive and energy.

As used herein, the term “investment casting” (alternatively referred to as lost wax or precision casting) refers to a process of forming a component utilizing a destructible core, wherein a material (e.g., a metal) is cast around the destructible core. Once the material has cooled, the destructible core is removed from the cast component leaving a void within the cast component, with the void being an inverse of the shape of the destructible core. The shape of the destructible or removable core is commonly referred to as a negative of the shape of the void. One material used to construct destructible cores for investment casting is a ceramic material.

The term “ionomeric,” as used herein, generally refers to polymer materials, which contain some ionic repeat units.

The term “jettable”, as generally used herein, refers suitability of the curable compositions described to be used in inkjet printing processes, including those used for three dimensional inkjet printing.

The term “leading edge” refers to the front, or nose, of the turbine blade

The term “mean particle size,” or “average particle size,” as used herein, generally refers to the statistical mean particle size (diameter) of the particles in a population of particles. The diameter of an essentially spherical particle may be referred to as the physical or hydrodynamic diameter. The diameter of a non-spherical particle may refer preferentially to the hydrodynamic diameter. As used herein, the diameter of a non-spherical particle may refer to the largest linear distance between two points on the surface of the particle. Mean particle size can be measured using methods known in the art, such as dynamic light scattering.

As used herein, the term “mold” refers to the tooling into which a flowable material is injected to form a fixed shape.

As used herein, the term “molding conditions” refers to conditions including cylinder temperature, injection speed, mold temperature, injection pressure etc. set in a molding machine to obtain required moldings.

As used herein, the term “monolithic” refers to an object having only one piece or part.

As used herein, the term “network” refers to a substance having oligomeric and/or polymeric strands interconnected to one another by crosslinks, including three-dimensional crosslinked networks.

The term “organometallic” refers to compounds, salts, materials, molecules, that have a hybrid character in that they contain both a “metal” component as well as an “organic” component. The nature of the linkage between the metal and organic components is not restricted. In this case, “metal” is defined as any element of the periodic table except carbon. “Organic” as used in this context means carbon-containing and can be any group, fragment, molecule, material that is comprised of at least one carbon atom.

The terms ortho, meta and para apply to 1,2-, 1,3- and 1,4-disubstituted benzenes, respectively. For example, the names 1,2-dimethylbenzene and ortho-dimethylbenzene are synonymous.

The term “photoinitiator,” as used herein, generally refers to a compound that undergoes a photoreaction on absorption of light, producing reactive species, such as radicals or cations capable of initiating polymerization reactions. Exemplary photoinitiators may include, for example, radical photoinitiators and cationic photoinitiators.

The term “plasticizer,” as used herein, generally refers to compounds (additives) that can interpose between polymer chains in order to decrease the transition temperatures, such as the glass transition, and/or decrease the viscosity of a polymer-based material. Exemplary plasticizers include classes of materials such as phthalates, dicarbonates, phosphates, and fatty acid esters, etc.

As used herein, the term “polymer” refers to a substance that has a molecular structure consisting chiefly or entirely of a large number of similar units bonded together, e.g., many synthetic organic materials used as plastics and resins.

As used herein, the term “prepolymer” refers to oligomeric or polymeric strands which have not undergone crosslinking to form a network.

As used herein, the term “rigid’ refers to the tendency of a solid body to resist deformation. The term “compliant”, in a mechanical sense, is the inverse of rigid.

The term “rubber,” or “elastomer,” as used herein, refers to a crosslinked network polymer, which may exhibit elastomeric behavior in response to deformation at temperatures defined as being within the “rubbery regime.”

As used herein, the term “runner” refers to a system of channels that meet up with the sprue, typically within or as part of the mold tool, that guides the molten material into the part cavities within the mold tool.

The term “sacrificial mold,” as used herein, generally refers to a geometric pattern formed for the purpose of sacrificial removal or destruction in the process of forming another article of manufacture. Sacrificial polymeric materials include burnout materials and solvent soluble or degradable materials and may be formed into negative, positive or other images used in another article's fabrication.

The term “single crystal alloys,” as used herein, generally refers to mixtures of metals that can be processed (solidified) such that the entire object essentially forms a single grain (i.e. one continuous crystal).

As used herein, the term “sintering” refers to a process by which a powdered material coalesces into a solid or porous mass by heating it (and usually also compressing it) without liquefaction.

The term “solvent degradable”, as used herein, refers to polymers that undergo one or more chemical reactions that result in cleavage of ionic, covalent and/or hydrogen bonds and leads to eventual polymer degradation, completely or partially, in the presence of certain solvents (such as organic solvents, water, or aqueous solvents), chemical environments, or under certain reaction conditions. “Water degradable” polymers are a type of solvent degradable polymer that undergoes one or more chemical reactions that result in cleavage of ionic, covalent and/or hydrogen bonds and leads to eventual polymer degradation, completely or partially, in the presence of water or aqueous solvents.

The term “solvent soluble”, as used herein, refers to polymer(s) that are capable of undergoing dissolution, degradation, dispersion, and/or swelling in the presence of common organic solvents. “Water soluble” polymer(s) are a type of solvent soluble polymer where the polymer is capable of undergoing dissolution, degradation, and/or dispersion in the presence of water and/or aqueous solvents.

As used herein, the term “sprue” refers to a channel that guides molten material from the nozzle of the injection molding machine to the entry point for the entire injection mold tool.

The term “stereolithography,” as used herein, generally refers to a form of 3-D printing technology used, for example, in creating models, prototypes, patterns, molds, dies, production parts or components, etc. via a layer-by-layer fashion typically using photopolymerization of a suitable formulation.

The term “substituted”, as used herein, means that the functional group contains one or more substituents attached thereon including, but not limited to, hydrogen, halogen, cyano, alkoxyl, alkyl, alkenyl, cycloalkyl, cycloalkenyl, aryl, heterocycloalkyl, heteroaryl, amine, hydroxyl, oxo, formyl, acyl, carboxylic acid (—COOH), —C(O)R′, —C(O)OR′, carboxylate (—COO—), primary amide (e.g., —CONH2), secondary amide (e.g., —CONHR′), —C(O)NR′R″, —NR′R″, —NR′S(O)2R″, —NR′C(O)R″, —S(O)2R″, —SR′, and S(O)2NR′R″, sulfinyl group (e.g., —SOR′), and sulfonyl group (e.g., —SOOR′); where R′ and R″ may each independently be hydrogen, alkyl, alkenyl, alkynyl, cycloalkyl, aryl, heterocycloalkyl and heteroaryl; where each of R′ and R″ is optionally independently substituted with one or more substituents selected from the group consisting of halogen, hydroxyl, oxo, cyano, nitro, amino, alkylamino, dialkylamino, alkyl optionally substituted with one or more halogen or alkoxy or aryloxy, aryl optionally substituted with one or more halogen or alkoxy or alkyl or trihaloalkyl, heterocycloalkyl optionally substituted with aryl or heteroaryl or oxo or alkyl optionally substituted with hydroxyl, cycloalkyl optionally substituted with hydroxyl, heteroaryl optionally substituted with one or more halogen or alkoxy or alkyl or trihaloalkyl, haloalkyl, hydroxyalkyl, carboxy, alkoxy, aryloxy, alkoxycarbonyl, aminocarbonyl, alkylaminocarbonyl and dialkylaminocarbonyl, or combinations thereof. In some instances, “substituted” also refers to one or more substitutions of one or more of the carbon atoms in a carbon chain (i.e., alkyl, alkenyl, cycloalkyl, cycloalkenyl, and aryl groups) which can be substituted by a heteroatom, such as, but not limited to, a nitrogen or oxygen.

The term “supramolecular,” as used herein, generally refers to an assembly or assemblies of a plurality of molecular components, wherein the components are assembled through typically weak and often reversible forces such as, but not limited to, intermolecular forces, hydrogen bonding, metal coordination, hydrophobic forces, van der Waals forces, pi-pi interactions and electrostatic effects.

The term “swelling,” as used herein, generally refers to the ability of crosslinked polymer to absorb at least a portion of solvent(s) when the polymer is placed into the solvent(s), as opposed to dissolving in the solvent(s). Swelling results from a solvent(s) ability to penetrate into the crosslinked polymer network.

As used herein, the term “thermoplastic” refers to a polymer that is linear or lightly branched in its macromolecular structure and that is not covalently crosslinked.

As used herein, the term “thermosetting” or “thermoset” refers to a crosslinked polymer with covalent, supramolecular, ionomeric or other crosslinks formed from monomeric, oligomeric or polymeric precursors.

As used herein, the term “tip” refers to outermost section of the turbine blade or vane.

As used herein, the term “trailing edge” refers to the trailing edge: the rear, or tail, of the turbine blade.

As used herein, the term “tool” or “tooling” refers to a mold, die, or other device used in various manufacturing and fabricating processes such as plastic injection molding, nickel backing, thermoforming, blow molding, vacuum casting, die casting, sheet metal stamping, hydroforming, forging, composite lay-up tools, machining and assembly fixtures, etc.

As used herein, the term “turbine blade” refers to the individual component which makes up the turbine section of a gas turbine or steam turbine. The turbine blade may be rotating or stationary. Stationary blades may also be referred to as “vanes.” The blades are responsible for extracting energy from the high temperature, high pressure gas produced by the combustor. The blades may also be responsible for directing the direction of flow or accelerating flow of the high temperature, high pressure gas produced by the combustor.

As used herein, the term “turbulator pin” or “pin” refers to a pin present in a heat exchanging channel, such as an inner cooling channel in a turbine blade.

As used herein, the term “turbulator rib” or “rib” refers to a rib present in a heat exchanging channel, such as an inner cooling channel in a turbine blade.

As used herein, the term “turbine inlet temperature” or “TIT” refers to the temperature of combustion chamber exhaust gases as they enter the turbine unit. The thermal efficiency and output power of the gas turbine improves by increasing the turbine inlet temperature.

As used herein, the term “viscoelastic” refers to the property of materials that exhibit both viscous and elastic characteristics when undergoing deformation.

The term “viscosity,” as used herein, refers to the resistance of a substance (typically a liquid) to flow. Viscosity is related to the concept of shear force; it can be understood as the effect of different layers of the fluid exerting shearing force on each other, or on other surfaces, as they move against each other. There are several measures of viscosity. The units of viscosity are Ns/m2, known as Pascal-seconds (Pa-s). Viscosity can be “kinematic” or “absolute”. Kinematic viscosity is a measure of the rate at which momentum is transferred through a fluid. It is measured in Stokes (St). The kinematic viscosity is a measure of the resistive flow of a fluid under the influence of gravity. When two fluids of equal volume and differing viscosity are placed in identical capillary viscometers and allowed to flow by gravity, the more viscous fluid takes longer than the less viscous fluid to flow through the capillary. If, for example, one fluid takes 200 s to complete its flow and another fluid takes 400 s, the second fluid is called twice as viscous as the first on a kinematic viscosity scale. The dimension of kinematic viscosity is length2/time. Commonly, kinematic viscosity is expressed in centiStokes (cSt). The SI unit of kinematic viscosity is mm2/s, which is equal to 1 cSt. The “absolute viscosity”, sometimes called “dynamic viscosity” or “simple viscosity”, is the product of kinematic viscosity and fluid density. Absolute viscosity is expressed in units of centipoise (cP). The SI unit of absolute viscosity is the milliPascal-second (mPa-s), where 1 cP=1 mPa-s. Viscosity may be measured by using, for example, a viscometer at a given shear rate.

Additionally, viscosity may be measured by using, for example, a viscometer at multiple given shear rates. A “zero-shear” viscosity can then be extrapolated by creating a best fit line of the four highest-shear points on a plot of dynamic viscosity versus shear rate, and linearly extrapolating viscosity back to zero shear. Alternatively, for a Newtonian fluid, viscosity can be determined by averaging viscosity values at multiple shear rates. Viscosity can also be measured using a microfluidic viscometer at single or multiple shear rates (also called flow rates), wherein absolute viscosity is derived from a change in pressure as a liquid flows through a channel. Viscosity equals shear stress over shear rate. Viscosities measured with microfluidic viscometers can, in some embodiments, be directly compared to zero-shear viscosities, for example those extrapolated from viscosities measured at multiple shear rates using a cone and plate viscometer.

Numerical ranges include ranges of temperatures, ranges of pressures, ranges of molecular weights, ranges of integers, ranges of force values, ranges of times, ranges of thicknesses, and ranges of gas flow rates. The disclosed ranges of any type, disclose individually each possible number that such a range could reasonably encompass, as well as any sub-ranges and combinations of sub-ranges encompassed therein. For example, disclosure of a temperature range, is intended to disclose individually every possible temperature value that such a range could encompass, consistent with the disclosure herein. In another example, the disclosure that an annealing step may be carried out for a period of time in the range of about 5 min to 30 min, also refers to time values that can be selected independently from about 5, 6, 7, 8, 9, 10, 11, 12, 13, 14, 15, 16, 17, 18, 19, 20, 21, 22, 23, 24, 25, 26, 27, 28, 29, and 30 minutes, as well as any range between these numbers (for example, 10 min to 20 min), and any possible combination of ranges between these time values.

### II. Injection Molding Assembly

Disclosed herein is an injection molding assembly that permits the manufacture of articles according to methods described herein, both directly and indirectly.

In a particular embodiment, the injection mold assembly permits the direct manufacture of articles of manufacture, e.g., ceramic cores. In one embodiment, an article of manufacture produced directly from the injection mold assembly is used to prepare a second or final article of manufacture. According to this embodiment, the article of manufacture produced directly from the injection molding assembly is referred to as an intermediated article.

In another particular embodiment, the injection assembly permits the indirect manufacture of articles, e.g., turbine blades, via an intermediate article, e.g., ceramic cores, produced using the injection molding assembly described herein.

In one embodiment, an injection molding assembly is disclosed comprising (1) a mold that is optionally dissolvable, (2) optionally, a compliant, viscoelastic or rigid intermediate layer encasing the inner mold, wherein the intermediate layer is optionally separate from the inner mold and optionally dissolvable and (3) optionally, a compliant, viscoelastic or rigid outer shell surrounding the intermediate layer, wherein the outer shell is also optionally dissolvable.

In a particular embodiment, the injection mold assembly comprises (1) an inner mold; (2) a compliant, viscoelastic or rigid intermediate layer encasing the inner mold, wherein the intermediate layer is optionally separate from the inner mold; and (3) a compliant, viscoelastic or rigid outer shell surrounding the intermediate layer, wherein (1)-(3) are optionally dissolvable.

In certain embodiments, the injection mold assembly is housed within an injection molding machine.

In a particular embodiment, the mold (e.g., the inner mold) is a polymer mold has one or more of the following characteristics: dissolvable, additively manufactured and monolithic. In one embodiment, the inner mold is a dissolvable, additively manufactured monolithic polymer mold.

In one embodiment, the mold is a two-part mold or a monolithic (one-part) mold, for example, an inner two-part mold or inner monolithic mold.

In a particular embodiment, the mold is a monolithic mold produced via additive manufacturing utilizing a polymer or co-polymer material.

In one embodiment, the mold comprises an internal cavity suitable for injection molding or casting. In a particular embodiment, the mold comprises an internal cavity that is a negative replica of a final article of manufacture (e.g., turbine blade) that can be produced from the same, while the outside of the mold is a generic shape suitable from facile assembly and disassembly of the mold assembly disclosed herein. In a particular embodiment, the inner mold is a monolithic mold

Generally, the internal architecture of the article made from the mold (e.g., a ceramic core) is determined by the features of the mold. In a particular embodiment, the mold is a multi-walled ceramic mold.

In one embodiment, the mold comprises one or more features suitable for use forming cavities, complex internal features, flow channels, reservoirs, inlets, outlets, hierarchical meshes, or other structures or combinations thereof in an final article of manufacture (e.g., a turbine blade) produced therefrom indirectly, i.e., by means of an intermediate article (e.g., a ceramic core). In a particular embodiment, the dissolvable mold is a mold that comprises a structure network selected from an interpenetrating or semi-interpenetrating network.

The number of each of these features dependent on the particular configuration of the internal structure of the final article of manufacture produced indirectly therefrom. In a particular embodiment, the mold comprises two or more, there or more, four or more, five or more or six or more features. In one embodiment, the mold comprises a plurality of features, wherein the internal features are spaced apart. In certain embodiments, the one or more features are integral with the mold.

In one embodiment, the mold is suitable for producing one or more features in an intermediate article of manufacture (e.g., a ceramic core), wherein the one are more features are about 1 nm to about 10 m in size, more specifically about 500 nm to about 1 m, more specifically about 1 micrometer to about 1 cm, more specifically about 5 micrometers to about 500 micrometers, more specifically about 10 micrometers to about 400 micrometers, or any combination thereof of these specified dimensions.

In a particular embodiment, the mold comprises one or more elements suitable for forming one or more features in an intermediate article of manufacture (e.g., a ceramic core) selected from slots, holes, or pin-fins or a combination thereof, wherein the one or more features on the order of about 150 to about 2000 microns. In particular, the mold comprises one or more features suitable for forming features (“core features”) in the ceramic core therefrom on the order of about 150 microns, about 200 microns, about 250 microns, about 350 microns, about 400 microns, about 450 microns, or about 500 microns or more.

In a particular embodiment, the mold comprises one or more dissolvable or meltable inserts or pattern. In one embodiment, these dissolvable or meltable inserts or patterns are inserted into the inner mold before injection.

In one embodiment, the dissolvable or meltable inserts or patterns are additively manufactured using digital light processing, stereolithographic techniques, inkjet printing, direct write of fused deposition modeling techniques. In another embodiment, these inserts or patterns are manufactured by conventional manufacturing techniques, including, without limitation, injection molding. In a particular embodiment, the inserts or patterns are manufactured by hybrid techniques.

In one embodiment, the dissolvable mold comprises one or more holes to allow for insertion of one or more rods into the dissolvable mold, e.g., ceramic rods or fused quartz rods, such that the rods are integrated into the intermediate article of manufacture, a ceramic core. The one or more holes may vary in shape, for example the holes may be circular, tubular, ovular, square, rectangular, triangular, trapezoidal, or polygonal configuration in cross-section. In certain embodiments, the holes exhibit minimum and maximum cross-section width and lengths between about 100 nanometers to 1 meter, between 500 nanometers to 100 centimeters, between 1 micrometer to 1 centimeter, or between 200 micrometers to 10 millimeters or any combination thereof.

In a particular embodiment, the mold is a core/shell mold comprising an inner cavity and a connected outer cavity. In certain embodiments, the core shell mold is suitable for forming features in a final article of manufacture (airfoil exterior) selected from a platform, angel wing, dovetail, shank and fir tree features.

In a particular embodiment, the injection molding assembly permits the production of two or more ceramic cores simultaneously. In another particular embodiment, the injection molding assembly permits the production of three or more, four or more or five or more ceramic cores simultaneously.

In a particular embodiment, the mold is a sacrificial or removable mold. In one embodiment, the mold is a dissolvable mold, i.e., capable of being dissolved by a dissolving liquid or solvent. The dissolving liquid may be for example, an aqueous solution, an organic solvent or water, or acidic or basic solutions. In a particular embodiment, the mold is a dissolving mold comprises at least one polymer or co-polymer that dissolves in an dissolving liquid (e.g., an environment).

In one embodiment, the mold dissolves in an aqueous environment within about 72 hours or less, or more particularly, within about 24, about 20, about 18, about 16 or about 14 hours or less., or more particularly, within about 12, about 8, about 6, about 4, about 2 or about 1 hour or less.

In one embodiment, the mold (e.g., inner mold) is dissolvable by water. In a particular embodiment, the mold (e.g., inner mold) is dissolvable by water over a period of from about 1 to about 72 hours, and more particularly, about 6, about 8, about 10, about 12, about 14, about 16, about 18, about 20, about 22 or about 24 hours. of from about 1 to about 72 hours, and more particularly, about 6, about 8, about 10, about 12, about 14, about 16, about 18, about 20, about 22 or about 24 hours.

In a particular embodiment, the dissolvable mold is dissolvable polymer mold characterized by minimal swelling behavior upon dissolution or degradation by a dissolving liquid or solvent. In a particular embodiment, the minimal swelling behavior. In one embodiment, the minimal swelling behavior is characterized by an increase in volume of the polymer that is less than about 200%, less than about 150%, less than about 100%, less than about 50%, less than about 25% or less than about 20%. In certain embodiments, the dissolvable mold is a monolithic dissolvable mold and more particularly, a monolithic dissolvable mold prepared by additive manufacturing.

In a particular embodiment, the mold is a dissolving polymer core/shell mold.

In certain embodiments, the outer cavity of the dissolving core/shell mold exhibits features and wall thicknesses ranging from 1 micron to 10 mm, more preferably 25 microns to 2.5 mm, more preferably 100 microns to 2 mm, more preferably 300 microns to 1.75 mm, more preferably 400 microns to 1.5 mm. The features may be platform, angel wing, dovetail, shank and fir tree and other features of turbine airfoils.

In a particular embodiment, a dissolvable inner mold is fastened to a tool using an outer sheet or ribbon-like assembly comprising a metal, engineering polymer, composite or woven fiber under tension to apply compression to the dissolvable inner mold such that the sheet or ribbon-like assembly mates with the surface of the dissolvable inner mold and covers a fraction of or the entire surface of the dissolvable inner mold. Optionally an intermediate layer comprising an elastomeric, viscoelastic or rigid material may be placed between the dissolvable inner mold and the outer sheet-like assembly to distribute load uniformly or in a desired manner to the dissolvable inner mold.

In a particular embodiment, the mold is dissolvable die.

In one embodiment, the dissolvable mold (e.g., the dissolvable, additively manufactured monolithic mold) exhibits physical and thermomechanical properties that make the mold suitable for use in injection molding, including mechanical strength, toughness, moduli, and thermal stability.

In a particular embodiment, the dissolvable mold (e.g., the dissolvable, additively manufactured monolithic mold) withstands manufacturing process conditions temperatures in the range of about 0 to 300 about ° C., more specifically in the range of about 15 to about 200° C., more specifically in the range of about 120 to about 160 or about 40 to about 140° C. and at injection speeds between about 1 to about 30 ccm/s, or more particularly about 3 to about 20 ccm/s.

In another particular embodiment, the dissolvable mold (e.g., the dissolvable, additively manufactured monolithic mold) withstands pressures in the range of about 1 Pa to about 10 GPa, more specifically at pressures ranging from about 1 Pa to about 1 GPa, more specifically at pressures ranging from about 0.1 MPa to about 1000 MPa, more specifically at pressures ranging from about 1 MPa to about 50 MPa.

In yet another particular embodiment, the dissolvable mold (e.g., the dissolvable, additively manufactured monolithic mold) withstands injection viscosities ranging from about 1 cP, about 20 cP, about 200 cP, about 1000 cP, about 10,000 cP, or about 30,000 cP or higher.

In one embodiment, the dissolvable mold (e.g., the dissolvable, additively manufactured monolithic mold) is suitable for use at injection temperatures, pressures and viscosities of flowable ceramics that include silica and alumina-based ceramic compositions.

In a particular embodiment, the dissolvable mold (e.g., the dissolvable, additively manufactured monolithic mold) exhibits high toughness. In a particular embodiment, the dissolvable mold is characterized by a toughness >0.05 MJ/m3, >0.25 MJ/m3, >2.5 MJ/m3 or >12.5 MJ/m3.

In another particular embodiment, the dissolvable mold (e.g., the dissolvable, additively manufactured monolithic mold) exhibits high tensile strength. In a particular embodiment, the dissolvable mold exhibits a tensile strength >5.0 MPa preferred, >10.0 MPa, 15.0 MPa, or >20.0 MPa.

In a further particular embodiment, the dissolvable mold exhibits (e.g., the dissolvable, additively manufactured monolithic mold) good solvent or chemical resistance for certain compositions, for example >24 h in organic solvents or corrosive environments, >1 week, or >2 weeks.

In another particular embodiment, the dissolvable mold (e.g., the dissolvable, additively manufactured monolithic mold) exhibits low swelling behavior when dissolving or degrading in a solvent, such as, but not limited to, water or organic solvents.

In one embodiment, the low swelling behavior is characterized by an increase in volume of the mold during dissolution or degradation that is less than about 200% by volume, preferably less than about 50% by volume, more preferably less than about 10% by volume.

In a particular embodiment, the dissolvable mold (e.g., the dissolvable, additively manufactured monolithic mold) exhibits glass transition temperatures between about −50° C. and about 400° C., between about 20 C and about 200 C further preferred, between about 45 C and about 150 C further preferred and between about 80 C and about 130 C further preferred.

In another particularly embodiment, the dissolvable mold (e.g., the dissolvable, additively manufactured monolithic mold) exhibits tunable crystalline melt temperatures, for example, between about −80° C. and about 400° C. preferred between about 20 C and about 200 C further preferred, between about 45 C and about 150 C further preferred and between about 80 C and about 130 C further preferred),

In one embodiment, dissolvable mold (e.g., the dissolvable, additively manufactured monolithic mold) is characterized by optical clarity.

In a particular embodiment, the inner mold is set into one half of the compression shell (outer shell) with an elastic polymer layer (intermediate layer). The additively manufactured monolithic mold (inner mold) rests on top of the elastomeric polymer layer (intermediate layer) covering the interior of the compression shell (outer shell) and aids in distributing pressure in equivalent or more equivalent manners during injection across the exterior of the mold. The compression shell is assembled and used in the injection molding process to produce a final part. Once the monolithic mold has been successfully injected it is removed from the compression shell and placed in a dissolution liquid. The dissolution liquid will remove the additively manufactured monolithic mold from the injection molded material.

In certain embodiments, the injection molding assembly disclosed herein permits reduced injection molding steps and unique disassembly capabilities, including anti-adhesion advancements for injection molding assemblies.

In one embodiment, the injection mold assembly further comprises one or more additional components, including but not limited to an injection unit or plasticator, which prepares the molten material (polymer) and transfer it into the mold, where it then solidifies.

Optionally, the injection molding assembly is one component of an injection molding system. In certain embodiments, the injection molding system further comprises a software component.

The elastomeric components of the injection molding system may vary in composition. In one embodiment, the elastomeric components of the injection molding assembly comprise platinum catalyzed or moisture cure silicone rubber, polyurethane semicrystalline elastomers, polyolefin rubber, acrylic elastomers or thiol-ene elastomers.

In one embodiment, the viscoelastic components of the injection molding assembly comprise semicrystalline linear polymers, thiol-ene polymers, acrylic network polymers, linear acrylic polymers, thermoplastic polyurethanes, polyethylene, polypropylene, thiol-ene polymers, aromatic silicones, epoxy/amine, epoxy/alcohol or epoxy/thiol thermosetting polymers.

In one embodiment, the rigid components of the injection molding assembly comprise semicrystalline linear polymers, thiol-ene polymers, acrylic network polymers, linear acrylic polymers, thermoplastic polyurethanes, polyethylene, polypropylene, acrylonitrile-butadiene-styrene, poly(bisphenol A) carbonate, poly(ether ketone), polyimide, thiol-ene polymers, aromatic silicones, epoxy/amine, epoxy/alcohol or epoxy/thiol thermosetting polymers, ionic salt containing thermosetting polymers and interpenetrating networks thereof.

In one embodiment, the elastomeric, viscoelastic or rigid components of the injection molding assembly are optionally filled with inorganic or ceramic particles to afford composite materials with tunable modulus, strength and/or dielectric constant. Inorganic or ceramic fillers include, e.g., fumed silica, alumna, titanium dioxide, boron carbide, strontium titanate, silicon nitride, silicon carbide, molybdenum disulfide or calcium carbonate.

In one embodiment, the organic or ceramic fillers of the components of the injection molding assembly range from about 0.1 to about 40 vol. %, more specifically about 1 to about 20 vol %, more specifically about 1 to about 10 vol %, more specifically about 1 to about 7 vol %.

In one embodiment, the organic or ceramic fillers of the components of the injection molding assembly range in particle size diameters from about 0.1 nm to about 10 mm. In one embodiment, the organic or ceramic fillers of the components of the injection molding assembly range in particle size diameters from 0.1 nm to 10 mm, more specifically from 1 nm to 5 mm, more specifically from 50 nm to 2 mm, and more specifically from 100 nm to 1000 micrometers.

The physical characteristics of the components of the injection molding assembly may vary. In a particular embodiment, elastomeric components of the injection molding assembly exhibit storage moduli by dynamic mechanical analysis at about 20° C. and 1 Hz ranging from about 100 kPa to about 80 MPa, more specifically from about 1 MPa to about 50 MPa, more specifically from about 3 MPa to about 30 MPa.

In a particular embodiment, viscoelastic components of the injection molding assembly exhibit storage moduli by dynamic mechanical analysis at about 20° C. and 1 Hz ranging from about 10 MPa to about 1000 MPa, more specifically from about 50 MPa to about 900 MPa, and more specifically from about 100 MPa to about 800 MPa. [000186

In a particular embodiment, rigid components of the injection molding assembly exhibit storage moduli by dynamic mechanical analysis at about 20 C and 1 Hz ranging from about 50 MPa to about 500 GPa, more specifically, about 100 MPa to about 250 GPa, more specifically about 500 MPa to about 240 GPa.

The composition of the dissolvable, inner mold may vary and include any suitable dissolvable composition, e.g., a dissolvable polymer composition.

In a particular embodiment, the dissolvable mold comprises a cured formulation that is the reaction product of (i) one or more electron-poor monomers; (ii) optionally one or more electron-rich monomers; (iii) one or more catalysts and/or accelerators; and (iv) optionally one or more capping and/or chain transfer agents.

In one embodiment, the electron-poor monomer is selected from the group consisting of maleimide, N-ethylmaleimide, N-methylmaleimide, N-phenylmaleimide, N-butanoic acid maleimide, other maleimides, maleic anhydride, dimethylmaleate, dimethylfumarate, 1,2-dicyanoethylene, vinylphosphonic acid, vinylsulfonic acid, and combinations thereof.

In one embodiment, the electron-rich monomer is selected from the group consisting of N-vinylformamide, N-vinyl pyrrolidone, N-methyl-N-vinylacetamide, N-vinylacetamide, N-vinylcaprolactam, N-vinylpthalimide, N-vinylimidazole, butyl vinyl ether, 2,3-dihydrofuran, 3,4-Dihydro-2H-pyran, vinyl ethers, vinyl acetate, benzofuran, indole, 1-Methylindole, styrene, styrene derivatives, 4-hydroxystyrene, stilbene, stilbene derivatives, hydroxylated stilbene compounds, 1-Pyrrolidino-1-cyclohexene, 1-Pyrrolidino-1-cyclopentene, 1-(Trimethylsilyloxy)cyclopentane, Vinylidene carbonate, 1-Morpholinocyclohexene, 1-Morpholinocyclopentene, 1-Pyrrolidino-1-cyclohexene, Phenyl vinyl sulfide, 9-Vinylcarbazole, Trimethyl(vinyloxy)silane, and combinations thereof.

In another particular embodiment, the inner mold is a mold comprising a cured formulation that is the reaction product of (i) one or more ionic/salt containing monomers; (ii) one or more monomers capable of forming solvent soluble or solvent degradable polymers; (iii) optionally one or more catalysts and/or accelerators; and (iv) optionally one or more capping and/or chain transfer agents.

In one embodiment, the one or more ionic/salt containing monomers is selected from the group consisting of sodium acrylate, sodium methacrylate, and its hemihydrate, potassium acrylate, potassium methacrylate and its hemihydrate, silver (I) methacrylate, lithium acrylate, lithium methacrylate, 3-sulfopropyl acrylate potassium salt, [2-(acryloyloxy) ethyl]trimethylammonium chloride, 2-acrylamido-2-methyl-1-propanesulfonic acid sodium salt, and 3-acrylamidopropyl trimethylammonium chloride, nickel(ll) acrylate, hafnium(IV) acrylate, zinc(ll) acrylate, zirconium(IV) carboxyethyl acrylate, zirconium(IV) acrylate, zirconium(IV) methacrylate, copper(ll) acrylate, barium(II).

In one embodiment, the one or more monomers capable of forming solvent soluble or solvent degradable polymers is selected from the group consisting of acrylic acid, methacrylic acid, itaconic acid, itaconic anhydride, citraconic anhydride, maleic acid, fumaric acid, maleic anhydride, 1,2,3,6-Tetrahydrophthalic anhydride, 2-carboxyethylacrylate, 2-hydroxyethyl acrylate, 2-hydroxyethyl methacrylate, acrylamide, dimethylacrylamide, 2-hydroxyethyl acrylamide, 2-hydroxypropyl acrylamide, 2-hydroxypropyl methacrylamide, 2-acrylamido-2-methyl-1-propanesulfonic acid, diacetone acrylamide, 2-(methacryloyloxy)ethyl acetoacetate, mono-2-(acryloyloxy)ethyl succinate, mono-2-(methacryloyloxy)ethyl succinate, N-[3-(dimethylamino) propyl]acrylamide, 2-(dimethylamino)ethyl acrylate, N-[3-(dimethylamino)propyl]methacrylamide, N-(butoxymethyl)acrylamide, N-(isobutoxymethyl)acrylamide, N-(3-methoxypropyl)acrylamide, N-(3-ethoxypropyl)acrylamide, 2-(diethylamino)ethyl acrylate, hydroxy propyl acrylate, hydroxypropyl methacrylate, 2-hydroxy-3-phenoxypropyl acrylate, ethylene glycol phenyl ether acrylate, di(ethylene glycol) ethyl ether acrylate, di(ethylene glycol) 2-ethylhexyl ether acrylate, etrahydrofurfuryl acrylate, 2-[[(butylamino)carbonyl]oxy]ethy 1 acrylate, poly(propylene glycol) acrylate, poly(ethylene glycol) methyl ether acrylate, dodecyl acrylate, 2-carboxyethyl acrylate oligomers, hydroxypropyl acrylate, 2-ethylhexyl acrylate, isobornyl acrylate, N-isopropylacrylamide, N-vinylformamide, N-vinyl pyrrolidone, N-methyl-N-vinylacetamide, N-vinylacetamide, 4-vinylpyridine, 4-acryloylmorpholine, N-vinylcaprolactam, N-vinylpthalimide, N-vinylimidazole, 3-sulfopropyl acrylate potassium salt, methoxymethyl acrylamide, methoxyethyl acrylamide, methoxybutyl acrylamide, ethoxyethyl acrylamide, ethoxymethyl acrylamide, ethoxypropyl acrylamide, propoxymethyl acrylamide, propoxyethyl acrylamide, N,N-diethyl acrylamide, dimethyl acryl de, alkyl acrylamides, tert-butyl acrylamide, 2-(methacryloyloxy)ethyl acetoacetate, di(ethylene glycol) methyl ether methacrylate, 2-N-morpholinoethyl methacrylate, cyclohexyl methacrylate, ureido methacrylate, N-succinimidyl methacrylate, butyl methacrylate, isobutyl methacrylate, tert-butyl methacrylate, sec-butyl methacrylate, 2-(tert-butylamino)ethyl methacrylate, 2-(diethylamino)ethyl methacrylate, ethylene glycol methyl ether methacrylate and triethylene glycol methyl ether methacrylate, monomers derived from the reaction of hydroxylated acrylates or methacrylates with organic anhydrides, and combinations thereof.

In another particular embodiment, the dissolvable mold comprises a cured formulation that is the reaction product of (i) one or more alkene monomers; (ii) one or more polythiol monomers; and (iii) one or more capping and/or chain transfer agents; wherein the one or more alkene monomers, the one or more polythiol monomers, or both comprise solvent soluble or solvent degradable anhydride linkages. In one embodiment, the one or more alkene monomers are selected from the group consisting of crotonic anhydride, methacrylic anhydride, or a combination thereof. In another embodiment, the one or more polythiol monomers is selected from the group consisting of linalool dimercaptan, terpinolene dimercaptan, terpinene dimercaptan, geraniol dimercapan, citral dimercaptan, dicyclopentadiene dimercaptan, norbomadiene dimercaptan, retinol dimercaptan, retinol trimercaptan, retinol tetramercaptan, beta-carotene polymercaptans, mercaptan-containing cyclic alkenes, tertiary mercaptans, cycloaliphatic mercaptans, polyfunctional tertiary mercaptans, mixed secondary and tertiary mercaptans, mercaptan-containing secondary cycloaliphatic alkenes, mercaptan containing polycyclic alkenes, trivinylcyclohexene dimercaptan, trivinylcyclohexene trimercaptan, polymercaptans, cycloaliphatic mercaptans, and vinylcyclohexene.

The one or more catalysts and/or accelerators in the embodiments above may vary. In a particular embodiment, the one or more catalysts is selected from the group consisting of aluminum(III) acetylacetonate, ammonium cobalt(m sulfate hexahydrate, bis(acetylacetonato) dioxomolybdenum, cadmium acetylacetonate, cobalt(II) acetate tetrahydrate, cobalt(III) acetylacetonate, copper(II) acetylacetonate, iron(ill) acetylacetonate, manganese(III) acetylacetonate, tetrabutyl orthotitanate, tetraethylammonium tetrachlorocobaltate, tetrabutylammonium dichromate, magnesium acetylacetonate dihydrate, zinc acetylacetonate hydrate, gallium acetylacetonate, titanium diisopropoxide bis(acetylacetonate), titanium(IV) isopropoxide, tributylborate, triethylborate, triethylphosphite, N-dodecyl-N,N-dimethyl-3-ammonium-1-propanesulfonate, 3-mercapto-1-propanesulfonic acid, sodium salt, 3-pyridinio-1-propanesulfonate, citric acid, triethylene diamine, piperazine, tetrabutylammonium hydrogensulfate, tetraethylammonium toluene sulfonate, tetrabutylammonium bromide, tetraethylammonium bromide, lithium acetylacetonate, lithium iodide, lithium perchlorate, lithium tetraphenylborate, and combinations thereof

In one or more capping or chain transfer agents in the embodiments disclosed above is selected from the group consisting dodecyl 3-mercaptopropionate, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, monofunctional aliphatic linear thiols, monofunctional aliphatic branched thiols, 1,8-dimercapto-3,6-dioxaoctane, n-dodecyl mercaptan, n-octyl mercaptan, pentaerythritol tetrakis(3-mercaptobutylate), 1,4-bis (3-mercaptobutylyloxy) butane, 1,3,5-Tris(3-mercaptobutyloxethyl)-1,3,5-triazine-2,4, 6(1H,3H,5H)-trione, tertiarydodecyl mercaptan, ethyl mercaptan, isopropyl mercaptan, dipentene dimercaptan, methyl mercaptan, n-propyl mercaptan, sec-butyl mercaptan, tert-nonyl mercaptan, tert-dodecyl mercaptan, tertiary mercaptan blends, tert-butyl mercaptan, grapefruit mercaptan, thioglycolic acid, thiolactic acid, 3-mercaptopropionic acid, ammonium thioglycolate, monoethanolamine thioglycolate, sodium thioglycolate, potassium thioglycolate, 2-ethylhexyl thioglycolate, isooctyl thioglycolate, iso-tridecyl thioglycolate, glyceryl thioglycolate, glyceryl dimercaptoacetate, pentaerythritol tetramercaptoacetate, butyl-3-mercaptopropionate, 2-ethylhexyl-3-mercaptopropionate, iso-tridecyl-3-mercaptopropionate, octadecyl 3-mercaptopropionate, ethoxylated trimethylolpropane tris(3-mercaptopropionate), monoethanolamine thiolactate, thiodiglycolic acid, diammonium dithioglycolate, di(2-ethylhexyl) thiodiglycolate, methylene bis(butylthioglycolate), thiodipropionic acid, dithiobis(stearylpropionate), thioglycerol, dithioglycerol, triphenylsilane, triethylsilane, triisopropylsilane, tributylsilane, triisobutylsilane, trioctylsilane, and tert-butyldimethylsilane, triethylsilane, triisopropylsilane, tributylsilane, triisobutylsilane, trioctylsilane, and tert-butyldimethylsilane,

The injection molding assembly disclosed herein optionally includes an intermediate layer. The intermediate later is suitable for functioning including distributing pressure during injection throughout the inner, intermediate and outer mold layers and transferring force of injection or other forces, whether internal or external, between layers. In certain embodiments, the intermediate layer is additively manufactured. Optionally, the intermediate layer is dissolvable.

In a particular embodiment, the intermediate layer and optionally the rigid outer shell comprise one or more recesses or holes to support ceramic rods or fused quartz rods in the dissolvable mold during injection or ensure proper location of ceramic rods or fused quartz rods in the dissolvable mold during injection.

The design of the intermediate layer may vary. In one embodiment, the intermediate layer comprises two or more components. In another particular embodiment, the intermediate layer comprises three or four components.

In a particular embodiment, the intermediate layer has a thickness (width) ranging from about 1 nm to about 1 m, more specifically about 1 nm to about 10 mm, more specifically about 100 nm to about 5 mm, more specifically about 1 micrometer to about 1000 micrometers.

In a preferred embodiment, the intermediate layer mates with the outer shell with a gap ranging from about 1 nm to about 5 cm, more specifically about 1 micrometer to about 1 mm, more specifically about 5 micrometers to about 500 micrometers, more specifically about 10 micrometers to about 75 micrometers.

The composition of the intermediate layer may vary. In a particular embodiment, the injection molding assembly comprises an intermediate layer comprising organic, inorganic, ceramic, metallic, composite, thermoplastic polymeric or other particles ranging in size with diameters ranging from about 0.1 nm to about 10 mm, more specifically from about 1 nm to about 5 mm, more specifically from about 50 nm to about 2 mm, and more specifically from about 100 nm to about 1000 micrometers.

In a particular embodiment, the intermediate layer comprises a thermosetting elastomeric polymer. In one embodiment, the thermosetting elastomer is a platinum catalyzed siloxane resin or a moisture cure silicone.

In another embodiment, the intermediate layer comprises a thermosetting polyurethane that is elastomeric, viscoelastic or glass at ambient temperature.

In another embodiment, the intermediate layer comprises a thermosetting epoxy resin that is elastomeric, viscoelastic or glassy at ambient temperature.

In one embodiment, the intermediate layer comprises a fluoropolymer, a silicon or siloxane-containing polymeric elastomer, C6-C110+ hydrocarbon chains or hydrophilic layers or coatings, including aqueous, polar organic molecules or macromolecules that include polysaccharides, mono- di, tri-, tetra-, penta- and hexa-hydroxyl compounds.

In one embodiment, the intermediate layer is a powder layer.

In a particular embodiment, the intermediate layer comprises a powder comprising organic, inorganic, ceramic, metallic, composite, thermoplastic polymeric constituents. The intermediate powder layer may be packed using powder compaction techniques. Optionally a liquid may be added to powder to remove void space. In one embodiment, the liquid is an organic oil, ionic liquid, water or organic solvent.

The intermediate powder layer may be packed using cold powder compaction techniques to afford tapped densities of about 10%-about 99%, more specifically about 30%-about 95%, and more specifically from about 55%-about 90%. The intermediate powder layer may be packed using powder compaction techniques at pressures ranging from about 1 kPa to about 100 GPa, more specifically about 10 kPa to about 10 GPa, more specifically about 100 kPa to about 1 GPa, and more specifically from about 1 MPa to about 100 MPa. T

The intermediate powder layer may be comprised of sand, silica, polymers including acrylonitrile-butadiene-styrene powder and/or carbohydrate-based powder including cellulose and other polyether polymeric species. The intermediate powder layer may have a void space percentage after packing between 0.1% and 40%, more specifically between 1% and 30%, more specifically between 2% and 27%, and more specially between 3% and 20%. Optionally a liquid may be added to powder to remove void space.

In a particular embodiment, the intermediate layer comprises a fluid. In one embodiment, the fluid is selected from an organic oil, an ionic liquid, water or an organic solvent.

In a particular embodiment, the intermediate layer comprises a fluid.

In a particular embodiment, the intermediate layer comprises an incompressible fluid such as oil or water or a pressurized compressible fluid such as compressed air, nitrogen or carbon dioxide, or a mixture of condensed matter, compressible and incompressible fluids. Incompressible fluids suitable for use in this embodiment include silicone oils, hydrocarbon oils, organic solvents, molten hydrocarbon waxes, water or molten ionic liquids. In this embodiment void space between the outer surface of the dissolvable inner mold and the inner surface of the outer shell is filled with an incompressible fluid such as to minimize and eliminate void space in the intermediate layer of the assembly. The outer shell is hermetically sealed such that the incompressible fluid is fully confined between the outer shell and the dissolvable inner mold.

Alternatively, the cavity between the outer shell and the dissolvable inner mold is pressurized with a compressible fluid to a pressure level lower than, equivalent to or greater than the injection pressures used to inject flowable material including ceramic slurries the assembly. Compressible fluids suitable for use in this embodiment include air, nitrogen or carbon dioxide. In this embodiment, injection forces are transmitted through the dissolvable insert walls, through the incompressible or compressible fluid through the dissolvable insert walls, through the incompressible or compressible fluid intermediate layer to the outer shell. This fluid-based intermediate layer reduces the effective forces acting on the dissolvable mold as the pressures of the internal cavity or cavities of the dissolvable mold are counter-acted or balanced by those of the incompressible or compressible fluid confined in an outer shell.

In one embodiment, injection forces are transmitted through the dissolvable insert walls, through the incompressible or compressible fluid intermediate layer to the outer shell. This fluid-based intermediate layer reduces the effective forces acting on the dissolvable mold as the pressures of the internal cavity or cavities of the dissolvable mold are counter-acted or balanced by those of the incompressible or compressible fluid confined in an outer shell. In this embodiment the compressible or incompressible intermediate layer serves to reduce displacement of the dissolvable mold or dissolvable mold surfaces and to reduce effective stresses acting on the dissolvable mold.

In this embodiment the compressible or incompressible intermediate layer serves to reduce displacement of the dissolvable mold or dissolvable mold surfaces and to reduce effective stresses acting on the dissolvable mold. Viscosities of incompressible fluids suitable for use in the intermediate layer range from about 1 cP to about 1000 cP, more specifically about 1 cP to about 400 cP, more specifically about 1 cP to about 100 cP, more specifically about 11 cP to about 60 cP. Pressures of compressible fluids suitable for use in the intermediate layer of this embodiment range from about 1 Pa to 1 about GPa, more specifically at pressures ranging from about 0.1 MPa to about 1000 MPa, more specifically at pressures ranging from about 0.1 MPa to about 50 MPa. Temperatures of compressible or incompressible fluids suitable for use in the intermediate layer of this embodiment range from about 0 to about 300 C, more specifically in the range of about 15 to about 200 C, more specifically in the range of about 15 to about 140 C.

The injection molding assembly described herein optionally comprises an outer shell. The design of the outer shell may vary. In one embodiment, the outer shell comprises two or more components. In another embodiment, the outer shell casing comprises three or more components.

The composition of the outer shell may vary. In a particular embodiment, the outer shell comprises a material selected from the group consisting of metals, ceramics, thermosetting polymers, engineering thermoplastics or other material. In a particular embodiment, the outer shell comprises a metal selected from the group consisting of aluminum and steel. In a particular embodiment, the ceramic is an engineered ceramic and more particularly, an engineered ceramic selected from the group consisting of metal oxides, carbides, and nitrides. In one embodiment, the ceramic is a composite ceramic. In another particular embodiment, the thermoplastic polymer is selected from the group consisting of acrylonitrile-butadiene-styrene, polyethylene, polycarbonate, polyamide, high impact polystyrene and polypropylene. In a further particular embodiment, the thermosetting polymer is selected from the group consisting of epoxies, phenolics, silicones, and polyesters. These materials may contain one or more additives to improve the overall performance and/or appearance of the finished product

In a particular embodiment, the other shell casing is rigid, with a storage modulus at 1 Hz and at about 20 C as characterized by dynamic mechanical analysis ranging from 50 MPa to 500 GPa, more specifically, 100 MPa to 250 GPa, more specifically 500 MPa to 240 GPa

In certain embodiments, the outer shell is additively manufactured.

In other embodiments, the outer shell is dissolvable, e.g., in aqueous environments, organic solvents, supercritical fluids, ionic liquids, molten molecular species and other solvents.

In a particular embodiment, the assembly (either as a whole, or one or more components of the assembly) are additively manufactured. Additive manufacturing techniques suitable for forming assembly components disclosed herein include stereolithographic (SLA) techniques, digital light processing (DLP), inkjet printing, direct write, and other additive manufacturing processes, including additive manufacturing processes in which ultraviolet or visible light is projected using a layer by layer process in which photopolymerization is selectively employed to form articles of manufacture of desired geometric patterns and after each projected layer is formed, each hardened layer is moved from the position in which it was hardened in a controlled or desired manner to allow for an additional layer to be hardened after light exposure, such that each hardened layer forms and adheres in a suitable manner to the previous layer formed. These additive manufacturing processes may be controlled by engineered systems integration parameters for materials/hardware/software.

In a particular embodiment, one or more components of the injection molding assembly (e.g., the inner mold) is produced by photopolymer jetting, an additive manufacturing technique that combines the techniques used in ink-jet printing and stereolithography. An array of inkjet print heads to deposit tiny drops of build material and support material to form each layer of a part, as in ink-jet printing, and the build material is a liquid photopolymer that is cured by a UV lamp after each layer is deposited, as in stereolithography.

In a particular embodiment, one or more components of the injection molding assembly (e.g., the inner mold) is produced using digital light processing (“DLP”), a layer by layer stereolithographic process in which a three dimensional object is formed by projecting one layer at a time through an optically clear window into a vat of photocurable polymer resin such that the resin hardens in the shape of the projected light. Initially layers of DLP printing result in resin such that the hardened initial layers adhere to a build head or supports connected to a build head, and each subsequently hardened layer then adheres to a layer hardened before it. Build heads in DLP printing are mechanically controlled to move in a positive or negative vertical direction using software/firmware.

In a particular embodiment, inner, intermediate or outer assembly components of the injection molding assembly disclosed herein may be formed using additive manufacturing techniques that afford gradient materials comprising polymeric, ceramic, composite or metal constituents in selectively blended ratios that afford tunably varying physical, thermomechanical and geometric properties for inner, intermediate or outer assembly components disclosed herein. Moduli in gradient material components may vary from ranges of about 0.1 MPa/micrometer to about 100 GPa/micrometer, more specifically from about 0.1 MPa/micrometer to about 11 GPa/micrometer, more specifically from about 0.5 MPa/micrometer to about 500 MPa/micrometer, more specifically from about 1 MPa/micrometer to about 100 MPa/micrometer.

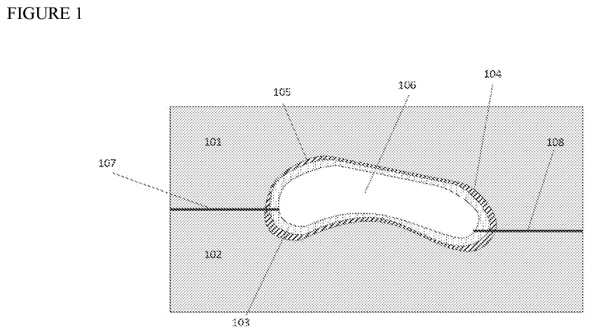

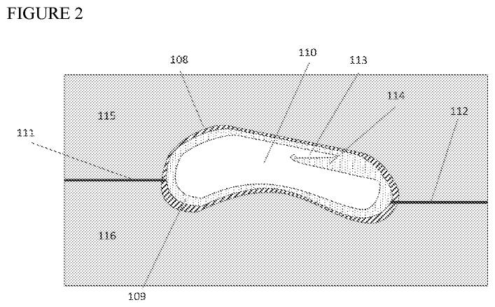

FIG. 1 depicts an embodiment of the injection molding assembly disclosed herein, comprising an additively manufactured mold and an outer shell (101, 102), divided into two halves at roughly the center of the object (107, 108). The assembly represented in FIG. 1 may be formed using a manufacturing method that involves additively manufacturing an outer shell in two sections (103, 104). When combined, these outer shell sections form a geometry that possesses an open internal negative cavity that is suitable for injection with a flowable material (e.g., a ceramic slurry) in processes that include injection molding (106). The outer shell material may be machined from metals, such as aluminum or steel, ceramics, thermosetting polymers, engineering thermoplastics or other materials or additively manufactured from metals, plastics, ceramics, thermoplastic or thermosetting polymers.

After the mold and compression shell are produced, a curable thermosetting polymer or composite blend (105) may be injected into cavities in the internal side of each half of the compression shell and given time to cure. The curable injectable polymer may be comprised of A+B silicone precursors, including platinum catalyzed siloxane resins, moisture cure silicones, thermosetting polyurethanes or epoxies, after curing, is suitable for acting as a support layer between the compressive shell and the additively manufactured mold. The intermediate support layer is suitable for reducing the requirement that the exterior of the mold and interior of the compressive shell mate perfectly and is suitable for providing a mating interface for inner, intermediate and outer layers embodied in the assemblies for injection molding disclosed herein. The intermediate layer is suitable for functions that include evenly transmitting loads between geometric configurations of inner and outer layers that include uneven exterior of the inner mold and interior of the outer shell.

To assemble the compressive shell and mold for injection, half (104) of the additively manufactured mold may be set in half (101) of the compressive shell. This process will be repeated with half (103) of the compression shell and half (102) of the mold. Complete assembly of the shell and mold will feature half (101), half (104), negative cavity (106), half (103), half (102). The completed assembly can fit into an injection molding machine and be injected with injection molding material. Once the material is successfully injected into the mold it can be retrieved by removing one half of the assembly. At this point, the compression shell and additively manufactured mold may be used again, or the additively manufactured shell can be discarded in favor of a new iteration of the design. When selecting a new mold, the additively manufactured object exhibits generic exterior that generally matches the inside of the compression shell, but the interior of the mold can vary significantly.

FIG. 2 illustrates an embodiment wherein two-part compression shell can be used to support an additively manufactured monolithic mold and the additively manufactured monolithic mold is removed via dissolution after the injection molding process. The ability to create a monolithic mold that can be removed via dissolution solves a key design problem inherent with standard injection molding. FIG. 2 illustrates a monolithic mold placed inside a two-part compression shell. Design feature (113) resides entirely on the top half of the mold. If this design were manufactured using the standard injection molding process feature (113) would crack off when the two halves of the metal mold were separated. This example illustrates the design limitations inherent with traditional injection molding. Monolithic molds (109) removed via dissolution methods enable the injection molding of complex geometric shapes that will not fracture when removed.

Disclosed herein an additively manufactured monolithic mold (109) with an internal cavity that is a negative replica of the final part that will be produced (110), while the outside of the monolithic mold is a generic shape suitable from facile assembly and disassembly of the mold assembly disclosed herein. Concurrent with additive manufacturing, a compressive shell of two halves (115, 116) is machined from metals, such as aluminum or steel, is produced with an external shape consistent with square or rectangle shapes commonly associated with injection molds. The internal side of each compressive shell is machined to match the generic external shape of the additively manufactured monolithic mold.

After the mold and compressive shell are produced a polymeric or polymer composite intermediate layer (108) is applied to the internal side of each half of the compressive shell or to the external surface of the monolithic mold (109) and given time to dry, harden, set or cure. The polymeric or polymer composite intermediate layer acts as a support layer between the compressive shell and the additively manufactured mold. The intermediate layer reduces the requirement that the exterior of the mold and interior of the compressive shell mate perfectly and serves to evenly transmit loads between the uneven exterior of the mold and interior of the compressive shell. The intermediate layer is of sufficient thickness to provide sufficient support to the additively manufactured mold but of sufficient thinness to enable the mold to benefit from the increased strength provided by the compressive shell.

To assemble the compressive shell and mold for injection molding, the mold (109) (inner mold) will be set in half (116) of the compressive shell (outer shell). Complete assembly of the shell and mold will feature half (116), mold (109) with cavity (110), half (115). The completed assembly can fit into an injection molding machine and be injected with a given material, e.g., plastic material, ceramic material. Once the mold is successfully injected the compression shell will be taken apart and monolithic mold 109 is removed. At this stage, monolithic mold (109) is filled with the injection material.

Removal of the additively manufactured mold from the final injected part requires the submersion of the additively manufactured mold in a liquid for dissolution. This liquid must be carefully chosen so that it can dissolve, disperse or degrade the mold material but not harm the interior part. Once the additively manufactured mold is removed the injection molded part can be removed from the dissolution liquid. In this embodiment, the additively manufactured mold is consumed during the process, requiring a new monolithic mold to be utilized with the existing compression shell for each design.

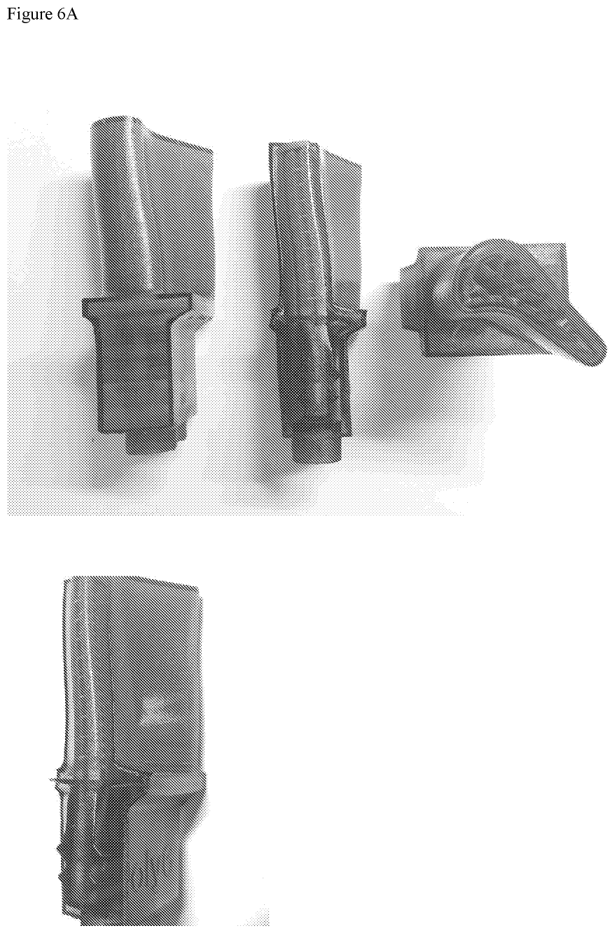

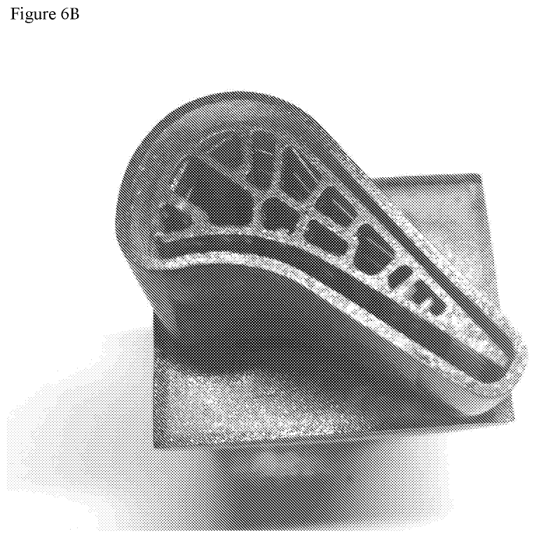

FIG. 6 depicts an embodiment of the additively manufactured core/shell mold disclosed herein. This core/shell mold was formed using digital light projection stereolithographic 3D printing.

### III. Method of Manufacturing the Injection Molding Assembly and Components

Described herein are methods of manufacturing the injection molding assembly disclosed herein, as well as the individual components thereof. In another embodiment, a process for preparation, assembly and/or disassembly is disclosed with respect to the inner mold, intermediate layer, and outer shell of the injection molding assembly disclosed herein.

In one embodiment, the method is disclosed for preparation of the injection molding assembly, comprising (i) providing a suitable material(s); and (ii) utilizing a suitable technique(s) to produce a mold, an intermediate layer and/or an outer layer from the suitable material(s).

In one embodiment, the suitable technique is an additive manufacturing technique, a conventional manufacturing technique or a combination of both (i.e., a hybrid manufacturing process).

In certain embodiments, the methods disclosed herein provide process integration of additive manufacturing and injection molding to permit improved geometric resolution, geometric feature design in combination with high throughout put capability.

In a particular embodiment, the inner mold is prepared by additive manufacturing and the outer shell are prepared by conventional manufacturing.

In one embodiment, disclosed herein is a method of fabrication and use of dissolvable molds that are optionally components of injection molding assemblies suitable for injection molding processes with surrounding outer layers, in which the dissolvable molds have internal cavities that are filled using injection molding processes.

In a certain embodiment, the method of fabrication of the dissolvable mold is additive manufacture and the method is scalable. In a particular embodiment, the dissolvable mold is a dissolvable, additively manufactured monolithic polymer mold.

In one embodiment the method of preparing dissolvable, additively manufactured monolithic polymer mold is repeated multiple times, with yields of greater than about 80%, and more particularly, about 85% or about 85% or more.

In a particular embodiment, the method of preparing dissolvable, additively manufactured monolithic polymer mold is repeated multiple times in order to provide between about 15 and about 20 such molds.

In one embodiment, the method of preparing the dissolvable, additively manufactured monolithic polymer molds permits dimensional repeatability.

In one embodiment, the method disclosed herein permits one or more steps of traditional investment casting processes to eliminated, including core/die assembly, wax over-molding and ceramic shelling.

In a particular embodiment, a method of manufacturing an monolithic mold (e.g., an inner monolithic mold) is disclosed, comprising (i) providing a suitable material(s) (e.g., a polymer or co-polymer material that optionally dissolves in a dissolving liquid) and (ii) utilizing a suitable technique(s) to provide the monolithic mold using the suitable material(s). In a particular embodiment, the suitable technique is an additive manufacturing technique(s). In a particular embodiment, the additive manufacturing technique is photopolymer jetting or digital light processing.

In a particular embodiment, the intermediate layer is prepared by a method comprising (i) providing a suitable material (e.g., a thermosetting elastomer) and (ii) utilizing a suitable technique(s) to produce the intermediate layer from the suitable material(s), wherein the suitable technique is selected from the group consisting of casting, spray, paint-on, vapor deposition, pour-in, injection molding, vacuum molding, two-photon polymerization, digital light projection or biological incubation processes. In this embodiment, diffusion of molecular, oligomeric or macromolecular constituents, including but not limited to hydrophilic or hydrophobic constituents into inner and/or outer assembly layers from intermediate layer is suitable for hardening, softening, plasticizing, curing, partially dissolving, selectively precipitating, polymerizing or optionally affording phase separations in inner or outer assembly layers that give rise to adhesive, omniphobic, selectively soluble, tunably mechanically robust, responsively compliant, viscoelastic or elastomeric behavior.

In a particular embodiment, the inner, intermediate and outer components of the inject molding assembly (i.e., the inner mold, intermediate layer and outer shell) are formed by a process or technique selected from the group consisting of spraying, dip-coating, injection molding, casting, diffusion-based plasticization, biological incubation, digital light projection, stereolithographic processes, blow molding, foaming, subtractive machining, investment casting and other processes.

In a particular embodiment, method is disclosed for assembling the injection molding assembly disclosed herein, comprising (i) setting the inner monolithic mold disclosed herein onto the intermediate layer disclosed herein, such hat the inner monolithic mold) rests on top of intermediate layer, wherein the intermediate layer covers the interior of the outer shell and aids in equally or more equally distributing pressure during injection across the exterior of the mold; (ii) The compression shell is then assembled by forming and/or closing the intermediate layer around the inner mold if an intermediate layer is utilized, subsequently closing the outer shell to provide the injection molding assembly and used in the injection molding process to produce an injection molded material (e.g., a ceramic core). Once the monolithic mold is injected it is removed from the compression shell and placed in a dissolution liquid. The dissolution liquid removes the monolithic mold from the injection molded material.

### IV. Methods of Manufacturing an Intermediate Article

Disclosed herein are methods for manufacturing articles of manufacture and more particularly, methods of producing articles of manufacture by casting. In certain embodiments, the method of manufacture produces an intermediate article, i.e., an article of manufacture that is thereafter used to prepare a second or final article of manufacture. In a particular embodiment, the method of manufacture produces ceramic core that thereafter can be used to cast a metal component (e.g., a turbine blade), wherein the cast metal components have desired geometries. In certain embodiments, intermediate article of manufacture may optionally be stored for a period of time before it is used to prepare a second or final article of manufacture.

In a particular embodiment, the processes disclosed herein are suitable for use in the manufacture of ceramics, thermosetting polymers, thermoplastic polymers, metal alloys, curable thermosetting elastomers, thermosetting biological materials, incubated cell culture constituents.

In certain embodiments, the methods disclosed herein permit the manufacture of intermediate articles such as ceramic cores in a shorter time frame than existing methods, which reduces manufacturing costs and lead times for new designs. For example, CAD to core production lead times using the methods of the present invention can be reduced from about 36 weeks for a multi-walled core to about 6 weeks or less and about 30 weeks for a single walled core to about 6 weeks or less.

In one embodiment, a method of manufacturing an intermediate article (e.g., a ceramic core, core/shell mold) is disclosed, comprising (i) providing a suitable material (“feedstock”); and (ii) utilizing a suitable technique(s) to form an intermediate article from the suitable material(s). Optionally, the intermediate article is used to manufacture a final article (e.g., a cast metal component, such as a turbine blade).

In a particular embodiment, the intermediate article is a ceramic core, wherein the feedstock is a ceramic slurry and the suitable technique is injection molding. In certain embodiments, the injection molding utilizes the injection molding assembly disclosed herein. In a particular embodiment, the mold component of the injection mold assembly (e.g., the inner mold) is a dissolvable, additively manufactured, monolithic polymer mold.

In another embodiment, a method of preparing a ceramic green body is disclosed, comprising (i) injection of a flowable ceramic composition into a dissolvable mold (e.g., a dissolvable, additively manufactured monolithic polymer mold) comprising an inner cavity, wherein the dissolvable mold is present within an injection molding assembly disclosed herein; b) allowing the flowable ceramic composition to solidify in the inner cavity to form a ceramic green body; (c) disassembling the injection molding assembly after injection, (d) placing the injected dissolvable inner mold into water or solvent until dissolvable components are removed and an isolated green body is produced; and optionally, (e) further processing the isolated ceramic green body to provide a ceramic core.

In one embodiment, the further processing in (e) comprising (i) treating the ceramic green body to remove the binder (debinding), thereby producing a ceramic brown body; and (ii) densifying the ceramic brown body by sintering to produce a ceramic sintered article or ceramic core having the desired shape and internal structure. The selective removal of soluble carrier phases is suitable for creating porosity and open internal channels within post-injection ceramic green state articles to allow for escape of volatile decomposition products during the sintering processes. The porosity can be measured, e.g., by X-ray diffraction.

In one embodiment, the debinding is immersion-based (solvent) debinding, solvent vapor debinding, thermal debinding (polymer burnout), catalytic debinding, vacuum debinding, wicking, or combinations thereof. In a particular embodiment, the debinding comprises solvent debinding followed by thermal debinding.

In a particular embodiment, the debinding is solvent debinding comprising immersing the ceramic green body in water or another organic solvent (e.g., ethanol) for a suitable period of time, such that the selective dissolution of one or more inhomogeneous phases removes a soluble carrier phase from the green body while leaving behind an insoluble polymer. In a particular embodiment, the ceramic green body is dried following solvent debinding but prior to sintering. In certain embodiments, solvent debinding utilizes a gas as opposed to a liquid.

In another embodiment, the debinding is thermal debinding and the treatment comprises heating the ceramic green body at a temperature above the volatilization temperature of the carrier/binder and more particularly, between about 100 and about 600° C., for a suitable period of time. In one embodiment, the suitable period of time is greater than about 10, greater than about 20, greater than about 30, greater than about 40, greater than about 50 or greater than about 60 hours.

In one embodiment, the debinding comprises solvent debinding followed by thermal debinding.

Sintering parameters depend on the type and electronic properties of the ceramic powder used and, as a result, ceramic injection molded (CIM) components are obtained. In one embodiment, the sintering comprises heating the ceramic green body to a temperature between about 1200 and about 1600° C. to produce a ceramic brown body.

In certain embodiments, one or more chemical additives or mechanical restraints are utilized to maintain the ceramic green body shape and dimensions during the binder removal and sintering processes. In a particular embodiment, the sintered ceramic core is subject to one or more further processing methods, including, without limitation, finishing, machining, polishing, heat treatment, straightening, and electroplating steps.

In a particular embodiment, a profile correction step is utilized before debinding and sintering.

In another particular embodiment, the method disclosed herein involves heating and pressurization of the flowable ceramic composition to produce ceramic green body, which is subjected to subsequent immersion in aqueous or solvent conditions. During immersion dissolution of the injected dissolvable inner mold and optionally aqueous or solvent debinding of ceramic green body, injection of the ceramic core may occur simultaneously or in subsequent steps. During debinding, the soluble component of the binder with the ceramic slurry is removed, and system of pore channels develops to allow removal of the remaining component. An aqueously or solvent debinded green state ceramic core is then fired, during which thermal debinding may occur of remaining organic constituents of ceramic slurry, resulting in brown body. After the debinding process, sintering takes place.

In certain embodiment, the method further comprising the preparing the ceramic slurry, e.g., by mixing the components thereof.

In another embodiment, a method of preparing a ceramic core or core/shell is disclosed, comprising (i) injection of a flowable ceramic composition into a dissolvable mold comprising a cavity, wherein the dissolvable mold is present within an injection molding assembly of the disclosed herein; b) allowing the flowable ceramic composition to solidify in the mold cavity to form a ceramic green body; (c) disassembling the injection molding assembly of disclosed herein after injection, (d) placing the injected dissolvable inner mold into water or solvent until dissolvable components are removed and an isolated green body is produced; and (e) further processing the isolated ceramic green body to provide a ceramic core, according to any of the method disclosed herein for further processing a ceramic green body.

In a particular embodiment, a method is disclosed for forming a core/shell wherein the method does not comprise wax-shelling.

In certain embodiments, the method of manufacturing the intermediate article (e.g., ceramic core) is scalable, reducing CAD to core production lead times using the methods disclosed herein from about 36 weeks for a multi-walled core to about 6 weeks or less and from about 30 weeks for a single walled core to 6 about weeks or less. In a particular embodiment, the method of manufacture of the intermediate article indirectly permits design enablement of scalable complex geometric complexity of cast turbomachinery components.

The method of preparing the intermediate article (e.g., the ceramic core) is conducted under suitable processing conditions. In a particular embodiment, the suitable processing conditions including injection temperature, injection pressure, injection rate, injection time, holding time, holding pressure and the like.

In one embodiment, the method of injection molding is low-pressure, medium-pressure or high-pressure injection molding.

In one embodiment, the injection processing conditions are the same or similar to the curing or solidification conditions. In another embodiment, one or more of the injection conditions differ from one or more of the curing conditions, e.g., with respect to temperature, pressure, time or the like.

In certain embodiments, the mold (e.g., the inner mold and more particularly, the dissolvable, additively manufactured monolithic polymer mold) may be provided cooled, at room temperature or heated. In embodiments, the dissolvable mold is between about 20 and about 80 minutes, or more particularly, about 30 and about 60 minutes, or even more particularly, about 30 or about 60 minutes.

The injection temperature may vary. In one embodiment, the injection temperature is the range of about 0 to about 300° C., more specifically in the range of about 15 to about 200° C., more specifically in the range of about 20 to about 140° C.

The injection time may vary. Injection time between 100 milliseconds and 1 minute, or more particularly 500 milliseconds to 45 seconds, or more specifically one second to about 30 seconds.

In a particular embodiment, the injection temperature is between about 0 and about 20° C., about 20 and about 40° C., about 40 and about 60° C., about 60 and about 80° C., about 80 and about 100° C., about 100 and about 120° C. or about 120 and about 140° C.

In a particular embodiment, the injection temperature is room temperature, or between about 20 and about 25 C.°

The injection pressure may vary. In a particular embodiment, the ceramic slurry is injected at a pressure ranging from about 1 Pa to about 1 GPa, more specifically at pressures ranging from about 100 Pa to about 1000 MPa, more specifically at pressures ranging from about 0.1 MPa to about 50 MPa.

Curing or solidification time of injected material may vary. In a particular embodiment, the curing or solidification time ranges from 1 second to 2 days depending on the type of ceramic binder used, and more particularly, about 1 second, about 10 seconds, about 30 seconds, about 60 seconds, about 5 minutes, about 10 minutes, about 30 minutes, about 1 hour, about 3 hours, about 6 hours, about 12 hours, about 18 hours, about 20 hours or about 24 hours.

The curing temperature may vary. In one embodiment, low pressure injection is utilized to introduce the flowable ceramic slurry into the mold and the curing temperature for the ceramic slurry is higher than the injection temperature.

In certain embodiment, the ceramic core is stored for a period of time before it is used. In a particular embodiment, the ceramic core can be stored without losing more than 99% or more than 95% of its physical or molding properties.

In a particular embodiment, the method disclosed herein provides a ceramic core with one or more desirable properties including but not limited to (i) suitable green strength to withstand the casting of a molten alloy at high temperatures; (ii) a low coefficients of thermal expansion; (ii) high dimensional precision; (iii) limited voids; (iv) high resistance to creep; (v) high crushability; (vi) high porosity; (vii) reduced shrinkable; (viii) uniform shrinkage or (ix) few cracks or defects. Where properties are stated relatively (.e., low, high), they are with respect to a ceramic core made by conventional methods.

In a particular embodiment, the method disclosed herein provides a ceramic core with an fired flexural strength ranging from 100 psi to 5000 psi, more specifically from 100 psi to 1000 psi and more specifically 100 psi to 500 psi.

In a particular embodiment, the method disclosed herein provides a ceramic core with an internal porosity that affords pre-fired air permeability ranging from 1.0×10-4 cm2/(sec-atm) to 9.0×10-1 cm2/(sec-atm), more specifically from 1.0×10-3 cm2/(sec-atm) to 7.0×10-1 cm2/(sec-atm) and more specifically from 1.0×10-2 cm2/(sec-atm) to 5.0×10-1 cm2/(sec-atm).

In a particular embodiment, the method disclosed herein provides a ceramic core with an open porosity of less than about 50%, less than about 40%, less than about 35%, less than about 30% less than about 25% or less than about 20%.

In a further particular embodiment, the method disclosed herein provides a ceramic core with uniform shrinking or reduced shrinkage. In one embodiment, the method disclosed herein provides a ceramic core with fired linear shrinkage ranging from 0.1% to 10%, more specifically from 1% to 5% and more specifically from 1.5% to 3.75%.

In one embodiment, the method disclosed herein is repeated multiple times. In a particular embodiment, the method when repeated multiple times produces ceramic cores with reproducible shrinkage. In a particular embodiment, the yield of the repeated method is greater than about 70%, greater than about 75%, greater than about 80%, greater than about 85% or greater than about 90%.

In one embodiment, the ceramic core is part of a ceramic system or mold, further comprising a shell. In a particular embodiment, a method is disclosed for forming the shell may be formed by applying the ceramic slurry composition or another material to the ceramic core, for example, when the ceramic core is sacrificial material such as wax. The shell is then dried and hardened, while the sacrificial material is removed. The physical properties of the shell, according to this embodiment, must be sufficient to withstand further processing.

In a particular embodiment, a ceramic slurry comprising solid particulate components and carrier phase components are injected into the injection molding assemblies disclosed herein to form intermediate articles of manufacture. Optionally a pore former or other additives may be additionally added to ceramic slurry composition. In one embodiment, a ceramic slurry composition disclosed herein is utilized.

For example, a carrier blend comprising polyethylene glycol, which is soluble in water, and poly(vinyl butyral), which is generally insoluble in water, can be prepared using mass ratios of about 0.1:1, about 0.33:0.67, about 1:1:, about 0.75:about 0.25 or 1:0.1. After injection, the post injection green state intermediate article of manufacture may be immersed in water for times ranging from about 1 h to about 72 hours to remove polyethylene glycol phases and leaving behind a semi-porous green state intermediate article of manufacture comprising silica, alumina or zirconium silicate solids and poly(vinyl butyral) binder. Upon firing, the poly(vinyl butyral) binder decomposes and escapes from the open passages within the intermediate article of manufacture.

In a particular embodiment, pore formers may be added to carrier and solid components of ceramic slurry to increase internal porosity, pore size distribution, internal access to firing furnace atmosphere and also modulate mechanical strength of final fired cores. Pore formers suitable for use in the ceramic slurries disclosed herein include organic solids with melting points ranging from about −50 to about 200 C, more specifically from about −20 to about 150 C, more specifically from about −10 to about 120 C and boiling points ranging from about 70 to about 450 C, more specifically from about 100 to about 400 C, more specifically from about 120 to about 375 C, more specifically about 200 to about 375 C and more specifically about 250 to about 375 C. Furthermore, it is preferable that pore formers gradually volatilize or burn out as temperature is ramped during core firing processes, and multiple pore formers may be added to ceramic slurry compositions such that mass decrease of ceramic core content with respect to temperature increase can be tuned to approach linearity by

In certain embodiments, the methods disclosed herein eliminate the need for metal tooling in the production of intermediate articles of manufacture such as ceramic cores, which tooling may take days to weeks to months to multiple months to years to produce using existing methods, is one broader advantage of the methods disclosed herein, which enable reduced numbers of manufacturing steps to be employed in existing or future enabled investment casting processes, reduced manufacturing costs, and reduced lead times for new designs.

These ceramic cores can be used alone or as part of casting assemblies to provide cast metal parts (e.g., turbine blades) having desired geometries. The ceramic cores may be removed from the full casting assembly by physical or chemical processes.

In one embodiment, the method further comprising dissolving away one or more of the outer casting shell, the intermediate layer and/or the inner mold.

### IV. Intermediate Articles of Manufacture

Disclosed herein are articles of manufacture (e.g., ceramic cores) and in particular, intermediate articles of manufacture (e.g., ceramic cores) formed using the injection molding methods, molds and/or injection molding assemblies disclosed herein and suitable for use in forming a final article of manufacture.

In a particular embodiment, the article of manufacture or the intermediate article of manufacture is formed using an mold disclosed herein and more particularly, a mold having one or more of the following characteristics: (i) dissolvable; (ii) additively manufactured and (iii) monolithic.

In a particular embodiment, the article of manufacture or the intermediate article of manufacture are formed using an injection molding assembly disclosed herein, and more particularly, an injection molding assembly comprising (i) an inner mold having one or more of the following characteristics: dissolvable, additively manufactured or monolithic; (ii) optionally, an intermediate layer encasing the inner mold; and (iii) optionally, an outer shell surrounding the intermediate layer. Optionally, the intermediate layer, the outer shell or both have one or more of the following characteristics: dissolvable or additively manufactured.

In a particular embodiment, the intermediate article (e.g., ceramic core) disclosed herein is suitable for use in forming components for use in turbomachinery applications including but not limited to rocket engine components, jet engine components (e.g., turbine blades or vanes) and industrial gas turbine components.

In one embodiment, the intermediate article (e.g., ceramic core) disclosed herein is suitable for use in the manufacture of metal components for use in turbomachinery applications by casting, i.e., cast metal components. The metal may be any suitable metal including an alloy or super alloy. In one embodiment, the ceramic core is suitable for use in investment casting of single crystal nickel-based superalloy, directionally solidified superalloy and equiaxed superalloy components.

In a particular embodiment, the article or intermediate article is a ceramic core for use in preparing an airfoil component of a turbine blade.

In a particular embodiment, the article or intermediate article is a two or three-dimensional ceramic core or a single or multi-walled ceramic core.

In a preferred embodiment, the article or intermediate article is a ceramic core is characterized by improved geometric resolution and complexity compared to a ceramic core made by conventional means, e.g., injection molding utilizing a inner mold comprising two or more parts. In certain embodiment, the ceramic cores permit improvements in air cooling of final articles of manufacture (e.g., turbine blades).

In certain embodiments, a ceramic core is disclosed characterized by one or more desirable properties including but not limited to (i) suitable green strength to withstand the casting of a molten alloy; (ii) a low coefficients of thermal expansion; (ii) high dimensional precision; (iii) limited voids; (iv) high resistance to creep; (v) high crushability; (vi) high porosity; (vii) reduced shrinkability; (viii) uniform shrinkage or (ix) few cracks or defects. Where properties are stated relatively (.e., low, high), they are with respect to a ceramic core made by conventional methods.

In a particular embodiment, the ceramic core disclosed herein is characterized by a fired flexural strength ranging from 100 psi to 5000 psi, more specifically from 100 psi to 1000 psi and more specifically 100 psi to 500 psi.

In another particular embodiment, the ceramic core disclosed herein is characterized by a porosity that affords pre-fired air permeability ranging from 1.0×10-4 cm2/(sec-atm) to 9.0×10-1 cm2/(sec-atm), more specifically from 1.0×10-3 cm2/(sec-atm) to 7.0×10-1 cm2/(sec-atm) and more specifically from 1.0×10-2 cm2/(sec-atm) to 5.0×10-1 cm2/(sec-atm).

In another particular embodiment, the ceramic core disclosed herein is characterized by an open porosity of less than about 50%, less than about 40%, less than about 35%, less than about 30% less than about 25% or less than about 20%.

In a further particular embodiment, the ceramic core disclosed herein is characterized by reduced shrinkage compared to existing ceramic cores. In one embodiment, ceramic core is characterized by fired linear shrinkage ranging from about 0.1% to about 10%, more specifically from about 1% to about 5% and more specifically from about 1.5% to about 3.75%.

Optionally, the intermediate article (e.g., ceramic core) is contained within a mold, such as the dissolvable mold described herein. In other embodiments, the intermediate article is isolated from the polymer mold, e.g., by dissolving the dissolvable mold.

The composition of the intermediate article (e.g., ceramic core) may vary. In a particular embodiment, the intermediate article is a ceramic core is formed from a ceramic slurry composition comprising a combination of one or more of the following categories of constituents: carrier constituents, ceramic particles, pore formers and additives.

In one embodiment, the ceramic slurry composition comprising at least one carrier. The composition of the carrier may vary.

In one embodiment, carriers suitable for use in ceramic slurries disclosed herein include thermoplastic polymers or linear oligomers, including paraffin waxes, polyethylene, hydrocarbon waxes, coal-derived waxes, natural waxes like beeswax, carbowax, linear polyethylene glycol, branched polyethylene glycol, linear polypropylene glycol, branched polypropylene glycol, short chain oligomeric poly-alfa olefins, polyisobutylene, linear thermoplastic organics, polystyrene, polystyrene/xylene blends, polyolefins formed by radical polymerization, alpha-methyl styrene, poly(methyl acrylate), poly(butyl methacrylate), poly(vinyl butyral) linear and branched (meth)acrylic polymers, thermoplastic aliphatic polyurethanes and amorphous or semi-crystalline aliphatic polyesters such as polycaprolactone.

In one embodiment, carriers comprising linear, thermoplastic or branched polymers suitable for use in ceramic slurries disclosed herein may have molecular weights between about 100 and about 1,000,000 g/mol, more specifically between about 300 and about 100,000 g/mol, more specifically between about 1000 and about 10,000 g/mol. Glass transitions of linear, thermoplastic or branched polymers suitable for use in ceramic slurries disclosed herein may range between about −110 and about 500 C, more specifically between about −110 and about 200 C, more specifically between about −110 and about 130 C. Crystalline melt transitions of linear, thermoplastic or branched polymers suitable for use in ceramic slurries disclosed herein may range between about −80 and about 500 C, more specifically between about −50 and about 220 C, more specifically between about 0 and about 150 C, and more specifically between about 20 and about 130 C.

In one embodiment, carriers comprising paraffin waxes include saturated and unsaturated hydrocarbons with 8 to 500 carbons, more specifically 12 to 100 carbons, more specifically 15 to 60 carbons, more specifically 18 to 40 carbons. Melting temperatures of paraffin waxes suitable for use may range between about −50 and about 150 C, more specifically between about 0 and about 140 C, and more specifically between about 20 and about 130 C.

In one embodiment, curable or thermosetting carriers comprise monomeric, oligomeric or polymeric constituents with pendant reactive functional groups that have molecular weights that range from about 100 g/mol to about 1,000,000 g/mol, more specifically about 100 g/mol to about 100,000 g/mol, more specifically from about 130 g/mol to about 10,000 g/mol.

Carriers may be blended in formulations that, when heated during firing, decompose in a gradual manner with increasing temperature such that the first derivative of thermogravimetric analysis experiments plotting % mass loss versus temperature approaches a constant value.

In one embodiment, the carrier may be a thermoplastic polymer or wax that may be blended in formulations that form homogeneous or soluble blends at elevated temperature and that are immiscible at reduced temperature. In one embodiment, upon cooling after injection of ceramic slurries disclosed herein, post-injection green state intermediate articles of manufacture are immersed in liquid baths that include water or organic solvents, such that selective dissolution of one or more inhomogeneous phases removes a soluble carrier phase from a green state intermediate article of manufacture while leaving behind an insoluble polymer. The selective removal of soluble carrier phases is suitable for creating porosity and open internal channels within post-injection green state articles of manufacture to allow for escape of volatile decomposition products during firing processes.

For example, a carrier blend comprising polyethylene glycol, which is soluble in water, and poly(vinyl butyral), which is generally insoluble in water, can be prepared using mass ratios of about 0.1:1, about 0.33:0.67, about 1:1:, about 0.750.25 or about 1:0.1. After injection, the post injection green state intermediate article of manufacture may be immersed in water for times ranging from 1 h to 72 h to remove polyethylene glycol phases and leaving behind a semi-porous green state intermediate article of manufacture comprising silica, alumina or zirconium silicate solids and poly(vinyl butyral) binder. Upon firing, the poly(vinyl butyral) binder decomposes and escapes from the open passages within the intermediate article of manufacture.

In one embodiment, thermosetting carriers suitable for use include monomeric and/or oligomeric precursors. The monomeric and/or oligomeric precursors contain one or more reactive functional groups, where the one or more reactive functional groups can vary from n=1 to n=50, or greater, depending on the monomeric and/or oligomeric precursors. The curable formulations formed from monomeric and/or oligomeric precursors can be tuned, for example, by varying the degree of functionalization with one or more reactive functional groups used to prepare the precursors and formulations thereof.

In one embodiment, the thermomechanical and physical properties of thermosetting carriers suitable for use can be tuned via the inclusion of one or more moieties, such as cyclic aliphatic linkages/linker groups for toughness, rigidity, UV resistance and thermal resistance; sterically hindered moieties and/or substituents, which can inhibit/control macromolecular alignment to afford amorphous materials, composites, and other compositions thereof upon polymerization and which can afford high optical clarity.

In one embodiment, thermosetting carriers suitable for use include moieties and/or substituents that can form or contain linkages, such as urethane, amide, thiourethane and dithiourethane groups which allow for inter-chain hydrogen bonding and can be used to impart increased toughness and rigidity. In yet other embodiments, the selective incorporation of ester, beta-aminoester, carbonate, silyl ether linkages, or linker groups in the precursors can be used to control environmental degradation time and solvent uptake, which can also be tuned by incorporating pendant hydrophilic or hydrophobic groups into material compositions.

In one embodiment, thermosetting carriers suitable for use can be prepared, for example, from mercapto, alkene, (meth)acrylate, alkyne, amine and epoxy functionalized monomeric and oligomeric constituents, or combinations thereof. The stoichiometric molar ratios of monomeric and/or oligomeric precursors present in the curable formulations can range from about 1.00:4.00, about 1.00:3.00, about 1.00:2.20, about 1.00:2.00, about 1.00:1.00, about 1.00:0.97, about 1.00:0.95, about 1.00:0.90, about 1.00:0.50, about 1.00:0.33, about 1.00:0.25, and about 1.00:0.20.

In one embodiment, thermosetting carriers formed of monomeric and/or oligomeric precursors can be cured by applying ultraviolent (UV) light, heat, acid or base catalyzed curing processes, or combinations thereof. The cured formulations are then subjected to performance characterization analysis and can be utilized, for example, in known additive manufacturing processes, such as stereolithography additive applications, and for coatings applications.

In one embodiment, thermosetting carriers can be prepared using varying quantities of initiators or catalysts added to the thermosetting carrier formulations to catalyze addition reactions, between the monomeric and/or oligomeric precursors, prior to or during the application of an optional thermal aging process. Exemplary addition reactions include, but are not limited to, free radical initiated thiol-ene, base catalyzed Michael Addition and base catalyzed thiol-epoxy addition reactions.

In one embodiment, for thermosetting carriers designed to be UV curable, a photoinitiator can also be added. For example, a free radical inhibitor can be added to acrylate containing formulations and select thiol-ene formulations. Exemplary photoinitiators include, but are not limited to, 2,2-dimethoxy-2-phenylacetophenone (DMPA) and diphenyl(2,4,6-trimethylbenzoyl)phosphine oxide (TPO). The amount of photoinitiator which can be added UV curable formulations can range from about 0.001 wt % to about 10 wt %. In some embodiments, the amount of photoinitiator added to the curable formulations can be about 0.10 wt %, about 0.20 wt %, about 0.30 wt %, about 0.40 wt %, about 0.50 wt %, about 1.00 wt %, about 1.50 wt %, about 2.00 wt %, about 2.50 wt %, about 3.00 wt %, about 3.50 wt %, about 4.00 wt %, about 4.50 wt %, and about 5.00 wt %. In some embodiments, free radical inhibitors (which include, but are not limited to 4-methoxyphenol and 1,4-hydroquinone) can be added to the curable formulations to a concentration in a range from about 0.01 to about 2000 ppm. In some embodiments, the concentration of free radical inhibitors added can be about 500 ppm, about 1000 ppm, about 1500 ppm.

In one embodiment, for thermosetting carriers designed to be thermally curable, such as compositions curable by thermally initiated radical chain polymerization processes or base catalyzed processes that include thiol-epoxy, amine-epoxy or alcohol-epoxy based formulations, thermal free-radical initiators or tertiary amine catalysts can be added to catalyze curing. Exemplary thermal free-radical initiators include, but are not limited to, benzoyl peroxide (BPO) and azobisisobutyronitrile (AIBN). Thermal free radical initiators catalyze radical initiated addition reactions, such as during a thermal aging process, and the amounts added to the curable formulations can range from about 0.001 wt % to about 10 wt %. In some embodiments, the amount of thermal free radical initiator added to the curable formulations can be about 0.10 wt %, about 0.20 wt %, about 0.30 wt %, about 0.40 wt %, about 0.50 wt %, about 1.00 wt %, about 1.50 wt %, about 2.00 wt %, about 2.50 wt %, about 3.00 wt %, about 3.50 wt %, about 4.00 wt %, about 4.50 wt %, or about 5.00 wt %. Tertiary amine base catalysts can be used catalyze, for example, Michael Addition and/or thiol-epoxy reactions or related reactions, during thermal aging.

The amounts of tertiary amine base catalyst(s) which can added to the curable formulations can range from about 0.01 wt % to about 10 wt %. In some embodiments, the amount of tertiary amine base catalyst(s) which can be added to the curable formulations can be about 0.10 wt %, about 0.20 wt %, about 0.30 wt %, about 0.40 wt %, about 0.50 wt %, about 1.00 wt %, about 1.50 wt %, about 2.00 wt %, about 2.50 wt %, about 3.00 wt %, about 3.50 wt %, about 4.00 wt %, about 4.50 wt %, or about 5.00 wt %.

In one embodiment, thermosetting carriers suitable for use are cured via polymerization reactions that fully cure or a substantially cure the formulations, wherein substantially refers to a percentage of crosslinking of at least about 80%, about 85%, about 90%, about 91%, about 92%, about 93%, about 94%, about 95%, about 96%, about 97%, about 98%, about or 99%.

In one embodiment, thermosetting carriers suitable for use are designed to be chemically curable wherein one or more chemical catalysts, such as acid or base catalysts act to cure the curable formulation over a period of time. The one or more chemical catalysts can be added at concentrations of about 0.10 wt %, about 0.20 wt %, about 0.30 wt %, about 0.40 wt %, about 0.50 wt %, about 1.00 wt %, about 1.50 wt %, about 2.00 wt %, about 2.50 wt %, about 3.00 wt %, about 3.50 wt %, about 4.00 wt %, about 4.50 wt %, or about 5.00 wt %. The time needed to achieve full curing will be dependent on the concentration of catalyst added and the nature of the crosslinking reaction chemistries occurring in the formulation on standing. In certain instances, such processes can be driven by applying heat to the formulation.

In certain embodiments, the thermosetting carriers suitable for use, once cured, can have unreacted, partially reacted, or fully reacted functional groups/substituents present therein. Exemplary functional groups include, but are not limited to, thiol, alkene, alkyne, hydroxyl, carboxylic acid, acrylate, isocyanate, isothiocyanate, amine, epoxy, diene/dienophile, alkyl halide, carboxylic acid anhydride, aldehyde and phenol groups.

In one embodiment, thermosetting carriers suitable for use in include thermosetting polymeric resins including platinum catalyzed silicones formed by hydrosilation or moisture cure silicones, polydimethylsiloxane, cyanate esters, thermosetting polyurethanes, thermosetting polyurethane-ureas, thermosetting polyureas, aliphatic epoxy resins derived from epoxide/amine, epoxide/hydroxyl or epoxy/thiol constituents, acrylic network polymers, or oxime-derived thermosetting resins.

In one embodiment, thermosetting carriers suitable for use include silicon-containing molecules or macromolecules comprising vinylsilane groups and optionally heterofunctional groups including (meth)acrylic, epoxy, allyl, tetrahydrofurfuryl and ionic salt constituents. Exemplary silicon-containing thermosetting carriers include methacryloxypropyl terminated polydimethylsiloxane, methacryloxypropyldimethylmethoxysilane, methacryloxypropyl tris(vinyl dimethylsiloxy)silane 4-(phenoxypheyl) phenyldimethoxysilane, allytripheylsilane tetrakis(epoxycyclohexyl) ethyl] tetramethyl cyclo tetrasiloxane, (3-glycidoxypropyl)heptamethyl cyclotetrasiloxane, mono vinyl functional polydimethylsiloxane, tetrahydrofurfuryloxypropyl terminated.

In one embodiment, thermosetting carriers suitable for use include ionic salt containing molecules or macromolecules containing (meth)acrylic, epoxy, allyl, tetrahydrofurfuryl linkages, including zirconium (IV) (meth)acrylate, nickel (II) (methacrylate), aluminum (III) (meth)acrylate.

In one embodiment, thermosetting carriers suitable for use comprise silicon-containing molecules or macromolecules comprising vinylsilane (i.e., Si—C═C) groups, including diphenylmethylsilane, vinyldiphenylethoxysilane, (5-bicyclo[2.2.1]hept-2-enyl) dimethylethoxysilane, heptamethylcyclotetransiloxane, 1,2-bis(trimethylsiloxy)cyclo butene, (bicycloheptenyl)ethyl terminated polydimethylsiloxane, monovinyl-monophenyl-monohydride terminated polydimethylsiloxane, poly(pheylsilsequioxane), 100% phenyl, trimethylsiloxane terminated, vinyl terminated polydimethylsiloxane, 1,3,5,7-tetravinyl-1,3,5-7-tetramethylcyclote transiloxane, 1,3,t-trivinyl-1,3,5-trimethylcyclotrisiloxane, tetravinylsilane.

In one embodiment, thermosetting carriers suitable for use comprise silicon-containing molecules or macromolecules comprising silane (i.e., Silicon Hydride) groups, including polymethylhydrosiloxane, 1,3,5,7-tetramethyl-cyclotetrahydrosiloxane, 7-9% (methylhydrosiloxane)-dimethylsiloxane copolymer, hydride terminated polydimethylsiloxane, (45-50% methylhydrosiloxane), phenylmethylsiloxane copolymer, hydride terminated, diphenylsilane, hexaphenyldisilane, 1,1,2,2-tetraphenyldisilane, (methacryloxymethyl) phenyldimethyl silane, p-phenylene(dimethylsilane), 4,4′-bis(dimehtylsilyl)biphenyl, 1, 3, 5-trisilacyclohexane. [000149] In one embodiment, thermosetting carriers suitable for use in the include catalysts and catalyst blends that catalyze hydrosilation and moisturecure reactions, including platinum-cyclovinylmethyl-siloxane complex, 0.1-5% in cyclomethyl vinylsiloxanes.

In one embodiment, thermosetting carriers suitable for use include saturated siloxane compounds suitable for modifying viscosity and blending homogeneity/mixture stability of carrier phase blends with other ceramic slurry constituents. Saturated siloxane compounds may undergo chemical reactions during firing processes but may not participate in carrier phase curing reactions. Exemplary saturated siloxane compounds including permethyl and perphenyl siloxanes, octaphenylcyclotetrasiloxane, octamethylcyclotetrasiloxane, hexamethylcyclotrisiloxane, hexaphenylcyclotrisiloxane, diphenylsiloxane dimethyl siloxane copolymer.

In one embodiment, thermosetting carriers suitable for use include silazane analogs to silicon-containing constituents, which undergo chemical reactions during firing processes to form silicon nitride and analogous ceramics and may also participate in carrier phase m curing reactions.

In one embodiment, oligomeric or polymeric precursor constituents present in carrier phases have molecular weights may range from 100 g/mol to 1,000,000 g/mol, more specifically 100 g/mol to 100,000 g/mol, more specifically from 130 g/mol to 10,000 g/mol.

In other embodiments described herein, the thermosetting carriers can include one or more polythiol constituents obtained from mercaptan-containing terpenes (such as D-Limonene and/or L-Limonene, and/or derivatives or analogs thereof) and/or terpenoids. Exemplary polythiols derived from terpenes or terpenoids include, but are not limited to dipentene dimercaptan, isoprene dimercaptan, farnesene dimercaptan, farnesene trimercaptan, farnesene tetramercaptan, myrcene dimercaptan, myrcene trimercaptan, bisabolene dimercaptan, bisabolene trimercaptan, linalool dimercaptan, terpinolene dimercaptan, terpinene dimercaptan, geraniol dimercapan, citral dimercaptan, retinol dimercaptan, retinol trimercaptan, retinol tetramercaptan, beta-carotene polymercaptans, or combinations thereof. In some embodiments, the polythiols are derived from trimethylolpropane trithiol, pentaerithritiol trithiol, pentaerithritol tetrathiol, inositol di-, tri-, tetra-, penta- and hexathiols.

In yet other embodiments described herein, the thermosetting carriers can include one or more include polythiol constituents obtained from mercaptan-containing cyclic, polycyclic, or linear aliphatic polyalkenes or alkynes. Exemplary polythiols derived from these groups include, but are not limited to, trivinylcyclohexene dimercaptan, trivinylcyclohexene trimercaptan, dicyclopentadiene dimercaptan, vinylcyclohexene dimercaptan, triallylisocyanurate dimercaptan, triallyl isocyanurate trimercaptan, phenylhepta-1,3,5-triyne polmercaptans, 2-butyne-1,4-diol dimercaptan, propargyl alcohol dimercaptan, dipropargyl sulfide polymercaptans, dipropargyl ether polymercaptans, propargylamine dimercaptan, dipropargylamine polymercaptans, tripropargylamine polymercaptans, tripropargyl isocyanurate polymercaptans, tripropargyl cyanurate polymercaptans.

In other embodiments described herein, the thermosetting carriers can include one or more polythiol constituents obtained from mercaptan-containing, unsaturated fatty acids or unsaturated fatty esters. Exemplary polythiols derived from these groups include, but are not limited to, arachidonic acid dimercaptan, arachidonic acid trimercaptan, arachidonic acid tetramercaptan, eleostearic acid dimercaptan, eleostearic acid trimercaptan, linoleic acid dimercaptan, linolenic acid dimercaptan, linolenic acid trimercaptan, mercaptanized linseed oil, mercaptanized tung oil, mercaptanized soybean oil, mercaptanized peanut oil, mercaptanized walnut oil, mercaptanized avocado oil, mercaptanized sunflower oil, mercaptanized corn oil, mercaptanized cottonseed oil.

In the embodiments described herein, the thermosetting carriers include one or more alkene constituents including, but not limited to, terpenes, terpenoids, dimerized terpenes or terpenoids, trimerized terpenes or terpenoids, oligomeric terpenes or terpenoids, polymerized terpenes or terpenoids, limonene, D-limonene, L-limonene, poly(limonene) having “n” repeat units wherein “n” is greater than n=2 and less than 500,000, farnesene, myrcene, bisabolene, linalool, terpinolene, terpinene, geraniol, citral, retinol, beta-carotene, triallyl isocyanurate, 1,2,4-trivinyl cyclohexane, norbornene functionalized poly(terpene) oligomers, norbornene-functionalized polydimethylsiloxane, norbornene-functionalized poly(butadiene), norbornene-functionalized polyisoprene oligomers, poly(isoprene) with having “n” repeat units wherein “n” is 2 or more and less than 500,000, poly(butadiene) having “n” repeat units wherein “n” is 2 or more and less than 500,000, divinyl ether, triallylamine, diallylamine, diallyl bisphenol A, cyclohexanedimethanol diallyl ether, pentaerithritol tetraallyl ether, trimethylolpropane triallyl ether, 2,4,6-Triallyloxy-1,3,5-triazine, inositol diallyl ether, inositol triallyl ether, inositol tetraallyl ether, inositol pentaallyl ether, inositol hexaallyl ether, inositol divinyl ether, inositol trivinyl ether, inositol tetravinyl ether, inositol pentavinyl ether, inositol hexavinyl ether, triallyl citrate, trivinyl citrate, 1,5-cyclooctadiene, 1,3-cyclooxtadiene, 1,4-cyclooctadiene, 1,3-6 cyclooctatriene, cyclohexane diallyl ether, cyclohexane triallyl ether, cyclohexane tetraallyl ether, cyclohexane pentaallyl ether, cyclohexane hexaallyl ether, cyclohexane divinyl ether, cyclohexane trivinyl ether, cyclohexane tetravinyl ether, cyclohexane pentavinyl ether, cyclohexane hexavinyl ether, diclyclopentadiene, tricyclodecane dimethanol divinyl ether, tricyclodecane dimethanol diallyl ether, tricyclodecane dimethanol, norbornene capped, bicyclo[2.2.1]hepta-2,5-diene, norbornene-functionalized polyamide oligomers having “n” repeat units wherein “n” is 2 or more polyamide repeat units and less than 100,000 repeat units, allyl ether-functionalized polyamide oligomers having “n” repeat units wherein “n” is 2 or more polyamide repeat units and less than 100,000 repeat units, vinyl ether-functionalized polyamide oligomers having “n” repeat units wherein “n” is 2 or more polyamide repeat units and less than 100,000 repeat units, norbornene-functionalized polydimethylsiloxane having “n” repeat units wherein “n” is 2 or repeat units and less than 100,000 repeat units, allyl ether-functionlized polydimethylsiloxane having “n” repeat units wherein “n” is 2 or repeat units and less than 100,000 repeat units, vinyl ether-functionlized polydimethylsiloxane having “n” repeat units wherein “n” is 2 or repeat units and less than 100,000 repeat units, resorcinol diallyl ether, resorcinol divinyl et her, diallylamine, triallylamine, or allylamine.

In the embodiments described herein, the thermosetting carriers can also include one or more acrylate or methacrylate-based constituents including, but not limited to, neopentyl glycol diacrylate, glycerol diacrylate, glycerol triacrylate, ethylene glycol diacrylate, tetraethylene glycol diacrylate, trimethylolpropane triacrylate, tris[2-(acryloyloxy)ethyl] isocyanurate, pentaerithritol tetraacrylate, pentaerithritol triacrylate, ethoxylated trimethylolpropane triacrylate, ethyoxylated pentaerithritol triacrylate, ethoxylated pentaerithritol tetraacrylate, poly(dimethylsiloxane) diacrylate having “n” repeat units wherein “n” is 2 or more repeat units and less than 500,000 repeat units, poly(isoprene) diacrylate having “n” repeat units wherein “n” is 2 or more repeat units and less than 500,000 repeat units, poly(butadiene-co-nitrile) diacrylate having “n” repeat units wherein “n” is 2 or more butadiene repeat units and 2 or more nitrile repeat units and less than 500,000 butadiene repeat units and less than 500,000 nitrile repeat units, polyethyleneglycol diacrylate having “n” repeat units wherein “n” is greater than 2 repeat units and less than 500,000 repeat units, tricyclodecantedimethanol diacrylate, bisphenol A diacrylate, ethoxylated bisphenol A diacrylate having “n” repeat units wherein “n” is greater than 2 repeat units and less than 500,000 repeat units, and methacrylated equivalents thereof of the above listed constituents.

In the embodiments described herein, the thermosetting carriers can also include one or more epoxy-based constituents including, but not limited to, epoxidized terpenes or terpenoids, epoxidized dimerized terpenes or terpenoids, epoxidized trimerized terpenes or terpenoids, epoxidized oligomeric terpenes or terpenoids or polymerized terpenes or terpenoids, limonene oxide, limonene dioxide, poly(limonene oxide) having “n” repeat units wherein “n” is 2 or more repeat units and less than 500,000 repeat units, poly(isoprene oxide)-co-polyisoprene copolymers having “n” repeat units wherein “n” is 2 or more repeat units and less than 500,000 repeat units, poly(butadiene oxide)-co-polybutadiene copolymers having “n” repeat units wherein “n” is 2 or more repeat units and less than 500,000 repeat units, epoxidized farnesene, epoxidized farnesene, epoxidized myrcene, epoxidized bisabolene, epoxidized linalool, epoxidized terpinolene, epoxidized terpinene, epoxidized geraniol, epoxidized citral, poxidized retinol, epoxidized beta-carotene, epoxidized arachidonic acid, epoxidized eleostearic acid epoxidized linoleic acid, epoxidized linolenic acid, epoxidized linseed oil, epoxidized tung oil, epoxidized soybean oil, epozidized peanut oil, epozidized walnut oil, epoxidized avocado oil, epoxidized sunflower oil, epoxidized corn oil, epoxidized cottonseed oil, epoxidized palm oil, epoxidized glycerol, including glycerol diglycidyl ether and glycerol triglycidyl ether, epoxidized sorbitol, including sorbitol diglycidyl ether, sorbitol triglycidyl ether, sorbitol tetraglycidyl ether, sorbitol pentaglycidyl ether and sorbitol hexaglycidyl ether, cyclohexanedimethanol diglycidyl ether, resorcinol diglycidyl ether, bisphenol A diglycidyl ether, hydrogenated bisphenol A diglycidyl ether, neopentyl glycol diglycidyl ether, ethylene glycol diglycidyl ether, 1,4-butanediol diglycidyl ether, tetraethylene glycol diglycidyl ether, polydimethylsiloxane diglycidyl ether, epoxidized butadiene oligomers, epoxidized butadiene-co-polynitrile oligomers, epoxidized grapefruit mercaptan, ethoxylated bisphenol A diglycidyl ether having “n” repeat units wherein “n” is 2 or more repeat units and less than 500,000 repeat units, ethoxylated hydrogenated bisphenol A diglycidyl ether having “n” repeat units wherein “n” is 2 or more repeat units and less than 500,000 repeat units, ethoxylated cyclohexanedimethanol diglycidyl ether having “n” repeat units wherein “n” is 2 or more repeat units and less than 500,000 repeat units.

In certain embodiments described herein, the thermosetting carriers can also include one or more alkyne-based constituents including, but not limited to, acetylene, supercritical acetylene, propargyl alcohol, 2-butyne-1,4-diol, phenylhepta-1,3,5-triyne, dipropargyl sulfide, dipropargyl ether, propargylamine, dipropargylamine, tripropargylamine, tripropargyl isocyanurate, tripropargyl cyanurate, propargyl inositol, dipropargyl inositol, tripropargyl inositol, tetrapropargyl inositol, pentapropargyl inositol, hexapropargyl inositol, dipropargylpiperazine, dipropargyl citrate, tripropargyl citrate, cyclohexanedimethanol propargyl ether, cyclohexanedimethanol dipropargyl ether, quinic acid lactone propargyl ether, quinic acid lactone dipropargyl ether, quinic acid lactone tripropargyl ether, tricyclodecanedimethanol propargyl ether, tricyclodecanedimethanol dipropargyl ether, bisphenol A bis(propargyl ether), hydrogenated bisphenol A bis(propargyl ether), cyclohexane dipropargyl ether, cyclohexane tripropargyl ether, cyclohexane tetrapropargyl ether, cyclohexane pentapropargyl ether, cyclohexane hexapropargyl ether, propargyl resorcinol, dipropargyl resorcinol.

In one embodiment, the thermosetting carriers can also include one or more constituents selected from the group consisting of alcohol constituents, anhydride constituents, amine constituents or other chemical constituents.

In one embodiment, thermosetting carries can also include polyisocyanate and polyol or polyamine precursors. Polyisocyanate precursors include hexamethylene diisocyanate, trimethylhexamethlene diisocyanate, dicylohexylmethane diisocyanate, n,n-methylenebis(isocyanate), phenylene diisocyanate, diisocyanate monomers with melting points above 50 C, liquid diisocyanate monomers with melting points below 50 C. Polyol and polyamine precursors include those mentioned in the present invention and include 1,4-butanediol, 1,3-butanediol, 1,6-hexanediol, 1,6-cyclohexanedimethanol, glycerol, pentaeerithritol, and triethanolamine. Thermosetting polyisocyanate, polyol and polyamine precurors may also include urethane or urea catalysts, including zirconium(IV) acetylacetonate, stannous octoate, various amine catalysts, including triethylene diamine.

The amount of the carrier constituents in the ceramic slurry composition may vary. In one embodiment, the carrier constituents are present in an amount from 0 to about 80 volume %, more preferably about 8 to about 65 vol %, more specifically, about 10 to about 55 vol %, more preferably about 12 to about 30 vol %.

In one embodiment, the ceramic slurry composition comprising at least one solid particulate constituent. The solid particulate constituent may vary.

In one embodiment, the ceramic slurry blends comprises solid particulate constituents with varying particle size distribution (PSD), including monomodal or multimodal (e.g., bimodal, trimodal, tetramodal, pentamodal and hexamodal) particle size distributions. The particle size distribution may be measured by any suitable technique, e.g., sedimentation, dynamic light scattering or laser diffraction.

In one embodiment, the ceramic slurry blend comprises solid particulate constituents ranging in size with diameters ranging from about 0.1 nm to about 10 mm, more specifically from about 1 nm to about 5 mm, more specifically from about 50 nm to about 2 mm, and more specifically from about 100 nm to about 1000 micrometers, more specifically from about 0.5 micrometers to about 100 micrometers. The average particle diameter may be measured by any suitable technique, e.g., with a transmission electron microscope.

In one embodiment, the solid particle size distribution width within the ceramic slurries used herein is controlled tightly and ranges from narrow to broad. Monodisperse particle blends may afford shear thickening during injection after blending with carrier phases and may suffer from a lack of processability. To address this lack of processability, multiple solid particulates with broad distributions may be blended to afford solid particulate blends in which interstitial sites are filled with appropriately sized smaller particles, in accordance with particle packing theory. For example, 5 micron alumina and 0.5 micron alumina particles may be blended such that alumina particles to afford 60% solids fraction for ceramic slurries disclosed herein, viscosity may reach a minimum at about 80% coarse, 20% fine, i.e., 4:1 ratio of coarse to fine for a 10:1 radius ratios and is expected to decrease by a factor of 2 to 5 or more when optimized bimodal particle distributions are employed.

In one embodiment, the ceramic slurry blends used herein comprise solid particulate constituents optimized to reduce viscosity during injection of ceramic slurry while also optimized to minimize creep during firing of intermediate articles of manufacture and/or casting process that utilize intermediate articles of manufacture to form final articles of manufacture. Optimized particulate constituents may include particles about 0.5 microns, about 1 micron, about 10 microns, about 20 microns, about 50 microns, or about 70 microns in size and may include particles with aspect ratios ranging from spherical to beam-like (1:1 to 100:1).

In one embodiment, the ceramic slurry blends suitable for use include solid particulate constituents selected from the group consisting of alumina, fumed silica, fused silica, zirconium silicate or combinations thereof.

In some embodiments, exemplary solid particulate constituents include alumina, fumed silica, fused silica, unfumed silica or zirconium silicate particles having an average particle size in the range of about 5 to about 500 m2/g. In some embodiments, the fumed silica additives have an average particle size of about 50 m2/g, about 75 m2/g, about 100 m2/g, about 120 m2/g, about 150 m2/g, about 200 m2/g, about 250 m2/g, about 300 m2/g, or about 350 m2/g.

In some embodiments, alumina, fumed silica, fused silica, unfumed silica or zirconium silicate particles may be surface functionalized and include commercial products such as Cabot CAB-O-SIL TS-720, TS-610, TS-622, TS-530, EVONIK AEROSIL R8200, R106, R812S, R202, R208, R972, R974, R812S. E.g. vinylsilanes, mercaptosilanes, aminosilanes, methacrylosilanes added in 0.01 to 15 mole % equivalents. Specific products suitable for use include Evonik Dynasylan MTMO, AMMO, VTMO and Evonik (meth)acrylated silanes.

In one embodiment, the ceramic slurry comprises solid particulate constituents in an amount from about 40 to about 90 volume %, more specifically from about 50 to about 80 volume %, and more specifically from about 51 to about 66 volume %.

In one embodiment, the ceramic slurry composition comprising one or more pore formers.

In a particular embodiment, pore formers may be added to the ceramic slurry to increase internal porosity of ceramic cores, modulate pore size distribution, facilitate internal access to firing furnace atmosphere of ceramic cores and also modulate mechanical strength of final fired cores. Pore formers suitable for use in the ceramic slurries include organic solids with melting points ranging from about 50 to about 200 C, more specifically from about −20 to about 150 C, more specifically from about −10 to about 120 C and boiling points ranging from about 70 to about 300 C, more specifically from about 100 to about 250 C and more specifically from about 120 to about 200 C. Pore formers suitable for use in the ceramic slurries include organic solids with melting points ranging from about −50 to about 200 C, more specifically from about −20 to about 150 C, more specifically from about −10 to about 120 C and boiling points ranging from about 70 to about 450 C, more specifically from about 100 to about 400 C, more specifically from about 120 to about 375 C, more specifically about 200 to about 375 C and more specifically about 250 to about 375 C. Furthermore, it is preferable that pore formers gradually volatilize or burn out as temperature is ramped during core firing processes, and multiple pore formers may be added to ceramic slurry compositions such that mass decrease of ceramic core content with respect to temperature increase can be tuned to approach linearity by controlling firing heating rates and cycling conditions.

In a particular embodiment, pore formers suitable for use in ceramic slurries of include, but are not limited to, cyclohexane, cycloheptane, cyclooctane, cyclononane, cyclodecane, cycloundecane, cyclododecane, octamethylcyclotetrasiloxane, hexamethylcyclotrisiloxane, decamethylcyclopentasiloxane, duodecamethylcyclohexasiloxane, hexamethyldiloxane, octamethyltrisiloxane, decamethyltetrasiloxane, dodecamethylpentasiloxane, tetradecamethylhexasiloxane, polydimethylsiloxane, n=2 to 20, 1,6-hexanediol, 1-hexanol, 2-hexanol, 3-hexanol, decane, undecane, dodecane, benzene, toluene, o-xylene, m-xylene, p-xylene, ethylbenzene, phenol, o-cresol, m-cresol, p-cresol, chlorobenzene, 1,2-dichlorobenzene, 1,3-dichlorobenzene, 1,4-dichlorobenzene, naphthalene, 1-naphthol, 2-naphthol, biphenyl and other organic compounds with molecular weights ranging from 70 g/mol to 700 g/mol.

In a particular embodiment, pore formers may be added to ceramic slurries in amounts ranging from about 1 to about 30 vol %, more specifically about 5 to about 25 vol % and more specifically about 10 to about 20 vol % and more specially about 12 to about 18 vol %.

In one embodiment, the ceramic slurry composition comprising one or more additives. The additive may be any suitable additive, including an organic additive or inorganic additive.

In one embodiment, the ceramic slurry blend comprises alkali and alkaline earth elements, magnesium oxide, calcium oxide, calcium stearate or magnesium stearate.

In one embodiment, the ceramic slurry blend includes ceramic slurry additives selected from the group consisting of alkali and alkaline earth elements, surfactants that encapsulate solid ceramic particles in slurry blends during mixing such as stearic acid, magnesium oxide, calcium oxide, calcium stearate or magnesium stearate ranging in overall slurry composition from about 10 to about 10,000 ppm, more specifically from about 50 to about 5000 ppm, more specifically from about 100 to about 1000 ppm, and more specifically from about 100 to about 500 ppm.

In a particular embodiment, the one or more ceramic slurry additives is present in an amount of about 100 ppm, about 150 ppm, about 200 ppm, about 250 ppm, about 300 ppm, about 350 pm, about 400 ppm, about 450 ppm or about 500 ppm. In another particular embodiment, the one or more ceramic slurry additives is present in an amount from about 150 to about 450 ppm, about 200 to about 400 ppm, or about 200 to about 300 ppm.

In certain embodiments, the ceramic slurry suitable for use exhibits unique process capabilities that that reduce number of manufacturing steps in investment casting processes through use in manufacturing processes that include the use of dissolvable molds or mold assemblies that afford superior injection process performance and unique disassembly capabilities, including anti-adhesion advancements for injection molding assemblies, therein enabling novel articles of manufacture to be produced using indirect and direct manufacturing processes.

The physical properties of the ceramic slurry may vary. In one embodiment, the ceramic slurry has a reduced viscosity relative to conventional slurries used to form ceramic cores, therein lowering pressure and temperature process conditions for forming ceramic cores and reducing energy costs for manufactures. The viscosity of the ceramic slurry composition may be measured by any suitable method, for example, by an immersion probe viscometer.

In certain embodiments, the ceramic slurries suitable for use are characterized by broadening composition ranges for ceramic slurry carrier phases in comparison with currently employed carrier compositions, therein offering environmental and cost benefits to manufacturers.

In other embodiments, the ceramic slurries suitable for use improving mechanical strength at ambient temperature for green state and fired ceramic cores used in the investment casting processes disclosed herein, therein offering process efficiency, reduced manufacturing steps and improved yield for manufacturers.

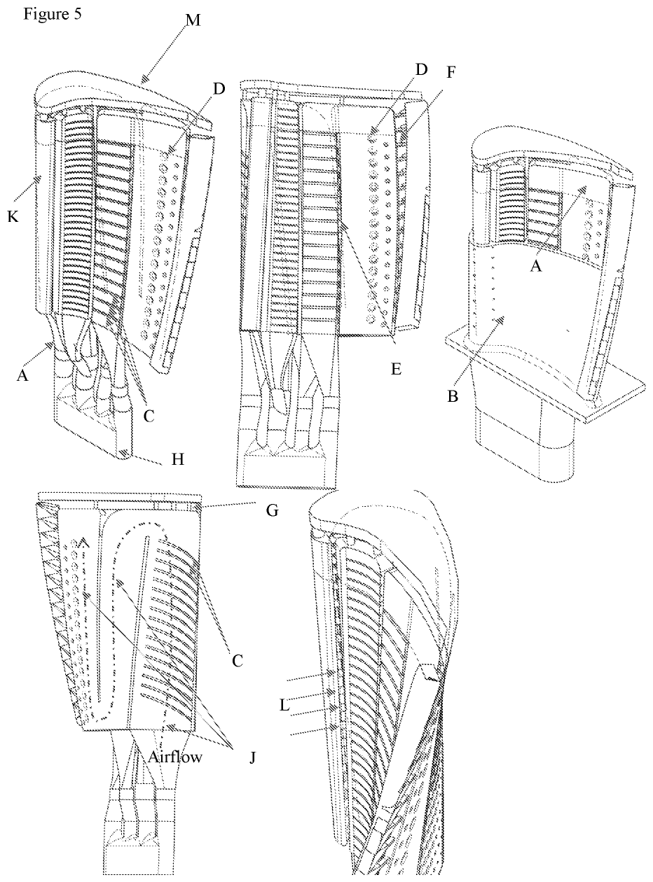

FIG. 5 depicts a one embodiment of the fired ceramic core disclosed herein, wherein the ceramic core comprises three dimensional features suitable for use in investment casting processes, where the ceramic core was formed by injection molding of a ceramic slurry into a mold assembly comprising an additively manufactured inner dissolvable mold and a machined outer shell.

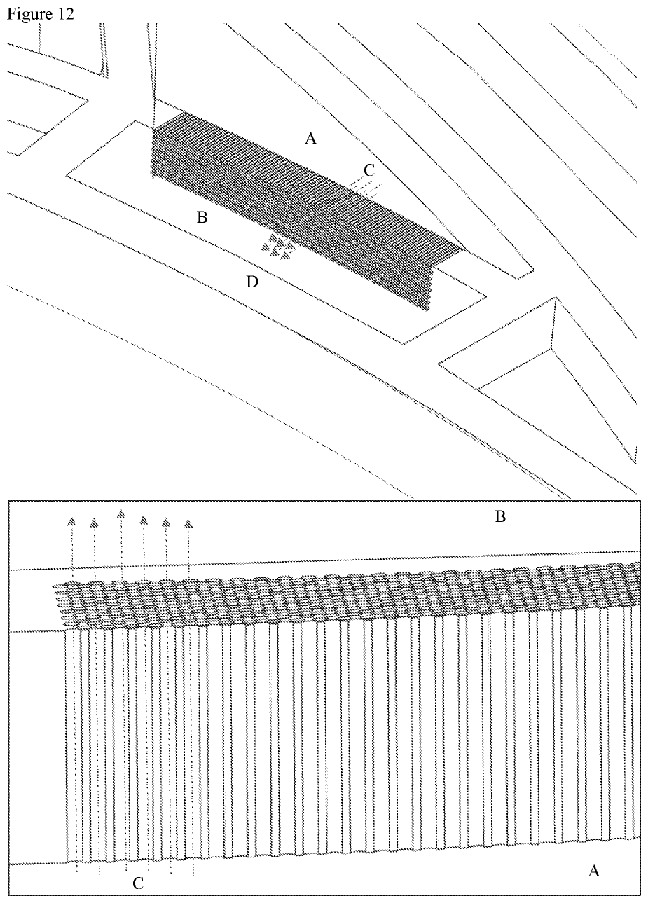

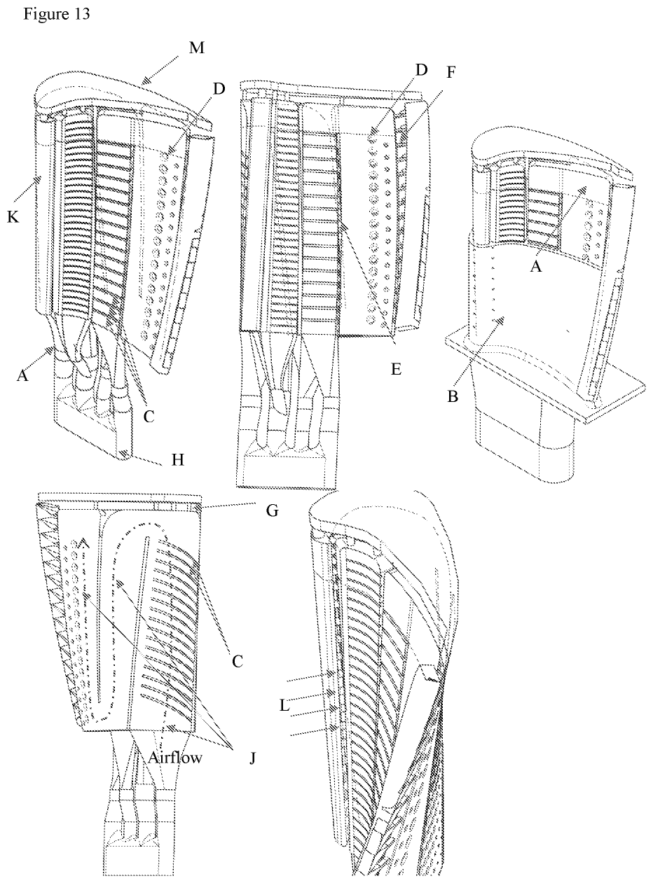

FIG. 12 (a) illustrates one embodiment of the casting core disclosed herein. The casting core or cores form some or all of the internal cavities, passages, and complex features and some external features present in the final blade (8B) during the casting process. The core provides a reverse definition for features including but not limited to turbulator ribs (8C), turbulator pins (8D), crossover holes (8E), trail edge channels (8F), tip holes (8G), inlets (8H), serpentine passages (8J), singular cavities (8K), or impingement holes (8L). It may also form portions of external features including but not limited to squealer rim (8M).

### V. Methods of Manufacturing a Final Article

Disclosed herein are methods of preparing a final article of manufacture (e.g., a cast metal component such as a turbine blade) and in particular, manufacturing a final product using a ceramic core disclosed herein and more particularly, a ceramic core prepared using a mold or injection molding assembly disclosed herein.

In one embodiment, a method for preparing a final article of manufacture (e.g., a turbine blade) is disclosed comprising (i) providing a ceramic core as disclosed herein; (ii) providing a suitable material(s); and (iii) using a suitable technique to form the article of manufacture from the suitable material using the ceramic core. In a particular embodiment, the ceramic core is prepared using the mold or inner mold disclosed herein and more particularly, a mold having one or more of the following characteristics: dissolvable, additively manufactured or monolithic.

In a particular embodiment, a method is disclosed for manufacturing turbomachinery component comprising (i) providing a mold defining the external geometry of the turbomachinery component wherein the mold contains a ceramic core defining the internal geometry of the turbomachinery component; and (ii) introducing a molten metal between the mold and the core; and (ii) removing the core. In a particular embodiment, the ceramic core is a ceramic core disclosed herein and more particularly, a ceramic core made the methods disclosed herein.

In one embodiment, a method is disclosed for preparation or casting of a turbine blade comprising (i) providing a mold defining the external geometry of the turbine blade, wherein the mold contains a ceramic core defining the internal geometry of the turbine blade; and (ii) introducing a molten metal between the mold and the core; and (ii) removing the core. In a particular embodiment, the ceramic core is a ceramic core disclosed herein and more particularly, a ceramic core made the methods disclosed herein.

In a particular embodiment, the method is repeated multiple times. In another embodiment, the method is suitable for preparing more than one turbine airfoil simultaneously.

In a particular embodiment, the method disclosed herein reduce core shift by up to about 150 microns, or more particularly, about 10, about 25, about 50, about 75, about 100, about 125 or about 150 microns.

In another particular embodiment, the injection molding assembly reduces core shift by up to about 50%, or more particularly, about 10%, about 20%, about 30%, about 40% or about 50%.

### VI. Final Article of Manufacture

In one embodiment, final articles of manufacture are disclosed including, but not limited to, cast turbomachinery components. In a particular embodiment, the final article of manufacture is a turbomachinery component for use in an internal combustion engine and more particularly, a gas turbine engine in the aerospace or energy industry.

In one embodiment, the final article of manufacture is a cast turbomachinery component (e.g., a turbine blade) formed using methods in which investment casting processes are carried out using ceramic cores formed using dissolvable molds or mold assemblies and in particular, dissolvable molds with dissolvable internal sections or components. In a particular embodiment, the cast turbomachinery component (e.g., turbine blade) comprises one or more cooling features disclosed herein.

In a particular embodiment, the final manufactured product is a cast turbomachinery component (e.g., a turbine blade) produced from an ceramic core disclosed herein. In one embodiment, the turbomachinery component is a cast turbomachinery component made utilizing a ceramic core disclosed herein, and more particularly, utilizing the injection molding assembly and injection molding methods disclosed herein.

In certain embodiments, the final article of manufacture is a cast turbomachinery (e.g., a turbine blade) characterized by improved engineering performance compared to existing cast turbomachinery components.

In certain embodiments, this improved engineering performance results in cast turbomachinery component (e.g., a turbine blade) having one or more desirable properties such as increased durability, reduced maintenance costs, advanced cooling capabilities, improved mechanical performance, improved local structural properties, improved vibrational behavior, greater overall freedom of aerodynamic design or a combination thereof compared to existing cast turbine components (e.g., turbine blades).

In a particular embodiment, the final articles of manufacture disclosed herein (e.g., a turbine blade) is a cast turbomachinery component exhibits one of more of the following non-limiting characteristics: (1) an aerodynamic exterior form, (2) fine internal features such as hollow channels, protrusions into internal cavities, (3) internal channels or serpentine passages, impingement holes optionally connecting internal channels, or (4) internal turbulating features. These designs and/or features are directed to cooling the article of manufacture under normal operating conditions—either internally or externally (e.g., film cooling).

In a particular embodiment, the final article of manufacture is a cast turbomachinery component (e.g., a turbine blade) suitable for use in a high temperature, pressure, load and/or vibrational environment such as that encountered in turbomachinery applications. The high temperature environments may approach or exceed the softening or melting points of the materials of the article of manufacture. In a particular embodiment, the high temperature environment is greater than about 1300, about 1400, about 1500, about 1600, about 1700, about 1800, about 1900, about 2000, about 2100, about 2200 or about 2300° C. or more.

In one embodiment, the final article of manufacture d includes, but is not limited to, single crystal nickel and/or titanium-based superalloy gas turbine airfoils, compressor airfoils, turbine airfoils, high-pressure compressor blades, low-pressure compressor blades, high-pressure turbine blades, a low-pressure turbine blades, turbine vane segments, turbine vanes, nozzle guide vanes, turbine shrouds, turbine accessory gearbox components, jet engine components, molds, or casts and ceramic cores, dies and molds used to make single crystal nickel and/or titanium-based superalloy gas turbine airfoils, compressor airfoils, turbine airfoils, high-pressure compressor blades, low-pressure compressor blades, high-pressure turbine blades, a low-pressure turbine blades, turbine vane segments, turbine vanes, nozzle guide vanes, turbine shrouds, turbine accessory gearbox components, jet engine components, molds, and casts that cannot be manufactured with current materials and/or current processes. In a particularly embodiment, the final article of manufacture comprises previously unachievable geometric designs and/or features.

In one embodiment, the final article of manufacture is a cast turbomachinery component (e.g., a turbine blade) made from one or more materials selected from the group consisting of stainless steel, nickel, chromium, aluminum, molybdenum, tungsten, niobium, tantalum, cobalt, titanium superalloys, single crystal superalloys, intermetallic superalloys, ceramic molds, ceramic over molds, ceramic cores, and cast ceramics or lay-up products of manufacture, including ceramics matrix composite (CMC) components.

In one embodiment, the final article of manufacture is a cast turbomachinery component (e.g., a turbine blade) comprising metal components, wherein the metal is selected from the group consisting of nickel-based single crystal superalloys, reactive metal alloys, directionally solidified superalloys and equiax superalloys for use in turbomachinery applications including rocket engine components, jet engine components and industrial gas turbine components.

In one embodiment, the final article of manufacture is a cast turbomachinery component (e.g., a gas turbine blade) that increases the efficiency of the internal combustion engine (e.g., the gas turbine engine) in which the turbomachinery component is housed.

In a particular embodiment, the final article of manufacture is a turbomachinery component (e.g., a gas turbine blade) that increases the thermal efficiency and/or fuel efficiency of the internal combustion engine (e.g., the gas turbine engine) in which the turbomachinery component is housed. In one embodiment, the thermal and/or fuel efficiency is increased by about 5%, about 10%, about 15%, about 20% or about 25% or more.

In one embodiment, the final article of manufacture is a turbomachinery component (e.g., a gas turbine blade) that increases the efficiency of the internal combustion engine (e.g., a gas turbine engine) in which the turbomachinery component is housed, leading to reduced fuel consumption by up to 1%, and more particularly, about 0.1, about 0.2, about 0.3, about 0.4, about 0.5, about 0.6, about 0.7, about 0.8, about 0.9 or about 1% or more.

In another embodiment, the final article of manufacture is a turbomachinery component (e.g., a gas turbine blade) characterized by improved durability compared to existing turbomachinery components. In a particular embodiment, the improvement in durability is between about 0 and about 5%, or about 1 and about 5% time before removal (0-100) cycles), or more particularly about 1%, about 2%, about 3%, about 4% or about 5% or more. In another embodiment, the increase in cycles is between about 1 and about 100, or more particularly, about 10 and about 90, about 20 and about 80, about 30 and about 70, about 40 and about 60 or about 50 cycles.

In a particular embodiment, the final article of manufacture is a turbomachinery component (e.g., a gas turbine blade) that enables a higher turbine inlet temperature (TIT) than previously achievable for an internal combustion engine (e.g., gas turbine engine). In one embodiment, the increase in TIT is associated with increased thermal efficiency, increased power output or both. In a particular embodiment, the turbomachinery component (e.g., gas turbine blade) disclosed herein permits an increased TIT using the same or similar amount of cooling air as existing turbomachinery components.

In one embodiment, the turbine inlet temperature is increased by about 0.5%, about 1%, about 2%, about 3%, about 4%, about 5%, about 10%, about 15%, about 20% or about 25%. In a particular embodiment, the turbine inlet temperature is about 0.5 and about 10%, about 1 and about 5%, or about 2 and about 3% higher. In another particular embodiment, the turbine inlet temperature that is greater than about 1%, greater than about 2% greater than about 3%, greater than about 4% or greater than about 5% higher.

In another embodiment, the turbine inlet temperatures is about 10 to 300° C. higher, e.g., about 100 to about 250, or more particularly, about 10, about 100, about 150, about 200, about 250, or about 300° C. higher. In a particular embodiment, the turbine inlet temperature is between about 10 and about 50° C. higher, e.g., about 15 and about 45, about 20 and about 40 or about 30° C. higher.

In a particular embodiment, turbine inlet temperatures is greater than about 1000, greater than about 1500, greater than about 1550, greater than about 1600, greater than about 1650, greater than about 1700, greater than about 1750, greater than about 1800, greater than about 1850 or about 1900° C. or greater.

In one embodiment, the final article of manufacture is a turbine blade or turbine nozzle.

In a particular embodiment, the final article of manufacture is a turbine blade. The turbine blade may be installed in an array in one or more axially arranged stages attached to a revolving rotor and spin the rotor through momentum transfer and pressure via hot gasses resulting from combustion. In a particular embodiment, the turbine blade may comprise a material selected from the group consisting of stainless steel, nickel, chromium, aluminum, molybdenum, tungsten, niobium, tantalum, cobalt, titanium superalloys, single crystal superalloys, intermetallic superalloys, ceramic molds, ceramic over molds, ceramic cores, and cast ceramics or lay-up products of manufacture, including ceramics matrix composite (CMC) components.

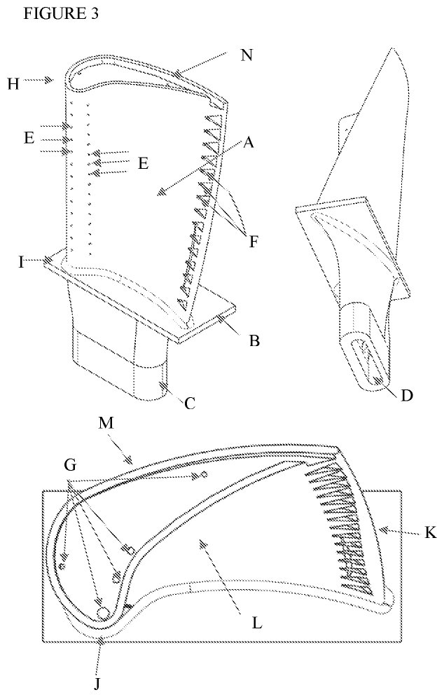

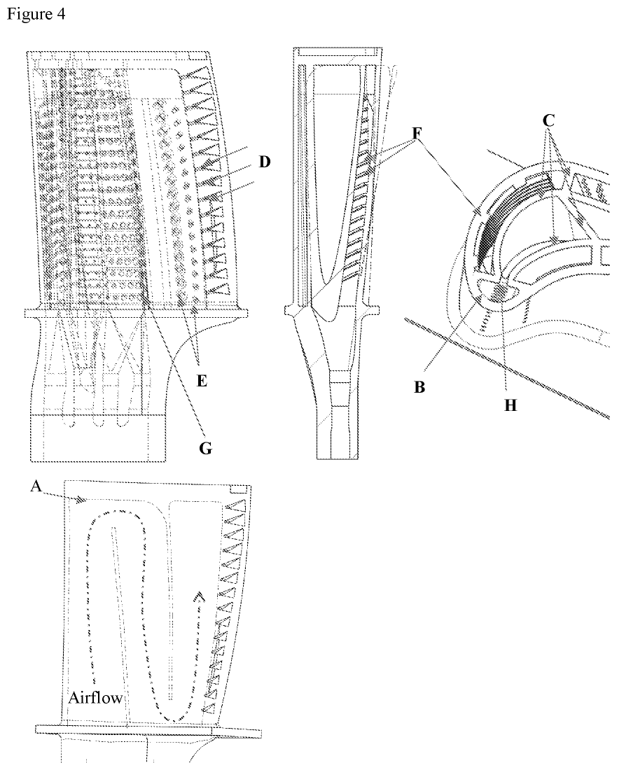

FIG. 3 a typical turbine blade. The turbine blade includes an airfoil (3A) that is joined to a shank (3C) with a platform (3B) in-between. The inlet (3D) supplies cooling air to internal passages which are further defined in FIG. 4. The internal passages lead to various outlets including but not limited to film cooling holes (3E), trail edge channels (3F), or tip holes (3G). A squealer rim (3N) may or may not be present to serve as the sealing interface between the blade and the corresponding flowpath wall. Locations on the airfoil are defined as follows: Tip (3H) the radially outermost portion of the blade; root (3I) the portion of the airfoil just radially outward of the platform; lead edge (3J) the aerodynamically forward most portion of the airfoil; and trail edge (3K) the aerodynamically aft most portion of the airfoil; pressure side (3L) the concave outer wall of the airfoil; and suction side (3M) the convex outer wall of the airfoil.

FIG. 4 illustrates various internal features present in a typical turbine blade. The inlet (3D) feeds cooling air internal cooling passages. These passages can be in the form of a serpentine passage (4A) or a singular cavity extending from root to tip (4B). Cavities are separated by multiple internal walls (4C). Trail edge channels (4D) are fed by these passages. Turbulator pins (4E) are protrusions in the cavities which may or may not span the entirety of the cavity. Turbulator ribs (4F) are partial protrusions into the cavity which span a portion or all of a wall. Crossover holes (4G) or impingement holes (4H) connect cavities.

The turbine blades disclosed herein include an airfoil section which is comprised of a concave pressure side wall and a convex suction side wall connected at a leading edge and trailing edge which enclose a plurality of internal cooling passages and cavities. These cavities are supplied with cooling air through inlet passages in the radially inner most portion of the blade, the shank, which pass through the radially inner most portion of the airfoil, the root. The radially outermost portion of the turbine blade is terminated by the tip.

In one embodiment, the final article of manufacture is a gas turbine blade that exhibits an increased average blade cooling effectiveness (ϕ) compare to a gas turbine blade made by conventional means. An increase in average cooling effectiveness allows gas turbine operators to increase TIT, which, in turn, increases the thermal efficiency of the system without compromising the life of the blade. In a particular embodiment, the average blade cooling effectiveness (ϕ) is increased by about 5%, about 10%, about 15%, about 20% or about 25% or more. In another particular embodiment, the blade cooling effectiveness is greater than about 0.4, about 0.45, about 0.5, about 0.55, about 6, about 0.65, about 0.75, about 0.8, about 0.85, about 0.9, about 0.95 or about 14 at a temperature between about 1400 and about 2000, more particularly, about 1400, about 1500, about 1600, about 1700, about 1800, about 1900 or about 2000° C.

In one embodiment, the average blade cooling effectiveness is greater than about 0.4, 0.42. 0.46, 0.48, 0.50, 0.52, 0.54, 0.56, 0.58, 0.60, 0.62, 0.64, 0.66, 0.68, 0.70, 0.72, 0.74, 0.78 or 8.0 ϕ at a temperature of between about 1400 and about 2000, more particularly, about 1400, about 1500, about 1600, about 1700, about 1800, about 1900 or about 2000° C.

In another particular embodiment, the final article of manufacture is a gas turbine blade that exhibits an airfoil temperature that is less than previously achievable for a gas turbine blade made by existing methods. In one embodiment, the airfoil temperature is reduced by about 5%, about 10%, about 15%, about 20%, or about 25% or more.

In another particular embodiment, the final article of manufacture is a gas turbine blade that permits about a 0.1 to about a 15% increase in heat transfer cooling effectiveness and more particularly, about 1 to about 15%, about 5 to about 15%, or more particularly, about 0.1, about 1, about 3, about 5, about 8, about 10, about 12, or about 15% or more increase in heat transfer cooling effectiveness.

In yet another particular embodiment, the final article of manufacture is a gas turbine blade that has a useful life that is greater than previously achievable for a gas turbine blade or turbine made by existing methods. In a particular embodiment, useful life is increased by about 5%, about 10%, about 15%, about 20% or about 25% or more. In one embodiment, overall time before blade failure is improved by up to 50%, more specifically about 20%, more specifically about 10%, or more specifically about 3%.

In on embodiment, failure of the turbine blade does not occur before 3500, about 3750, about 4000, about 4250, about 4500, about 4750, about 5000, about 5250, about 5500, about 5750, about 6000, about 6250, about 6500, about 6750, about 7000, about 7250, about 7500, about 7750, or about 8000 hours or more.

In one embodiment, the final article of manufacture is a turbine blade comprising one or more features selected from structural features, cooling features or combinations thereof.

In certain embodiments, the gas turbine blade contains or more cooling features that permit the blade to exceed the maximum allowable temperature of the material from which blade is made and in particular, to withstand the maximum temperature to which the gas turbine blade is exposed. This differential temperature may vary. In certain embodiments, the differential is between about 400 and 600, about 500 and about 700 or about 600 and about 800° C. In a particular embodiment the differential represents the differential between the maximal allowable temperature of the single crystal alloy used to make the gas turbine blade and the maximal obtainable fuel composition temperature of the gas turbine engine.

The cooling feature provide cooling air to the turbine blade by a mechanism selected from convective cooling, augmented convective cooling, impingement (no film) cooling, multi-pass cooling (e.g., two-pass, three-pass), film/cross-flow impingement cooling, transpiration cooling or a combination thereof.

In a particular embodiment, the one of more cooling features is selected from the group consisting of cavities, complex internal features, flow channels, reservoirs, inlets, outlets, hierarchical meshes, walls, or other structures or combinations thereof produced therefrom by means of an intermediate article (ceramic mold) having features about 1 nm to about 10 m in size, more specifically about 500 nm to about 1 m, more specifically about 1 micrometer to about 1 cm, more specifically about 5 micrometers to about 500 micrometers, more specifically about 10 micrometers to about 400 micrometers, or any combination thereof of these specified dimensions.

In one embodiment, the turbine blade comprises one or more cooling features on the order of 1 nm to about 10 m in size, more specifically about 500 nm to about 1 m, more specifically about 1 micrometer to about 1 cm, more specifically about 5 micrometers to about 500 micrometers, more specifically about 10 micrometers to about 400 micrometers, or any combination thereof of these specified dimensions. In a particular embodiment, the one or more cooling feature are on the order of about 400 micrometers in size or less.

In a particular embodiment, the one or more cooling features are internal cooling features, external cooling features or a combinations thereof. The one or more cooling features may be located in one or more sections of the gas turbine blade and may impact the temperature, the temperature distribution or both. In a particular embodiment, the one or more cooling features are located in the trailing edge, the mid-chord section or the leading edge.

In one embodiment, the final article of manufacture is a gas turbine blade comprising one or more internal cooling features. In internal cooling, a small amount of air is extracted (bled) from the compressor and injected into the gas turbine blade. Cooling air is supplied from the engine compressor at a cost to cycle performance, so the internal cooling features described herein provide necessary cooling with the minimum required cooling air flow. In a particular embodiment, the cooling flow required is less than about 5%, less than about 4%, less than about 3%, less than about 2% or less than about 1% of total flow. In certain embodiments, the internal cooling features(s) permit an increase the heat transfer coefficient by up to about 1%, about 3%, about 5%, about 8%, about 10%, about 12%, about 15%, about 18% or 20% or more or less without significantly increasing the pressure loss of the coolant fluid in the passageway.

In a particular embodiment, the gas turbine blade comprises one or more cooling passages, channels or cavities. Cooling air flows through the internal cooling passages and cavities and cools the body of the airfoil through internal convective cooling. Internal cavities and passages may be connected by cross-over holes or impingement holes.

In a particular embodiment, the turbine blade comprises a plurality of cooling channels, i.e., two or more, three or more, four or more, five or more, six or more, seven or more, eight or more, nine or more or ten or more cooling channels. The one or more cooling channels may be single-pass or multi-pass.

In one embodiment, the spacing, orientation and shape of the cooling channels may vary. In certain embodiments, the one or more cooling channels are circular, tubular, ovular, square, rectangular, triangular, trapezoidal, or polygonal configuration in cross-section. The cooling channels may be characterized by a serpentine or zigzag flow axis. Optionally, the cooling channels may contain one or more turbulating features, such as one or more dimples, protrusions, pin-fins, either alone or in combination. In certain embodiments, the one or more turbulating features may be in any orientation.

In one embodiment, the turbine blade comprises one or more pin-fin cooling channels. The pin-fin channels may enhance heat transfer as well as provide structural support. The spacing, orientation, shape and location of the pin-fins may vary.

In a further embodiment, the one or more cooling channels comprise pin geometries, wherein the novel pin geometries (1) improve convective cooling of the turbine airfoil through increased ability to generate turbulent flow in desired magnitude and location, (2) improve local structural rigidity through the use of angled or crossing pins, (3) improve convective cooling performance through increased effectiveness of impingement cooling enabled by greater control of direction of impingement cooling, (4) increase effectiveness of impingement cooling enabled by lead edge impingement holes with protruding nozzle geometry, (5) improve film cooling effectiveness through increased channel length and ideal exit angles not limited by location relative to internal cavities, (6) enable more uniform airfoil wall temperatures through the employment of mesh impingement cooling, (7) improve engine efficiency by enabling greater combustion temperatures, (8) improve durability of turbine blades through reduced turbine blade body temperatures, and (9) improve durability of turbine blades through increased capability in adjusting local stiffness of a blade in order to tune blade vibratory frequencies.

The shape of the pin may vary. In one embodiment, the pin is circular, diamond or cubic in shape.

The diameter of the pin (Dp) may vary. In one embodiment, the pin has a diameter of about 1 nm to about 10 m in diameter, more specifically about 500 nm to about 1 m, more specifically about 1 micrometer to about 1 cm, more specifically about 5 micrometers to about 50 millimeters, more specifically about 100 micrometers to about 3 millimeters, or any combination thereof of these specified dimensions. The pin height (Hp) may vary. In one embodiment, the pin height (Hp) has a length of about 1 nm to about 1 m, more specifically about 500 nm to 500 mm, more specifically about 1 micrometer to about 10 cm, more specifically about 150 micrometers to about 3 millimeters, or any combination thereof of these specified dimensions. In a particular embodiment, the pins have a height-to-diameter ratio between about 1.3 and about 8, or more particularly, about ½ and about 5.

In certain embodiments, the pins are present in arrays. The arrays may be in-line or staggered with respect to the direction of flow. The spanwise and streamwise spacing of the arrays may differ.

The one or more pin-fin channel may be located in any section of the blade. In one embodiment, the pin-fin channel is located within the trailing edge of the blade. In a particular embodiment, the gas turbine blade disclosed herein comprises pins that span the trailing edge cavity from the suction side wall to the pressure side wall. These pins may span a wall to wall length of 1 nm to 1 m, more specifically 500 nm to 500 cm, more specifically 5 micrometers to 500 millimeters, more specifically 50 micrometers to 50 millimeters, or any combination thereof.

The angle of the one or more pins may vary. Described herein are design advancement that overcome design limitations of current manufacturing methods in which a split line results in a plane of symmetry to which each array of pins must be orthogonal to. In the article of manufactured disclosed herein, all or a portion of the pins are not limited in orientation to a plane of symmetry required by a mold split line.

In a particular embodiment, the turbine blade disclosed herein comprises one or more cooling cavities in the trailing edge, wherein the one or more cooling cavities contain a plurality of turbulator pins which are arranged at angles to between the suction side and pressure side walls of the trail edge cavity.

The one or more pins may be characterized by angles may range from −90 to 90 degrees, more specifically, −70 degrees to 70 degrees, more specifically −50 degrees to 50 degrees, or any combination thereof these specified angles. The vectors of the centerlines of these pins may also be at different angles relative to other pins in the same cavity. These angles may range from −90 to 90 degrees, more specifically, −70 degrees to 70 degrees, more specifically −50 degrees to 50 degrees, or any combination thereof these specified angles.

In a particular embodiment, the final article of manufacture (e.g., a turbine blade) exhibits improved cycle fatigue performance through optimized vibratory behavior. Turbine blades disclosed herein exhibit improved fatigue resistance and increased achievable numbers of use life cycles by exhibiting improved vibratory behavior, in which the resonant frequencies of vibration of a blade driven by aerodynamic use gives rise to high cycle fatigue in blades. The vibratory behavior is characterized by resonant frequency and mode shape. Resonant frequency is driven by blade stiffness and shape, and blade stiffness and shape are influenced by blade geometry, material, temperature, aero loading, mechanical dampening, and rotational velocity. Thus, blade mechanical design encompasses increasing or decreasing resonant frequencies of a blade such as to avoid resonant frequencies that are excited by engine operating conditions. Mode shape can be characterized by node lines and deflection and changes at each resonant frequency. The locations of these node lines characterize locations on the mode shape that do not deflect at a particular resonant frequency which in turn defines high stress regions during blade vibration. The locations of these high stress regions are analyzed in turbine blade design and drive mechanical design of the blade such that high stress locations of the blade are shifted away from stress sensitive areas of the blade. Airfoil geometry such as wall thicknesses, airfoil thicknesses, location of internal walls, overall airfoil aerodynamic shape, and location and quantity of pins are traditionally adjusted in order to avoid resonant frequencies at engine operating conditions and change mode shapes in order to avoid high stress locations in critical areas.

The angled pins present in the turbine blade disclosed herein will result in tension when the turbine blade is locally bending in one direction and compression in the other direction. Depending on adjacent geometry, this may increase or decrease equivalent stiffness of the region by about 0 to about 70%, more specifically about 0% to about 50%, more specifically about 0% to about 20%, or more specifically about 0% to about 5%. This will increase or decrease blade resonant frequency by about 0 to about 84%, more specifically about 0% to about 70%, more specifically about 0% to about 44%, more specifically about 0% to 22%. In this embodiment, the node lines may be shifted as a proportion of total blade length by about 0% to 20%, more specifically about 0% to about 10%, more specifically about 0% to about 7%, or more specifically about 0% to about 5%. The increased ability to change blade resonant frequency and node line location will allow for greater freedom in selecting wall thicknesses, airfoil thickness, location of internal walls, airfoil shape, and location and quantity of pins. This will allow for more freedom to optimize aerodynamic shape and pin array design. The result in an overall engine efficiency improvement of up to about 1%, more specifically about 0.1%, more specifically about 0.01%, or more specifically about 0.005%. Additionally, the increased freedom permits overall blade time before failure to be improved by as much as about 50%, more specifically about 20%, more specifically about 10%, or more specifically about 3%.

In a particular embodiment, the turbine blade has pins that span the trailing edge cavity from the suction side wall to the pressure side wall at an angle or angles perpendicular or not perpendicular to a midplane of the cavity or a wall that intersect with adjacent pins. This pins may be arranged in the same angle or varying angles.

In a particular embodiment, pins that span the trailing edge cavity from the suction side wall to the pressured side wall intersect. Intersecting pins will further increase stiffness of the local structure formed by the intersecting pins spanning the pressure side and suction side walls. This will allow for greater ability to tune the vibrational behavior of a blade.

A plurality of pins may intersect, more specifically 2 to 8 pins, more specifically 2 to 5 pins, more specifically 2 to 4 pins, or any combination thereof. The pins may intersect at any point along an individual pin span such that a two pin intersecting structure may form a “V” shape or from a cross shape. A three pin structure may form a three sided pyramid shape or intersect mid plane to form two interconnected pyramid shapes.

In this embodiment, intersecting pins result in localized bending stress over a larger area compared to singular pins and increase equivalent stiffness of the region by about 0 to about 70%, more specifically about 0% to about 50%, more specifically about 0% to about 20%, or more specifically about 0% to about 5%. This will increase blade resonant frequency by about 0 to about 84%, more specifically about 0% to about 70%, more specifically about 0% to about 44%, more specifically about 0% to about 22%. In this embodiment, the node lines may be shifted as a proportion of total blade length by about 0% to about 20%, more specifically about 0% to 10%, more specifically about 0% to about 7%, or more specifically about 0% to about 5%. The increased ability to change blade resonant frequency and node line location will allow for greater freedom in selecting wall thicknesses, airfoil thickness, location of internal walls, airfoil shape, and location and quantity of pins. This will allow for more freedom to optimize aerodynamic shape and pin array design to result in an overall engine efficiency improvement of up to about 1%, more specifically about 0.1%, more specifically about 0.01%, or more specifically about 0.005%. Additionally, the increased freedom will enable overall blade time before failure to be improved by as much as about 50%, more specifically about 20%, more specifically about 10%, or more specifically about 3%.

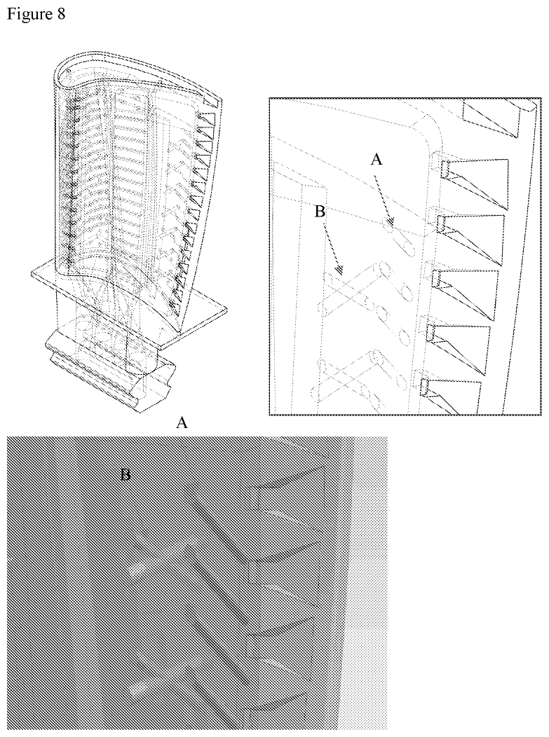

FIG. 8 illustrates angled pins (3A) and intersecting pins (3B) in one embodiment of the turbine blade disclosed herein. Angled pins (3A) are protrusions that span the trail edge cavity from pressure side to suction side. In this embodiment, these pins are at an angle to both walls and the midplane of the cavity. Intersecting pins (3B) are pairs of protrusions that span the trail edge cavity from pressure side to suction side in which they intersect and form a cross-like structure in one embodiment. They may form more complex structures in another embodiment.

In one embodiment, the internal cooling mechanism is one or more rib turbulating channels, i.e., a channel comprising one or more turbulating ribs. In a particular embodiment, the rib turbulating channel(s) is located in the mid-chord region of the gas turbine blade.

The size, shape, spacing, distribution and orientation (angle) of the turbulator rib may vary. Representative, non-limiting, shapes of turbulator ribs include square, isosceles triangular, reverse right-angle triangular, right angle triangular, right angle trapezoidal, isosceles trapezoidal, semicircular, fan-shaped, house-shaped, reverse cut-trapezoidal, cut-trapezoidal, reverse boot-shaped, boot-shaped, reverse pentagonal, pentagonal and reverse right angle trapezoidal. In a particular embodiment, the ribs are situated on opposite walls of the inner cooling channel. In a particular embodiment, only one side of the inner cooling channel has ribs.

In certain embodiments, the ribs may be present on adjacent walls of the cooling channel, i.e., pressure and suction sides). In alternative embodiments, the ribs are present on only one side of the cooling channel. The arrangement of the ribs may be symmetric or staggered.

In one embodiment, the ribs are arranged orthogonally to the flow. In another embodiment, the ribs are angled with respect to the main flow. In a particular embodiment, the ribs are 75°, 60° or 45° ribs.

In a particular embodiment, the turbine blade comprises a rib-dimpled compound channel.

In one embodiment, the turbine blade comprise a one or more impingement holes. In a particular embodiment, the turbine blade comprises a plurality of impingement holds. The impingement holes may vary size, shape, injection angle and location of the holes may vary. Similarly, the spacing between a plurality of film cooling holes may vary.

In one embodiment, the turbine blade comprises one or more impingement holes as small as 0.013″ in any location, internal or external. In another embodiment, the turbine blade comprises a plurality of impingement holes that are multi-angled.

In a particular embodiment, impingement holes are selectively located in turbine blades to enable directed cooling of blade sections. The one or more impingement holes may be located in one or more sections of the turbine blade.

For turbine blades with impingement holes in this embodiment, exits to a cavity adjacent to the pressure side wall are formed in multiple angles, enabling greater freedom in placing the impingement flow impingement location as well enabling ideal impingement angles. In this embodiment, cooling air flows from the adjacent cavity through the impingement holes into the cavity adjacent to the airfoil wall and contacts the internal surface of the airfoil wall as an impingement jet. The impact of cooling air on the airfoil wall results in convective heat transfer, with the highest rate of heat transfer at the center of the impact location, and the airfoil wall is locally cooled with each impingement jet such that local areas of the wall are cooler than adjacent areas.

In one embodiment, the impingement holes with exits to a cavity adjacent to the pressure side wall are formed in multiple angles, enabling greater design freedom in placing the impingement location of the impingement cooling stream.

For airfoil walls comprising non-uniform temperature distributions, it is advantageous to enable targeted cooling through impingement holes to cool areas with locally higher temperature with a directed impingement jet exiting an impingement hole. Traditional manufacturing methods are design limited in that impingement holes must be parallel. For certain airfoil internal wall geometries formed using exiting methods, there may be regions of the airfoil wall which may not be able to be cooled by impingement jets. In one embodiment, a turbine blade is disclosed comprising impingement holes are arranged in multiple angles to ensure impingement jets may be directed to impart cooling flow in hot areas of the wall which previously did not have access to impingement cooling.

In one embodiment, the impingement holes are of about 1 nm to about 10 m in diameter, more specifically about 500 nm to 1 m, more specifically about 1 micrometer to about 1 cm, more specifically about 5 micrometers to about 50 millimeters, more specifically about 100 micrometers to about 3 millimeters, or any combination thereof of these specified dimensions. The vectors of the centerlines of these holes are at the same or different angles relative the wall which they penetrate. These angles may range from about −90 to about 90 degrees, more specifically, about −60 degrees to about 60 degrees, more specifically about −30 degrees to about 30 degrees, or any combination thereof these specified dimensions.

In a particular embodiment, a turbine blade is disclosed comprising impingement holes with exits formed of positive material connect the leading edge cavity to an adjacent cavity or cavities. The positive material serves to reduce the distance from the impingement hole exit to the opposing wall. The positive material also is shaped such as to improve impingement hole exit gas aerodynamics and improve impingement performance. In this embodiment, the impingement holes are of diameter about 1 nm to about 1 m, more specifically about 500 nm to about 5 cm, more specifically about 50 micrometers to about 50 millimeters, more specifically about 200 micrometers to about 5 millimeters, or any combination thereof.

In this embodiment, the positive material may protrude from the wall in which the hole penetrates about 0 nm to about 1 m, more specifically about 500 nm to about 5 cm, more specifically about 50 micrometers to about 50 millimeters, more specifically about 200 micrometers to about 10 millimeters, or any combination thereof. The shape of a protrusion may be conical, tapered conical, pyramid shape, or polygonal prism shape. The holes are at an angle to the wall they perforate between about 1 to about 90 degrees, more specifically about 10 to about 90 degrees, more specifically about 40 to about 90 degrees, more specifically about 70 to about 90 degrees, or any combination thereof. The distance from the impingement hole exit to the opposing wall is between about 1 nm to about 1 m, more specifically about 500 nm to about 5 cm, more specifically about 50 micrometers to about 50 millimeters, more specifically about 200 micrometers to about 10 millimeters or any combination thereof.

In a particular embodiment, impingement holes with nozzle shaped exits formed of positive material connect the leading edge cavity to an adjacent cavity or cavities. The positive material serves to reduce the distance from the impingement hole exit to the opposing wall. The positive material also is shaped such as to improve impingement hole exit gas aerodynamics and improve impingement performance.

In one embodiment, the one or more features comprise crossover holes and more particularly, multi-angled crossover holes.

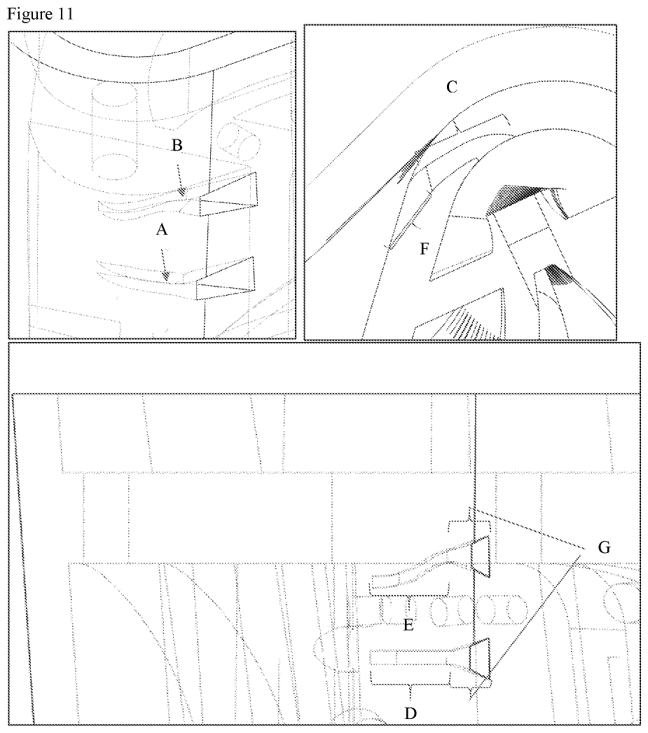

In one embodiment, the internal cooling feature is a cooling mesh, wherein the cooling mesh comprising a dense array of small holes. FIG. 11 shows a view of an embodiment of the turbine blade impingement cooling mesh where airflow (7C) flows from an internal cavity (7A) into an adjacent cavity (7B) which is adjacent to either the pressure side (7D) or suction side wall through a dense array of small holes.

In another embodiment, the turbine blade comprises porous metal walls. In a particular embodiment, a portion of the pressure side wall of the turbine blade disclosed herein encapsulates a locally porous metal volume with stochastic structure through which cooling air is supplied through one or multiple inlets and is exhausted through film cooling holes and tip holes.

In another embodiment, the one or more features that promote external cooling.

In one embodiment, the external cooling mechanism is film cooling, which comprises pumping the cooling air out of the blade through multiple small holes in the structure. A thin layer (the film) of cooling air is then created on the external surface of the blade, reducing the heat transfer from main flow.

In a particular embodiment, curved passage film cooling holes connect the internal lead edge cavity to the exterior of the turbine blade. The film cooling holes provide a layer of film cooling to the exterior to the blade. In this embodiment, the curved film cooling passage allows for improved film cooling effectiveness and greater flexibility in positioning film cooling hole inlets and exits.

The film cooling passage exhibits curvature which may be defined by a passage cross-section following an imaginary centerline defined as a spline composed of a section of single radius of curvature or a combination of multiple sections of radii of curvature and straight sections. The individual radius of curvature of a single section of a composite centerline spline may range from infinite (straight) to as small as about 1 nm, more specifically about 100 nm, more specifically about 1 micrometer, more specifically about 100 micrometers, more specifically about 200 micrometers or any combination thereof. The centerline spline may be a composite of multiple sections of curvature with radius or straight with section count ranging from about 1 to about 100, more specifically about 1 to about 50, more specifically about 1 to about 20, more specifically about 1 to about 10, more specifically about 1 to about 6, or any combination thereof. In one embodiment, the composite centerline spline is two dimensional and exhibits curvature in only one imaginary plane. In another embodiment, the composite centerline is three dimensional and exhibits curvature in two imaginary planes. The passage cross-section defines the shape of the film cooling passage and may be square, square with rounded corners, rectangular, rectangular with rounded corners, trapezoidal, trapezoidal with rounded corners, circular, or ovular and may transition between cross sectional shapes along the centerline spline. The cross-sectional area may be about 100 square nm to about 1 square meter, more specifically about 200 square nm to about 50 square centimeters, more specifically about 300 square nanometers to 1 square centimeter, more specifically about 500 square nanometers to about 10 square millimeters, or any combination thereof. The cross-sectional area may remain constant from the internal entrance of the film cooling passage to the transition to diffusion geometry or it may increase from the internal entrance to the transition to diffusion geometry by as much as about 80%, more specifically about 70%, more specifically about 45%, or more specifically about 20%.

The film cooling passage may then pierce the external surface of the airfoil wall in its current shape, or it may transition to a diffusion shaped exit. The angle at which the centerline of the passage pierces the external surface of the airfoil wall may range from about 0.01 degree to about 90 degrees, more specifically about 0.1 degree to about 50 degrees, more specifically about 0.2 degrees to about 40 degrees, more specifically about 0.2 degrees to about 20 degrees, or any combination thereof. A diffusion shaped exit serves to increase the propensity for film cooling flow to remain attached to the airfoil exterior surface as well as to widen the film cooling flow shape in order to provide greater coverage from a single film cooling hole. The diffusion shape had side walls that radiate from the exit of the film cooling hole in a fan like fashion such that the angle between each side wall and the centerline of the exit is about 0 degrees to about 70 degrees, more specifically about 0 degrees to about 50 degrees, more specifically about 0 degrees to about 30 degrees, more specifically about 0 degrees to about 15 degrees, more specifically about 0 degrees to about 10 degrees, or any combination thereof.

In a particular embodiment, a portion of an inner wall is perforated in a dense array of holes such that it behaves in a porous manner to provide uniform, directed impingement cooling air over a broad area. While impingement cooling has one of the highest heat transfer capability within air convection cooling methods, impingement cooling may result in high temperature gradients, as the highest heat transfer capabilities reside in the center of the impingement jet contact areas. High temperature gradients result in thermally driven stresses which reduce the durability of the turbine blade.

Reducing the size of impingement holes and increasing quantity will reduce the thermal gradient between impingement contact locations. Thus, for large areas of wall with moderate cooling needs, it is advantageous to minimize impingement hole area and maximize impingement hole quantity. Traditional manufacturing technologies have limited impingement hole size to be greater than about 400 micrometers and have limited impingement hole quantity to less than about 100 per square centimeter. In this embodiment, a dense array of holes of diameter about 1 nm to about 400 micrometers or greater are enabled such that hole count per square centimeter is about 50 to about 1 billion, more specifically about 60 to about 1 million, more specifically about 80 to about 500,000, more specifically about 100 to about 100,000, or any combination thereof. Each hole extends through entire thickness of a wall with wall thickness that about 1 nm to about 1 meter, more specifically about 500 nm to about 50 centimeters, more specifically about 10 micrometers to about 10 centimeters, more specifically about 250 micrometers to about 15 millimeters, or any combination thereof. The centerlines of the individual holes may be at an angle to the surface of the inner wall by about 1 degree to about 90 degrees, more specifically about 10 degrees to about 90 degrees, more specifically about 30 degrees to about 90 degrees, more specifically about 60 degrees to about 90 degrees, or any combination thereof.

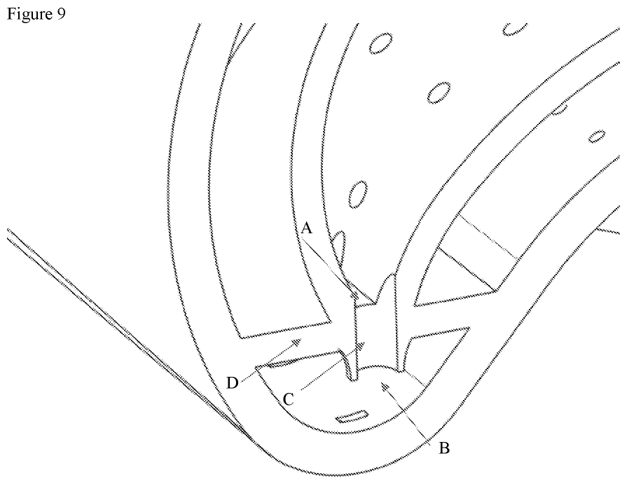

FIG. 9 illustrates the turbine blade lead edge impingement holes with positive exit features according to a cooling feature disclosed herein. In this embodiment, air flows from a cavity through the inlet (4A) and through an exit (4B) which extends through an internal wall (4D) and through a positive feature (4C).

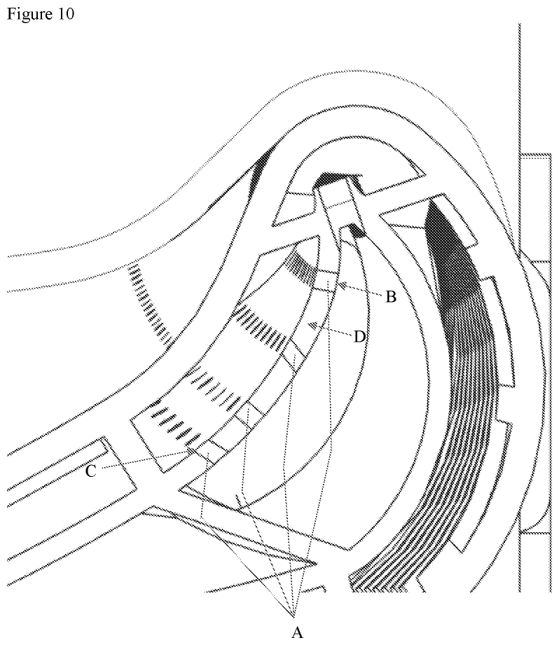

FIG. 10 illustrates turbine blade angled impingement holes (5A) in the pressure side cavity according to a cooling feature disclosed herein. Cooling air flows through the inlet (5B) of each hole through an exit (5C) and subsequently impinges on the internal side of the pressure side wall (5D). In this embodiment, these impingement holes are arranged in an array along all or a portion of the cavity wall and the holes are not parallel.

FIG. 11 depicts an embodiment of the turbine blade disclosed herein, comprising curved inlet passage film cooling holes. In one embodiment, the inlet passage (6C) is curved along one plane with circular or non-circular curvature (6A) and linear in another plane (6D). In another embodiment, the inlet passage is curved in two planes (6C, 6E) with a combination of circular and non-circular curvature or any combination thereof (6B). Cooling air then flows from the inlet passage (6C, 6E) to an expansion exit (6G). This expansion exit (6G) may be fan shaped such that the cooling flow experiences a greater flow area as it exits to the airfoil exterior.

In another embodiment, the external cooling mechanism is transpiration, which comprises releasing air through pores in the turbine blade. In another embodiment, the external cooling strategy comprises a thermal barrier coating.

In one embodiment, the final article of manufacture is a turbine nozzle. Turbine nozzles may be installed in an array in one or more axially arranged stages attached to stationary case or intermediate attachment and redirect and accelerate the hot gasses resulting from combustion to provide desirable aerodynamic and thermodynamic flow characteristics for subsequent turbine blade and nozzle stages.

Also disclosed herein is a gas turbine engine comprising one or more turbine blades disclosed herein.

### EXAMPLES

### Example 1: Preparation of Additively Manufactured Dissolvable, Core-Shell Mold

A dissolvable core/shell mold was additively manufactured using digital light projection to the geometries shown in FIG. 6. The geometries include an inner negative cavity and a connected outer shell cavity. T

The inner negative cavity exhibited the geometry of a ceramic core of the following dimensions: Overall height: approximately 3 inches; Overall width: approximately 1.25 inches; Overall thickness: approximately 0.4 inches; Lead edge impingement: 0.40 inches; Trail edge slots: 0.025 inches×0.016 inches; Turbulators: 0.020×0.020 inches; Turbulator pins: 0.030 DIA. The outer shell cavity was connected to the inner negative cavity and exhibited wall thicknesses of approximately 0.50 to 1.5 mm.

### Example 2: Preparation of Multi-Walled Ceramic Core

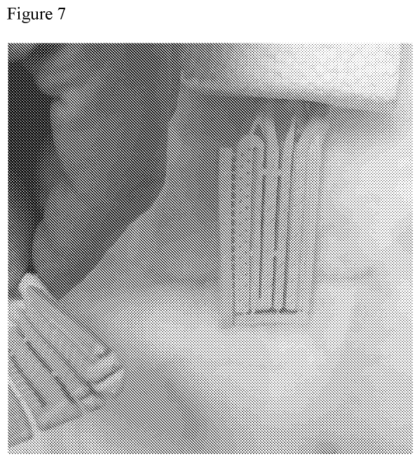

A fired multi-walled ceramic core comprising integral tip tie pins and core ties, which was suitable for use in single crystal investment casting of super alloy turbine blades, was fabricated using an additively manufactured dissolvable mold and is pictured in FIG. 7.

The dissolvable mold was affixed to a ceramic injection molding machine, and a ceramic material suitable for the casting of single crystal metal components was injected into the dissolvable mold. After injection, the mold was removed from the injection molding machine and immersed in water until the mold was entirely dissolved and only the ceramic component remained. The mold fully dissolved in water gently agitated using a pump in less than 4 hours and exhibited minimal swelling during dissolution, after which a green state ceramic core remained. Before firing, the ceramic core exhibited the following dimensions: Overall height: approximately 3 inches; Overall width: approximately 1.25 inches; Overall thickness: approximately 0.4 inches; Lead edge impingement: 0.40 inches; Trail edge slots: 0.025 inches×0.016 inches; Turbulators: 0.20×0.020 inches; Turbulator pins: 0.030 DIA. After firing, the ceramic core exhibited the following approximate composition and properties: Silica, 96.68%; Zirconium, 2.48%; Alumina, 0.84%. Apparent porosity (Fired to 1200 C: 28.5%, Fired to 1500 C, 28.5%); True porosity (Fired to 1200 C, 29.75%, Fired to 1500 C, 28.5%); Process Shrink, die to fired (Length: 0.95% fired to 1200 C, Chord, 1.35%, Profile, 1.50%; Free Linear Shrinkage, 1.27%.)

1. An injection molding assembly comprising (i) a dissolvable, additively manufactured monolithic polymer mold; (ii) optionally, an intermediate layer encasing dissolvable, additively manufactured monolithic polymer mold; and (iii) optionally, an outer shell surrounding the intermediate layer.

2. The injection molding assembly of claim 1, wherein the dissolvable, additively manufactured monolithic polymer mold dissolves in water or an organic solvent.

3. The injection molding assembly of claim 1, wherein the dissolvable, additively manufactured monolithic polymer mold exhibits minimal swelling behavior when dissolved.

4. The injection molding assembly of claim 3, wherein the minimal swelling behavior is characterized by an increase in polymer volume in amount selected from less than about 200%, less than about 150%, less than about 100%, less than about 50%, less than about 25% or less than about 20%.

5. The injection molding assembly of claim 1, wherein the dissolvable, additively manufactured monolithic polymer mold comprises one or more features suitable for forming features in an intermediate article.

6. The injection molding assembly of claim 5, wherein the intermediate article is a ceramic core suitable for forming a turbine blade or turbine vane and the one or more features are about 400 microns in size or less.

7. The injection molding assembly of claim 6, wherein the ceramic core further comprises one or more dissolvable or meltable inserts.

8. (canceled)

9. (canceled)

10. (canceled)

11. A ceramic core made from the injection molding assembly of claim 1.

12. The ceramic core of claim 11, wherein the ceramic core is suitable for use in casting a metal turbomachinery component.

13. The ceramic core of claim 12, wherein the metal turbomachinery component is a turbine blade or turbine vane.

14. The ceramic core of claim 11, wherein the ceramic core comprises alumina, fumed silica, fused silica, zirconium silicate or combinations thereof.

15. The ceramic core of claim 11, wherein the ceramic core is selected from a single-wall or multi-walled ceramic core.

16. The ceramic core of claim 11, wherein the ceramic core comprises one or more features suitable for forming one or more cooling features in a metal turbomachinery component cast from the ceramic core.

17. The ceramic core of claim 16, wherein the one or more features are on the order of between about 150 and about 500 microns in size.

18. (canceled)

19. A turbine blade made from the ceramic core of claim 11.

20. The turbine blade of claim 19, wherein the turbine blade comprises a single crystal superalloy.

21. The turbine blade of claim 19, wherein the turbine blade comprises one or more features selected from structural features, cooling features or combinations thereof.

22. The turbine blade of claim 21, wherein the one or more features are on the order of between about 5 micrometers and about 500 micrometers in size.

23. (canceled)

24. The turbine blade of claim 21, wherein the turbine blade comprise a base and an airfoil and wherein the airfoil comprises the one or more features.

25. The turbine blade of claim 21, wherein the one or more cooling features are selected from the group consisting of channels, passages, cavities, flow channels, holes, reservoirs, inlets, outlets, hierarchical meshes or combinations thereof.

26. The turbine blade of claim 21, wherein the one or more cooling features are selected from the group consisting of cooling passages, cooling channels or cooling cavities and wherein the cooling feature comprises one or more turbulating features.

27. The turbine blade of claim 21 wherein the one or more turbulating features is selected from the group consisting of dimples, pins, ridges or a combinations thereof.

28. The turbine blade of claim 21, wherein the cooling passage, cooling channel or cooling cavities comprises a plurality of pins in the form of one or more pin arrays.

29. The turbine blade of claim 28, wherein the pin arrays are selected from angled pin arrays, intersecting pin arrays or combinations thereof.

30. The turbine blade of claim 28, wherein the cooling feature is a trailing edge cavity spanning the turbine blade from the suction side wall to the pressure side wall and where all or a portion of the plurality of pins are not perpendicular a midplane of the cavity or a wall.

31-40. (canceled)

41. The turbine blade of claim 19, wherein the turbine blade is characterized by one or more improved properties compared to existing turbine blades, wherein the improved property is selected from the group consisting of improved durability, improved average blade cooling effectiveness, reduced maintenance frequency, reduced airfoil temperature, improved heat transfer cooling effectiveness or combinations thereof.

42. The turbine blade of claim 19, wherein the turbine blade permits an increased turbine inlet temperature compared to existing turbine blades.

43. The turbine blade of claim 42, wherein the increase in the turbine inlet temperature is selected from an increase greater than about 1.0%, greater than about 2.0%, greater than about 3%, greater than about 4% or greater than about 5%.

44. The turbine blade of claim 42, wherein the increased turbine temperature is between about 1700 and about 2200° C.

45-49. (canceled)

50. A method for preparing an isolated ceramic green body, comprising (i) providing a ceramic slurry; (ii) injecting a flowable ceramic slurry into a dissolvable, additively manufactured monolithic polymer molding of the injection mold assembly of claim 1; (iii) allowing the ceramic slurry to solidify to provide a ceramic green body; and (iv) dissolving the polymer mold by means of a dissolving liquid to provide an isolated ceramic green body.

51. The method of claim 50, wherein the dissolving liquid is selected from water or an organic solvent.

52. The method of claim 50, wherein the dissolvable, additively manufactured polymer exhibits minimal swelling when dissolved.

53. The method of claim 52, wherein the minimal swelling is characterized by an increase in polymer volume in an amount selected from less than about 200%, less than about 150%, less than about 100%, less than about 50%, less than about 25% or less than about 20%.

54. The method of claim 50, wherein the flowable ceramic slurry comprises (i) solid particulate components; (ii) carrier phase components; (iii) optionally, pore former and (iv) optionally, one or more additives.

55. The method of claim 50, further comprising (v) debinding the isolated ceramic green body to provide a ceramic brown body and (vi) sintering the ceramic brown body to provide a ceramic core.

56. The method of claim 55, wherein the debinding in (v) comprises solvent debinding, thermal debinding or a combination thereof.

57. A method of preparing a ceramic core, comprising (i) providing a ceramic slurry; (ii) injecting the ceramic slurry into a dissolvable, additively manufactured monolithic polymer mold of the injection molding assembly of claim 1; (iii) allowing the ceramic slurry to solidify to provide a ceramic green body; (iv) dissolving the polymer mold by means of a dissolving liquid to provide an isolated ceramic green body; and (v) further processing the isolated ceramic green body to provide the ceramic core.

58. The method of claim 57, wherein the further processing in (v) comprises debinding the isolated ceramic green body to provide a ceramic brown body and sintering the ceramic brown body to provide a ceramic core.

59. The method of claim 58, wherein the debinding comprises solvent debinding, thermal debinding or a combination thereof.

60. The method of claim 57, wherein the dissolving liquid is selected from water or an organic solvent.

61. The method of claim 57, wherein the dissolvable, additively manufactured monolithic polymer mold exhibits minimal swelling when dissolved.

62. The method of claim 61, wherein the minimal swelling comprises an increase in polymer volume of an amount selected from less than about 200%, less than about 150%, less than about 100%, less than about 50%, less than about 25% or less than about 20%.

63. The method of claim 50, wherein the method permits the elimination of one or more steps of traditional investment casting processes, where in the step is selected from core/die assembly, wax-overmolding, ceramic shelling or a combination thereof.

64. The method of claim 50, wherein the method is repeated multiple times and is characterized by a yield of greater than about 70%.

65. (canceled)

66. A method for preparing a turbine airfoil, comprising (i) providing the ceramic core of claim 11; (ii) introducing a molten metal into an assembly containing the ceramic core; (iii) permitting the molten metal to cool; and (iv) removing the ceramic core.
